(19) United States
(12) Patent Application Publication
(10) Pub. No.: US 2008/0040519 A1
(43) Pub. Date: Feb. 14, 2008

(54) Network interface device with 10 Gb/s full-duplex transfer rate

(75) Inventors: Daryl D. Starr, Milpitas, CA (US); Clive M. Philbrick, San Jose, CA (US); Colin C. Sharp, Cardiff, CA (US)

Correspondence Address: MARK A LAUER, 6601 KOLL CENTER PARKWAY, SUITE 245, PLEASANTON, CA, 94566, US

(73) Assignee: Alacritech, Inc.

(21) Appl. No.: 11/799,720

(22) Filed: May 1, 2007

Related U.S. Application Data
(60) Provisional application No. 60/797,125, filed on May 2, 2006.

(51) Int. Cl. G06F 3/00

(52) U.S. Cl. 710/39

(57) ABSTRACT

A 10 Gb/s network interface device offloads TCP/IP datapath functions. Frames without IP datagrams are processed as with a non-offload NIC. Receive frames are filtered, then transferred to preallocated receive buffers within host memory. Outbound frames are retrieved from host memory, then transmitted. Frames with IP datagrams without TCP segments are transmitted without any protocol offload, but received frames are parsed and checked for protocol errors, including checksum accumulation for UDP segments. Receive frames without datagram errors are passed to the host and error frames are dumped. Frames with Tcp segments are parsed and error-checked. Hardware checking is performed for ownership of the socket state. TCP/IP frames which fail the ownership test are passed to the host system with a parsing summary. TCP/IP frames which pass the ownership test are processed by a finite state machine implemented by the CPU. TCP/IP frames for non-owned sockets are supported with checksum accumulation/insertion.

### CROSS-REFERENCE TO RELATED APPLICATIONS

This application claims the benefit under 35 U.S.C. 119 of Provisional Patent Application Ser. No. 60/797,125, filed May 2, 2006, by inventors Daryl D. Starr, Clive M. Philbrick and Colin R. Sharp, entitled Network Interface Device with 10 Gb/sFull-Duplex Transfer Rate, which is incorporated by reference herein.

### INTRODUCTION

The following specification describes a TCP/IP offload network interface device called Sahara, which is capable of full duplex data transfer rates of at least ten-gigabits/second. This Introduction highlights a few of the features of Sahara, which are more fully described throughout the remainder of the document.

As shown in the upper-left-corner of FIG. 2, data from a network can be received by a ten-gigabit TCP/IP offload network interface device (TNIC) called Sahara via a Ten-gigabit Attachment Unit Interface (XAUI). Alternatively, a XFI (10-Gbit small form factor electrical interface) optical transceiver interface or XGMII 10 Gigabit Media Independent Interface, for example, can be employed.

In the particular 10 G/s physical layer embodiment of XAUI, data is striped over 4 channels, encoded with an embedded clock signal then sent in a serial fashion over differential signals. Although a 10 Gb/S data rate is targeted, higher and lower data rates are possible.

In this embodiment, the data is received from XAUI by Receive XGMII Extender Sublayer (RcvXgx) hardware, aligned, decoded, re-assembled and then presented to the Receive media access control (MAC) hardware (RcvMac). In this embodiment, the Receive MAC (RcvMac) is separated from the Transmit MAC (XmtMac), although in other embodiments the Receive and Transmit MACs may be combined.

The Receive MAC (RcvMac) performs known MAC layer functions on the data it has received, such as MAC address filtering and checking the format of the data, and stores the appropriate data and status in a Receive MAC Queue (RcvMacQ). The Receive MAC Queue (RcvMacQ) is a buffer that is located in the received data path between the Receive MAC (RcvMac) and the Receive Sequencer (RSq).

The Receive Sequencer (RSq) includes a Parser (Prs) and a Socket Detector (Det). The Parser reads the header information of each packet stored in the Receive MAC Queue (RcvMacQ). A FIFO stores IP addresses and TCP ports of the packet, which may be called a socket, as assembled by the parser. The Socket Detector (Det) uses the IP addresses and TCP ports, stored in the FIFO, to determine whether that packet corresponds to a TCP Control Block (TCB) that is being maintained by Sahara. The Socket Detector compares the packet socket information from the FIFO against TCB socket information stored in the Socket Descriptor Ram (SktDscRam) to determine TCB association of the packet. The Socket Detector (Det) may utilize a hash bucket similar to that described in U.S. Published Patent Application No. 20050182841, entitled “Generating a hash for a TCP/IP offload device,” to detect the packet's TCB association. Compared to prior art TNICs, that used a processor to determine that a packet corresponds to a TCB, this hardware Socket Detector (Det) frees the chip's processor for other tasks and increases the speed with which packet-TCB association can be determined.

The Receive Sequencer's (RSq) Socket Detector (Det) creates a Receive Event Descriptor for the received packet and stores the Receive Event Descriptor in a Receive Event Queue implemented in the Dma Director (Dmd) block. The Receive Event Descriptor comprises a TCB identifier (TCBID) that identifies the TCB to which the packet corresponds, and a Receive Buffer ID that identifies where, in Dram, the packet is stored. The Receive Event Descriptor also contains information derived by the Receive Sequencer (RSq), such as the Event Code (EvtCd), Dma Code (DmaCd) and Socket Receive Indicator (SkRcv). The Receive Event Queue (RcvEvtQ) is implemented by a Dma Director (Dmd) that manages a variety of queues, and the Dma Director (Dmd) notifies the Processor (CPU) of the entry of the Receive Event Descriptor in the Receive Event Queue (RcvEvtQ).

Once the CPU has accessed the Receive Event Descriptor stored in the Receive Event Queue (RcvEvtQ), the CPU can check to see whether the TCB denoted by that descriptor is cached in Global Ram (GRm) or needs to be retrieved from outside the chip, such as off-chip memory or host memory. The CPU also schedules a DMA to bring the header from the packet located in Dram into Global Ram (GRm), which in this embodiment is dual port SRAM. The CPU then accesses the IP and TCP headers to process the frame and perform state processing that updates the corresponding TCB. The CPU contains specialized instructions and registers designed to facilitate access and processing of the headers in the header buffers by the CPU. For example, the CPU automatically computes the address for the header buffer and adds to it the value from an index register to access header fields within the header buffer.

Queues are implemented in a Queue RAM (QRm) and managed jointly by the CPU and the DMA Director (Dmd). DMA events, whether instituted by the CPU or the host, are maintained in Queue RAM (Qrm) based queues.

The CPU is pipelined in this embodiment, with 8 CPUs sharing hardware and each of those CPUs occupying a different pipeline phase at a given time. The 8 CPUs also share 32 CPU Contexts. The CPU is augmented by a plurality of functional units, including Event Manager (EMg), Slow Bus Interface (Slw), Debugger (Dbg), Writable Control Store (WCS), Math Co-Processor (MCp), Lock Manager (LMg), TCB Manager (TMg) and Register File (RFl). The Event Manager (EMg) processes external events, such as DMA Completion Event (RspEvt), Interrupt Request Event (IntEvt), Receive Queue Event (RcvEvt) and others. The Slow Bus Interface (Slw) provides a means to access non-critical status and configuration registers. The Writable Control Store (WCS) includes microcode that may be rewritten. The Math Co-Processor (MCp) divides and multiplies, which may be used for example for TCP congestion control.

The Lock Manager (LMg) grants locks to the various CPUs, and maintains an ordered queue which stores lock requests allowing allocation of locks as they become available. Each of the locks is defined, in hardware or firmware, to lock access of a specific function. For example, the Math Co-Processor (MCp) may require several cycles to complete an operation, during which time other CPUs are locked out from using the Math Co-Processor (MCp). Maintaining locks which are dedicated to single functions allows better performance as opposed to a general lock which serves multiple functions.

The Event Manager (EMg) provides, to the CPU, a vector for event service, significantly reducing idle loop instruction count and service latency as opposed to single event polling performed by microcode in previous designs. That is, the Event Manager (EMg) monitors events, prioritizes the events and presents, to the cpu, a vector which is unique to the event type. The CPU uses the vector to branch to an event service routine which is dedicated to servicing the unique event type. Although the Event Manager (EMg) is configured in hardware, some flexibility is built in to enable or disable some of the events of the Event Manager (EMg). Examples of events that the Event Manager (EMg) checks for include: a system request has occurred over an I/O bus such as PCI; a DMA channel has changed state; a network interface has changed state; a process has requested status be sent to the system; and a transmitter or receiver has stored statistics.

As a further example, one embodiment provides a DMA event queue for each of 32 CPU contexts, and an idle bit for each CPU context indicating whether that context is idle. For the situation in which the idle bit for a context is set and the DMA event queue for that context has an event (the queue is not empty), the Event Manager (EMg) recognizes that the event needs to be serviced, and provides a vector for that service. Should the idle bit for that context not be set, instead of the Event Manager (EMg) initiating the event service, firmware that is running that context can poll the queue and service the event.

The Event Manager (EMg) also serves CPU contexts to available CPUs, which in one embodiment can be implemented in a manner similar to the Free Buffer Server (FBS) that is described below. A CPU Context is an abstract which represents a group of resources available to the CPUs only when operating within the context. Specifically, a context specifies a specific set of resources comprising CPU registers, a CPU stack, DMA descriptor buffers, a DMA event queue and a TCB lock request. When a CPU is finished with a context, it writes to a register, the CPU Context ID, which sets a flip-flop indicating that the context is free. Contexts may be busy, asleep, idle (available) or disabled.

The TCB Manager (TMg) provides hardware that manages TCB accesses by the plurality of CPUs and CPU Contexts. The TCB Manager (TMg) facilitates TCB locking and TCB caching. In one embodiment, 8 CPUs with 32 CPU Contexts can together be processing 4096 TCBs, with the TCB Manager (TMg) coordinating TCB access. The TCB Manager (TMg) manages the TCB cache, grants locks to processor contexts to work on a particular TCB, and maintains order for lock requests by processor contexts to work on a TCB that is locked.

The order that is maintained for lock requests can be affected by the priority of the request, so that high priority requests are serviced before earlier received requests of low priority. This is a special feature built into the TCB Manager (TMg) to service receive events, which are high priority events. For example, two frames corresponding to a TCB can be received from a network. While the TCB is locked by the first processor context that is processing the first receive packet, a second processor context may request a lock for the same TCB in order to process a transmit command. A third processor context may then request a lock for the same TCB in order to process the second receive frame. The third lock request is a high priority request and will be given a place in the TCB lock request chain which will cause it to be granted prior to the second, low priority, lock request. The lock requests for the TCB are chained, and when the first CPU context, holding the initial lock gets to a place where it is convenient to release the lock of the TCB, it can query the TCB Manager (TMg) whether there are any high priority lock requests pending. The TCB Manager (TMg) then can release the lock and grant a new lock to the CPU context that is waiting to process the second receive frame.

Sequence Servers issue sequential numbers to CPUs during read operations. Used as a tag to maintain the order of receive frames. Also used to provide a value to insert into the IP header Identification field of transmit frames.

Composite Registers are virtual registers comprising a concatenation of values read from or to be written to multiple single content registers. When reading a Composite Register, short fields read from multiple single content registers are aligned and merged to form a 32 bit value which can be used to quickly issue DMA and TCB Manager (TMg) commands. When writing to Composite Registers, individual single content registers are loaded with short fields which are aligned after being extracted from the 32-bit ALU output. This provides a fast method to process Receive Events and DMA Events. The single content registers can also be read and written directly without use of the Composite Register.

A Transmit Sequencer (XSq) shown in the upper right portion of FIG. 2 includes a Formatter (Fmt) and a Dispatcher (Dsp). The Transmit Sequencer (XSq) is independent of the Receive Sequencer (RSq) in this embodiment, and both can transfer data simultaneously at greater than 10 GB/s. In some previous embodiments, a device CPU running microcode would modify a prototype header in a local copy of a TCB that would then be sent by DMA to a DRAM buffer where it would be combined with data from a host for a transmit packet. A transmit sequencer could then pass the data and appended header to a MAC sequencer, which would add appropriate information and transmit the packet via a physical layer interface.

In a current embodiment, the CPU can initiate DMA of an unmodified prototype header from a host memory resident TCB to a transmit buffer and initiate DMA of transmit data from host memory to the same transmit buffer. While the DMAs are taking place, the CPU can write a transmit command, comprising a command code and header modification data, to a proxy buffer. When the DMAs have completed the CPU can add DMA accumulated checksum to the proxy buffer then initiate DMA of the proxy buffer contents (transmit command) to the Transmit Command Queue (XmtCmdQ). The Transmit Sequencer (XSq) Dispatcher (Dsp) removes the transmit command from the Transmit Command Queue (XmtCmdQ) and presents it to the Dram Controller (DrmCtl) which copies the header modification portion to the XmtDmaQ then copies header and data from the transmit buffer to the XmtDmaQ. The Transmit Sequencer (XSq) Formatter (Fmt) removes header modification data, transmit header and transmit data from the Transmit DMA Queue (XmtDmaQ), merges the header modification data with the transmit header then forwards the modified transmit header to the Transmit Mac Queue (XmtMacQ) followed by transmit data. Transmit header and transmit data are read from the Transmit Mac Queue (XmtMacQ) by a Transmit MAC (XmtMac) for sending on XAUI.

For the situation in which device memory is sufficient to store all the TCBs handled by the device, e.g., 4096 TCBs in one embodiment, as opposed to only those TCBs that are currently cached. In one embodiment, instead of a queue of descriptors for free buffers that are available, a Free Buffer Server (FBS) is utilized that informs the CPU of buffers that are available. The Free Buffer Server (FBS) maintains a set of flip-flops that are each associated with a buffer address, with each flip-flop indicating whether its corresponding buffer is available to store data. The Free Buffer Server (FBS) can provide to the CPU the buffer address for any buffer whose flip-flop is set. The list of buffers that may be available for storing data can be divided into groups, with each of the groups having a flip-flop indicating whether any buffers are available in that group. The CPU can simply write a buffer number to the Free Buffer Server (FBS) to free a buffer, which sets a bit for that buffer and also sets a bit in the group flip-flop for that buffer. To find a free buffer, the Free Buffer Server (FBS) looks first to the group bits, and finding one that is set then proceeds to check the bits within that group, flipping the bit when a buffer is used and flipping the group bit when all the buffers in that group have been used. The Free Buffer Server (FBS) may provide one or more available free buffer addresses to the CPU in advance of the CPU's need for a free buffer or may provide free buffers in response to CPU requests.

Such a Free Buffer Server (FBS) can have N levels, with N=1 for the case in which the buffer flip-flops are not grouped. For example, 2 MB of buffer space may be divided into buffers having a minimum size that can store a packet, e.g., 1.5 KB, yielding about 1,333 buffers. In this example, the buffer identifications may be divided into 32 groups each having 32 buffers, with a flip-flop corresponding to each buffer ID and to each group. In another example, 4096 buffers can be tracked using 3 levels with 8 flips-flops each. Although the examples given are in a networking environment, such a free-buffer server may have applications in other areas and is not limited to networking.

The host interface in this embodiment is an eight channel implementation of PciExpress (PciE) which provides 16 Gb of send and 16 Gb of receive bandwidth. Similar in functional concept to previous Alacritech TNICs, Sahara differs substantially in it's architectural implementation. The receive and transmit data paths have been separated to facilitate greater performance. The receive path includes a new socket detection function mentioned above, and the transmit path adds a formatter function, both serving to significantly reduce firmware instruction count. Queue access is now accomplished in a single atomic cycle unless the queue-indirect feature is utilized. As mentioned above, TCB management function has been added which integrates the cam, chaining and TCB Lock functions as well as Cache Buffer allocation. A new event manager function reduces idle-loop instruction count to just a few instructions. New statistics registers, automatically accumulate receive and transmit vectors. The receive parsing function includes multicast filtering and, for support of receive-side-scaling, a toeplitz hash generator. The Director provides compact requests for initiating TCB, SGL and header DMAs. A new CPU increases the number of pipeline stages to eight, resulting in single instruction ram accesses while improving operating frequency. Adding even more to performance are the following enhancements of the CPU:
32-bit literal instruction field.
16-bit literal with 16-bit jump address.
Dedicated ram-address literal field.
Independent src/dst operands.
Composite registers. E.g. {3′b0, 5′bCpCxId, 5′b0, 7′bCxCBId, 12′bCxTcId}
Per-CPU file address registers.
   CPU-mapped file operands.
a Per-CPU Context ID registers.
   Context-mapped file operands.
   Context-mapped ram operands.
   Per-context pc stacks.
   Per-context file address registers.
   Per-context ram address registers.
   Per-context TCB ID registers.
   Per-context Cache Buffer ID registers.
   CchBuf-mapped ram operands.
   Per-context Header Buffer ID registers.
   Per-context Header Buffer index registers.
   HdrBuf-mapped ram operands.
Per-CPU queue ID register
   Queue-mapped file operands.
   Queue-direct file operands.

Parity has been implemented for all internal rams to ensure data integrity. This has become important as silicon geometries decrease and alpha particle induced errors increase.

Sahara employs several, industry standard, interfaces for connection to network, host and memory. Following is a list of interface/transceiver standards employed:

| Spec | Xcvrs | Pins | Attachment | Description |
|---|---|---|---|---|
| XAUI | 8-CML | | XGbe Phy | 10 Gb Attachment Unit |
| | | | Interface. | |
| MGTIO | -LVTTL | | Phy | Management I/O. |
| PCI-E | ??-LVDS | | Host | Pci Express. |
| RLDRAM | ??-HSTL | | RLDRAM | Reduced Latency DRAM. |
| SPI | -LVTTL | | FLASH | Serial Peripheral Interface. |
| | | | MEM | |

Sahara is implemented using flip-chip technology which provides a few important benefits. This technology allows strategic placement of I/O cells across the chip, ensuring that the die area is not pad-limited. The greater freedom of I/O cell and ram cell placement also reduces connecting wire length thereby improving operating frequency.

External devices are employed to form a complete TNIC solution. FIG. 1 shows some external devices that can be employed. In one embodiment the following memory sizes can be implemented.
Drmm—2×8M×36—Receive RLDRAM (64 MB total).
Drmm—2×4M×36—Transmit RLDRAM (32 MB total).
Flsh—1×1M×1—Spi Memory (Flash or EEProm).
RBuf—Registered double data rate buffers.
Xpak—Xpak fiberoptic transceiver module.

### BRIEF DESCRIPTION OF THE FIGURES

FIG. 1 is a functional block diagram of a system of the present invention.

FIG. 2 is a functional block diagram of a device that is part of the system of FIG. 1.

FIG. 3 is a diagram of TCB Buffer Space that is part of the system of FIG. 1.

FIG. 4 is a diagram of a TCB Buffer that is part of the system of FIG. 1.

FIG. 5 is a diagram of a physical memory of the system of FIG. 1.

FIG. 6 is a diagram of buffers of the system of FIG. 1.

FIG. 7 is a diagram of Transmit Command Descriptors of the system of FIG. 1.

FIG. 8 is a diagram of Transmit Command Rings of the system of FIG. 1.

FIG. 9 is a diagram of Transmit Ring Space of the system of FIG. 1.

FIG. 10 is a diagram of Receive Command Descriptors of the system of FIG. 1.

FIG. 11 is a diagram of Receive Command Rings of the system of FIG. 1.

FIG. 12 is a diagram of Receive Ring Space of the system of FIG. 1.

FIG. 13 is a diagram of a Page Descriptor of the system of FIG. 1.

FIG. 14 is a diagram of a Scatter-Gather List of the system of FIG. 1.

FIG. 15 is a diagram of a System Buffer Descriptor of the system of FIG. 1.

FIG. 16 is a diagram of a NIC Event Descriptor of the system of FIG. 1.

FIG. 17 is a diagram of a NIC Event Queue of the system of FIG. 1.

FIG. 18 is a diagram of a NIC Event Queue Space of the system of FIG. 1.

FIG. 19 is a diagram of a Header Buffer Space of the system of FIG. 1.

FIG. 20 is a diagram of a TCB Valid Bit Map of the system of FIG. 1.

FIG. 21 is a diagram of a DMA Descriptor Buffer Space of the system of FIG. 1.

FIG. 22 is a diagram of a Cache Buffer Space of the system of FIG. 1.

FIG. 23 is a diagram of a Prototype Header Buffer of the system of FIG. 1.

FIG. 24 is a diagram of a Delegated Variables Space of the system of FIG. 1.

FIG. 25 is a diagram of a Receive Buffer Space and Transmit Buffer Space of the system of FIG. 1.

FIG. 26 is a diagram of a DRAM Controller of the system of FIG. 1.

FIG. 27 is a diagram of a DMA Director of the system of FIG. 1.

FIG. 28 is a DMA Flow Diagram of the system of FIG. 1.

FIG. 29 is a Proxy Flow Diagram of the system of FIG. 1.

FIG. 30 is a diagram of a Ten-Gigabit Receive Mac of the system of FIG. 1.

FIG. 31 is a diagram of a Transmit/Receive Mac Queue of the system of FIG. 1.

FIG. 32 is a diagram of a Receive Sequencer and connecting modules of the system of FIG. 1.

FIG. 33 is a diagram of a Transmit Sequencer and connecting modules of the system of FIG. 1.

FIG. 34 is a diagram of a CPU of the system of FIG. 1.

FIG. 35 is a diagram of a Snoop Access and Control Interface (SACI) Port of the system of FIG. 1.

FIG. 36 is a diagram of a Lock Manager of the system of FIG. 1.

FIG. 37 is a diagram of a CPU and Receive Sequencer of the system of FIG. 1.

FIG. 38 is a diagram of an Ingress Queue of the system of FIG. 1.

FIG. 39 is a diagram of an Egress Queue of the system of FIG. 1.

FIG. 40 is a diagram of an Event Manager of the system of FIG. 1.

FIG. 41 is a diagram of a TCB Manager of the system of FIG. 1.

FIG. 42 is a diagram of TCB Lock registers forming a request chain of the system of FIG. 1.

FIG. 43 is a diagram of Host Event Queue Control/Data Paths of the system of FIG. 1.

FIG. 44 is a diagram of Global RAM Control of the system of FIG. 1.

FIG. 45 is a diagram of Global RAM to Buffer RAM of the system of FIG. 1.

FIG. 46 is a diagram of Buffer RAM to Global RAM of the system of FIG. 1.

FIG. 47 is a Global RAM Controller timing diagram of the system of FIG. 1.

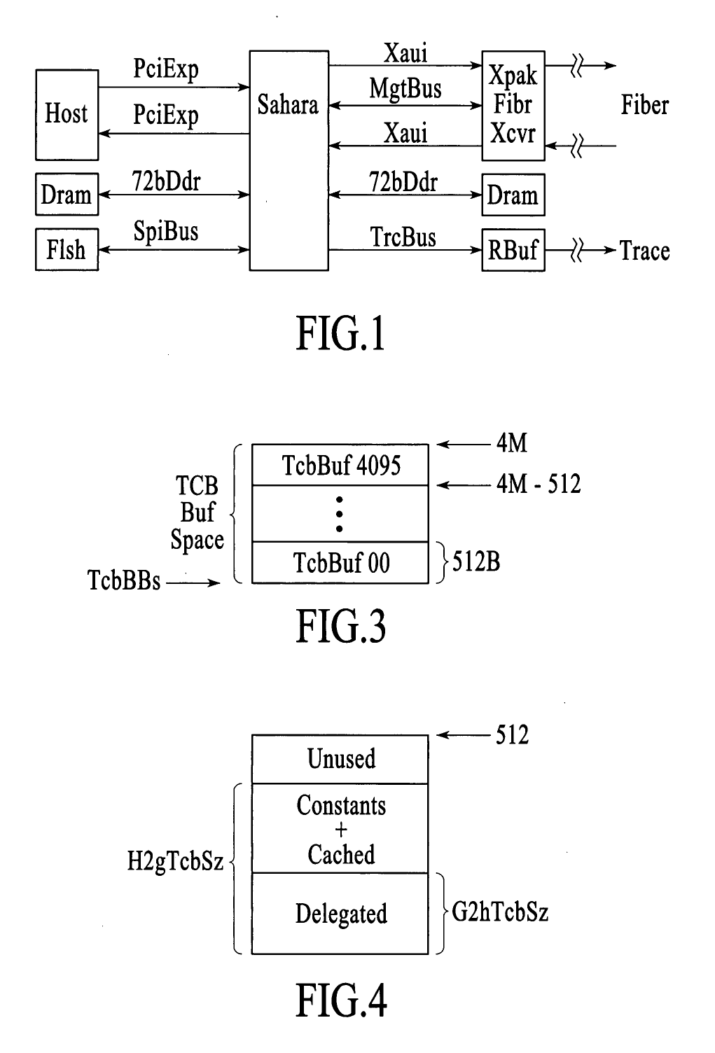

### FUNCTIONAL DESCRIPTION

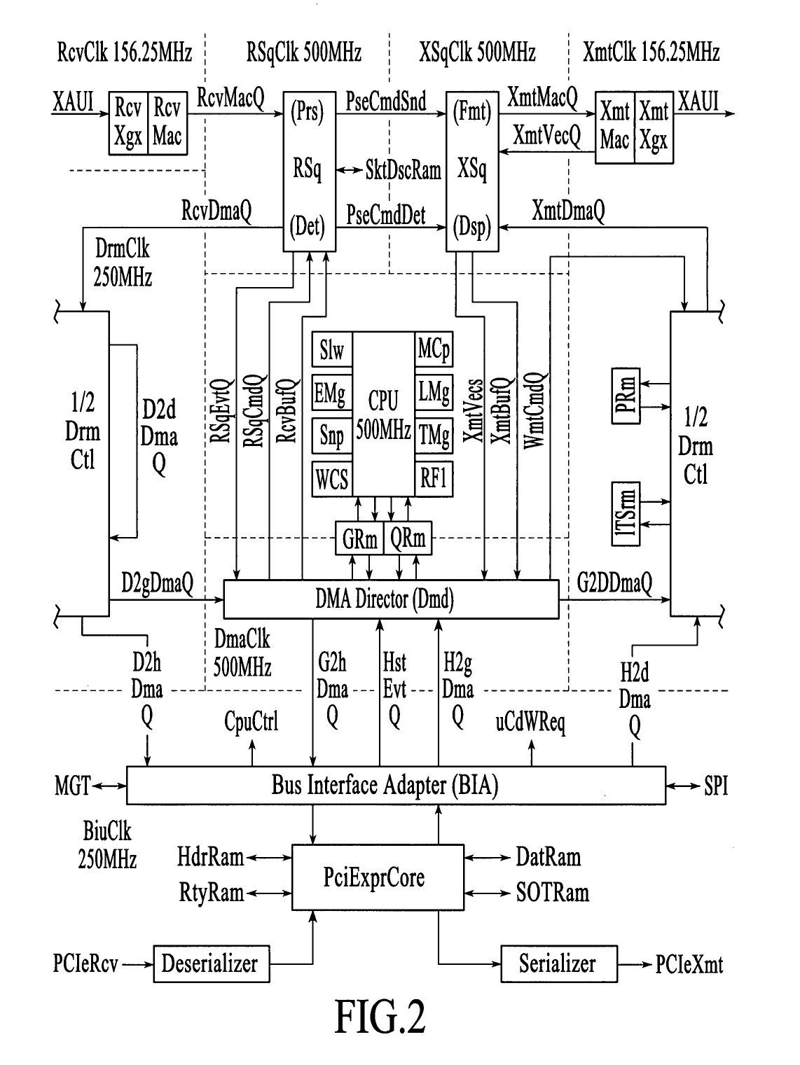

A functional block diagram of Sahara is shown in FIG. 2. Only data paths are illustrated. Functions have been defined to allow asynchronous communication with other functions. This results in smaller clock domains (the clock domain boundaries are shown with dashed lines) which minimize clock tree leaves and geographical area. The result is better skew margins, higher operating frequency and reduced power consumption. Also, independent clock trees will allow selection of optimal operating frequencies for each domain and will also facilitate improvements in various power management states. Wires, which span functional clocks are no longer synchronous, again resulting in improved operating frequencies. Sahara comprises the following functional blocks and storage elements:
xgxRcvDes—XGXS Deserializer.
XgxXmtSer—XGXS Serializer.
XgeRcvMac—XGbe Receive Mac.
XgeXmtMac—XGbe Transmit Mac.
RSq—Receive Sequencer.
XSq—Transmit Sequencer.
DrmCtl—Dram Control.
QMg—Queue Manager.
CPU—Central Processing Unit.
Dmd—DMA Director.
BIA—Host Bus Interface Adaptor
PciRcvPhy—Pci Express Receive Phy.
PciXmtPhy—Pci Express Transmit Phy.
PCIeCore—Pci Express Core IP.
MgtCtl—Phy Management I/O Control.
SpiCtl—Spi Memory Control.
GlobalRam—4×8K×36—Global Ram (GlbRam/GRm).
QueMgrRam—2×8K×36—Queue Manager Ram (QRm).
ParityRam—1×16K×16—Dram Parity Ram (PRm).
CpuRFlRam—2×2K×36—CPU Register File Ram (RFl).
CpuWCSRam—1×8K×108—CPU Writeable Control Store (WCS).
SktDscRam—1×2K×288—RSq Socket Descriptor Ram.
RcvMacQue—1×64×36—Receive Mac Data Queue Ram.
XmtMacQue—1×64×36—Transmit Mac Data Queue Ram.
XmtVecQue—1×64×36—Transmit Mac Vector (Stats) Queue Ram.
XmtCmdQHi—1×128×145—Transmit Command Q—high priority.
XmtCmdQLo—1×128×145—Transmit Command Q—low priority.
RcvDmaQue—1×128×145—Parse Sequencer Dma Fifo Ram.
XmtDmaQue—1×128×145—Format Sequencer Dma Fifo Ram.
D2gDmaQue—1×128×145—Dram to Global Ram Dma Fifo Ram.
D2hDmaQue—1×128×145—Dram to Host Dma Fifo Ram.
G2dDmaQue—1×128×145—Global Ram to Dram Dma Fifo Ram.
G2hDmaQue—1×128×145—Global Ram to Host Dma Fifo Ram.
H2dDmaQue—1×128×145—Host to Dram Dma Fifo Ram.
H2gDmaQue—1×128×145—Host to Global Ram Dma Fifo Ram.
PciHdrRam—1×68×109—PCI Header Ram.
PciRtyRam—1×256×69—PCI Retry Ram.
PciDatRam—1×182×72—PCI Data Ram.
   Functional Synopsis

In short, Sahara performs all the functions of a traditional NIC as well as performing offload of TCP/IP datapath functions. The CPU manages all functions except for host access of flash memory, phy management registers and pci configuration registers.

Frames which do not include IP datagrams are processed as would occur with a non-offload NIC. Receive frames are filtered based on link address and errors, then transferred to preallocated receive buffers within host memory. Outbound frames are retrieved from host memory, then transmitted.

Frames which include IP datagrams but do not include TCP segments are transmitted without any protocol offload but received frames are parsed and checked for protocol errors. Receive frames without datagram errors are passed to the host and error frames are dumped. Checksum accumulation is also supported for Ip datagram frames containing UDP segments.

Frames which include Tcp segments are parsed and checked for errors. Hardware checking is then performed for ownership of the socket state. Tcp/Ip frames which fail the ownership test are passed to the host system with a parsing summary. Tcp/Ip frames which pass the ownership test are processed by the finite state machine (FSM) which is implemented by the TNIC CPU. Tcp/Ip frames for non-owned sockets are supported with checksum accumulation/insertion.

The following is a description of the steps which occur while processing a receive frame.

Receive Mac

1) Store incoming frame in RcvMacQue.
2) Perform link level parsing while receiving/storing incoming frame.
3) Save receive status/vector information as a mac trailer in RcvMacQue.
   Receive Sequencer
1) Obtain RbfId from RcvBufQ (Specifies receive buffer location in RcvDrm).
2) Retrieve frame data from RcvMacQue and perform link layer parsing.
3) Filter frame reception based on link address.
4) Dump if filtered packet else save frame data in receive buffer.
5) Parse mac trailer.
6) Save a parse header at the start of the receive buffer.
7) Update RcvStatsR.
8) Select a socket descriptor group using the socket hash.
9) Compare socket descriptors within group against parsed socket ID to test for match.
10) If match found, set SkRcv, TcbId and extract DmaCd from SktDsc else set both to zero.
11) Store entry on the RSqEvtQ {RSqEvt, DmaCd, SkRcv, TcbId, RbfId}.
   CPU
1) Pop event descriptor from RSqEvtQ.
2) Jump, if marker event, to marker service routine.
3) Jump, if raw receive, to raw service routine.
4) Use TcbMgr to request lock of TCB.
5) Continue if TCB grant, else Jsx to idle loop.
6) Jump, if !TcbRcvBsy, to 12.
7) Put RbfId on to TCB receive queue.
8) Use TcbMgr to release TCB and get next owner.
9) Release current context.
10) Jump, if owner not valid, to idle.
11) Switch to next owner and Rtx.
12) Schedule TCB DMA if needed.
13) Schedule header DMA.
14) Magic stuff.

The following is a description of the steps which occur while processing a transmit frame.

CPU

1) Use TcbMgr to request lock of TCB.
2) If not TCB grant, Jsx, to idle loop.
3) Magic stuff here.
4) Schedule H2dDma.
5) Pop Proxy Buffer Address (PxyAd) off of Proxy Buffer Queue (PxyBufQ).
6) Partially assemble formatter command variables in PxyBuf.
7) If not H2dDmaDn, Jsx to idle loop.
8) Check H2dDma ending status.
9) Finish assembling formatter command variables (Chksum+) in PxyBuf.
10) Write Proxy Command {PxySz,Queld,PxyAd} to Proxy Dispatch Queue (PxyCmdQ).
11) Magic stuff here.
   Proxy Agent
1) Pop PxyCmd off of PxyCmdQ.
2) Retrieve transmit descriptor from specified PxyBuf.
3) Push transmit descriptor on to specified transmit queue.
4) Push PxyAd on to PxyBufQ.
   Transmit Sequencer
1) Pop transmit descriptor off of transmit queue.
2) Copy protoheader to XmtDmaQue.
3) Modify protoheader while copying to XmtMacQue.
4) Release protoheader to XmtMac (increment XmtFmtSeq).
5) Copy data from transmit buffer to XmtDmaQue.
6) Copy data from transmit buffer to XmtMacQue.
7) Write EOP and DMA status to XmtMacQue.
8) Push XmtBuf on to XmtBufQ to release transmit buffer.
   Transmit Mac
1) Wait for transmit packet ready (XmtFmtSeq>XmtMacSeq).
2) Pop data off of XmtMacQue and send until EOP/Status encountered.
3) If no DMA error, send good crc else send bad crc to void frame.
4) Increment XmtMacSeq.
5) Load transmit status into XMacVecR and flip XmtVecRdy.
   Transmit Sequencer
1) If XmtVecRdy !=XmtVecSvc, read XMacVecR and update XSNMPRgs.
2) Flip XmtVecSvc.
   Host Memory (HstMem) Data Structures

Host memory provides storage for control data and packet payload. Host memory data structures have been defined which facilitate communication between Sahara and the host system. Sahara hardware includes automatic computation of address and size for access of these data structures resulting in a significant reduction of firmware overhead. These data structures are defined below.

TCP Control Block

TCBs comprise constants, cached-variables and delegated-variables which are stored in host memory based TCB Buffers (TcbBuf) that are fixed in size at 512 B. A diagram of TCB Buffer space is shown in FIG. 3, and a TCB Buffer is shown in FIG. 4. The TCB varies in size based on the version of IP or host software but in any case may not exceed the 512B limitation imposed by the size of the TcbBuf. TCBs are copied as needed into GlbRam based TCB Cache Buffers (CchBuf) for direct access by the CPUs. A special DMA operation is implemented which copies the TCB structure from TcbBuf to CchBuf using an address calculated with the configuration constant, TCB Buffer Base Address (TcbBBs), and the TcbBuf size of 512 B. The DMA size is determined by the configuration constant, H2gTcbSz.

Constants and cached-variables are read-only, but delegated variables may be modified by the CPUs while the TCB is cached. All TCBs are eventually flushed from the cache at which time, if any delegated-variable has been modified, the changed variable must be copied back to the TcbBuf. This is accomplished with a special DMA operation which copies to the TcbBuf, from the CchBuf, all delegated variables and incidental cached variables up to the next 32B boundary. The DMA operation copies an amount of data determined by the configuration constant G2hTcbSz. This constant should be set to a multiple of 32 B to preclude read-modify-write operations by the host memory controller. To this same end, delegated variables are located at the beginning of the TcbBuf to ensure that DMAs start at a 64-byte boundary. Refer to sections Global Ram, DMA Director and Slow Bus Controller for additional information.

Prototype Headers

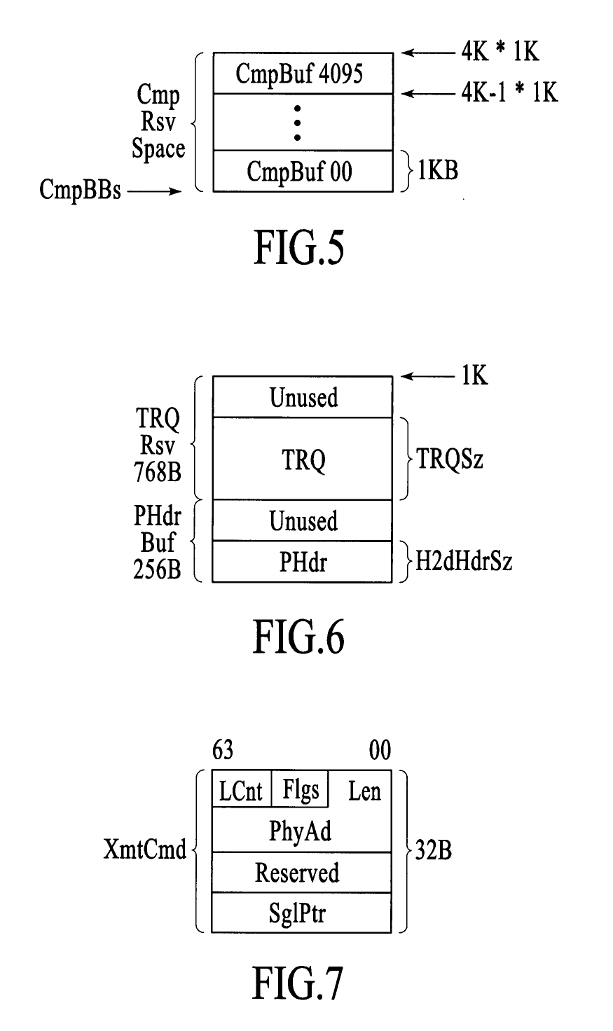

Every connection has a Prototype Header (PHdr) which is not cached in GlbRam but is instead copied from host memory to DRAM transmit buffers as needed. Headers for all connections reside in individual, 1 KB Composite Buffers (CmpBuf, FIG. 6) which are located in contiguous physical memory of the host as shown in FIG. 5. A composite buffer comprises two separate areas with the first 256-btye area reserved for storage of the prototype header and the second 768-byte area reserved for storage of the TCB Receive Queue (TRQ). Although the PHdr size and TRQ size may vary, the CmpBuf size remains constant.

Special DMA operations have been defined, for copying prototype headers to transmit buffers. A host address is computed using the configuration constant—Composite Buffer Base Address (CmpBBs), with a fixed buffer size of 1 KB. Another configuration constant, prototype-header transmit DMA-size (H2dHdrSz), indicates the size of the copy. Refer to sections DMA Director and Slow Bus Controller for additional information.

TCB Receive Queue

Every connection has a unique TCB Receive Queue (TRQ) in which to store information about buffered receive packets or frames. The TRQ is allocated storage space in the TRQ reserved area of the composite buffers previously defined. The TRQ size is programmable and can be up to 768-bytes deep allowing storage of up to 192 32-bit descriptors. This is slightly more than needed to support a 256 KB window size assuming 1448-byte payloads with the timestamp option enabled.

When a TCB is ejected from or imported to a GlbRam TCB Cache Buffer (CchBuf), its corresponding receive queue may or may not contain entries. The receive queue can be substantially larger than the TCB and therefore contribute greatly to latency. It is for this reason that the receive queue is copied only when it contains entries. It is expected that this DMA seldom occurs and therefore there is no special DMA support provided.

Transmit Commands.

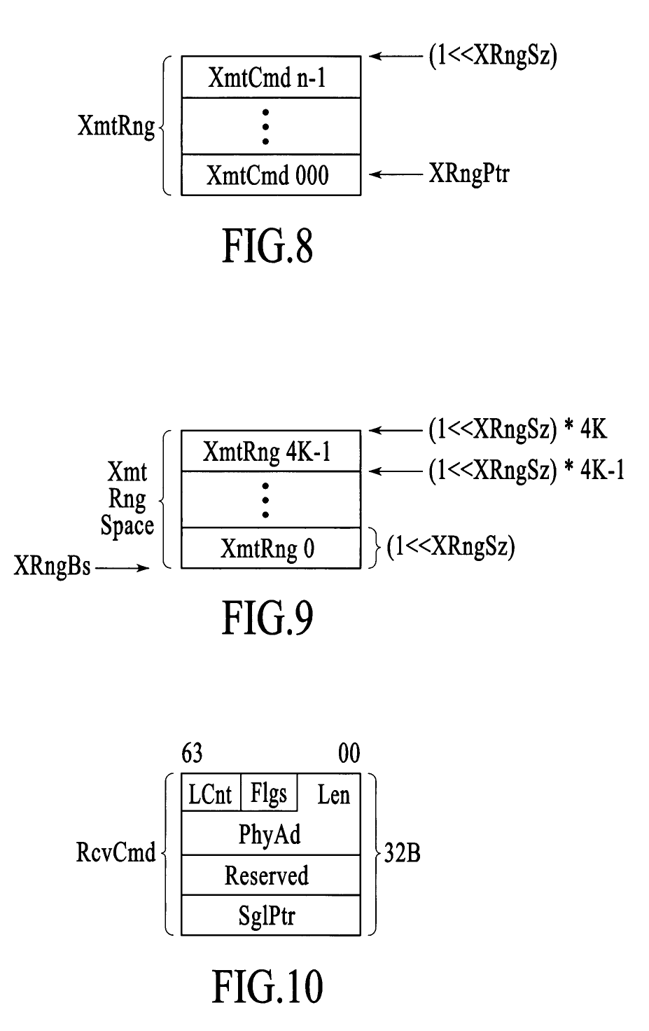

Transmit Command Descriptors (XmtCmd, FIG. 7) are retrieved from host memory resident transmit command rings (XmtRng, FIG. 8). Transmit Ring space is shown in FIG. 9. A XmtRng is implemented for each connection. The size is configurable up to a maximum of 256 entries. The descriptors indicate data transfers for offloaded connections and for raw packets.

The command descriptor includes a Scatter-Gather List Read Pointer (SglPtr, Fig. xx-a), a 4-byte reserved field, a 2-byte Flags field (Flgs), a 2-byte List Length field (LCnt), a 12-byte memory descriptor and a 4-byte reserved field. The definition of the contents of Flgs is beyond the scope of this document. The SglPtr is used to fetch page descriptors from a scatter-gather list and points to the second page descriptor of the list. MernDsc[0] is a copy of the first entry in the SGL and is placed here to reduce latency by consolidating what would otherwise be two DMAs. LCnt indicates the number of entries in the SGL and includes MemnDsc[0]. A value of zero indicates that no data is to be transferred.

The host compiles the command descriptor or descriptors in the appropriate ring then notifies Sahara of the new command(s) by writing a value, indicating the number of new command descriptors, to the transmit tickle register of the targeted connection. Microcode adds this incremental value to a Transmit Ring Count (XRngCnt) variable in the cached TCB. Microcode determines command descriptor readiness by testing XRngCnt and decrements it each time a command is fetched from the ring.

Commands are fetched using an address computed with the Transmit Ring Pointer (XRngPtr), fetched from the cached TCB, and the configuration constants Transmit Ring Base address (XRngBs) and Transmit Rings Size (XRngSz). XRngPtr is then incremented by the DMA Director. Refer to sections Global Ram, DMA Director and Slow Bus Controller for additional information.

Receive Commands.

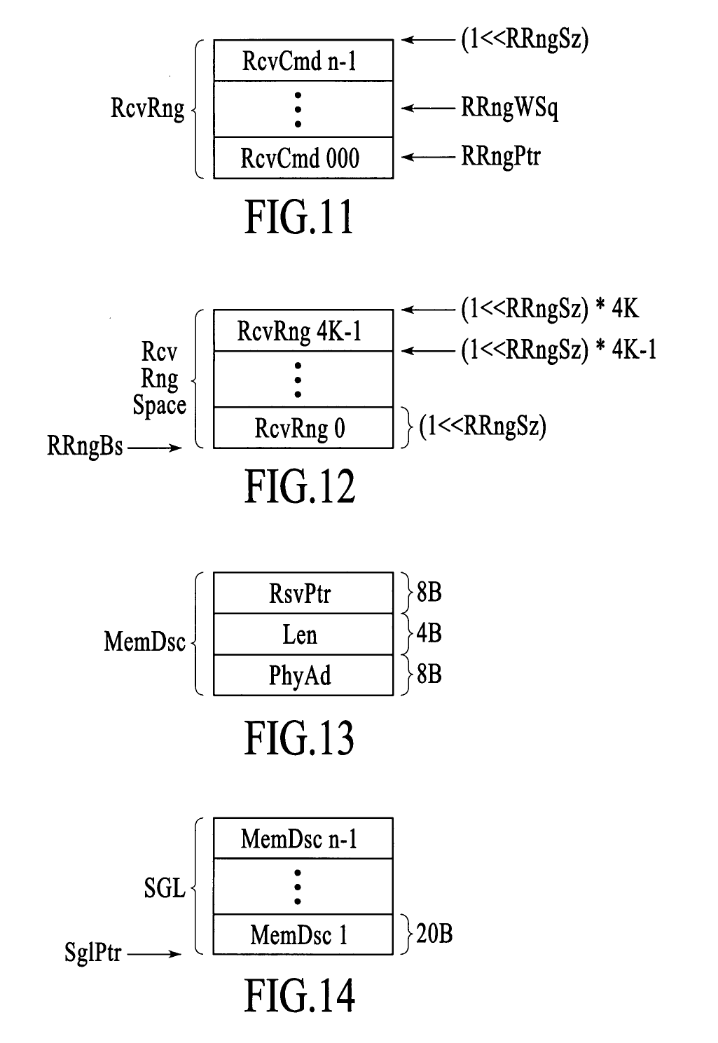

Receive Command Descriptors (RcvCmd, FIG. 10) are retreived from host memory resident Receive Command Rings (RcvRng, FIG. 11). Receive Ring space is shown in FIG. 12. A RcvRng is implemented for each connection. The size is configurable up to a maximum of 256 entries. The descriptors indicate data transfers for offloaded connections and the availability of buffer descriptor blocks for the receive buffer pool. The descriptors are basically identical to those used for transmit except for the definition of the contents of the 2-byte Flags field (Flgs). Connection 0 is a special case used to indicate that a block of buffer descriptors is available for the general receive buffer pool. In this case SglPtr points to the first descriptor in the block of buffer descriptors. Each buffer descriptor contains a 64-bit physical address and a 64-bit virtual address. LCnt indicates the number of descriptors in the list and must be the same for every list. Furthermore, LCnt must be a whole fraction of the size of the System Buffer Descriptor Queue (SbfDscQ) which resides in Global Ram. Use of other lengths will result in DMA fragmentation at the SbfDscQ memory boundaries.

The host compiles the command descriptor or descriptors in the appropriate ring then notifies Sahara of the new command(s) by writing a value, indicating the number of new command descriptors, to the receive tickle register of the targeted connection. Microcode adds this incremental value to a Receive Ring Count (RRngCnt) variable in the cached TCB. Microcode determines command readiness by testing RRngCnt and decrements it each time a command is fetched from the ring.

Commands are fetched using an address computed with the Receive Ring Pointer (RRngPtr), fetched from the cached TCB, and the configuration constants Receive Ring Base address (RRngBs) and Receive Ring Size (RRngSz). RRngPtr is then incremented by the DMA Director. Refer to sections Global Ram, DMA Director and Slow Bus Controller for additional information.

Scatter-Gather Lists.

A Page Descriptor is shown in FIG. 13, and a Scatter-Gather List is shown in FIG. 14. Applications send and receive data through buffers which reside in virtual memory. This virtual memory comprises pages of segmented physical memory which can be defined by a group of Memory Descriptors (MemDsc, FIG. 13). This group is referred to as a Scatter-Gather List (SGL, FIG. 14). The SGL is passed to Sahara via a pointer (SglPtr) included in a transmit or receive descriptor.

Memory descriptors in the host include an 8-byte Physical Address (PhyAd, FIG. 13), 4-byte Memory Length (Len) and an 8-byte reserved area which is not used by Sahara. Special DMA commands are implemented which use an SglPtr that is automatically fetched from a TCB cache buffer. Refer to section DMA Director for additional information.

System Buffer Descriptor Lists.

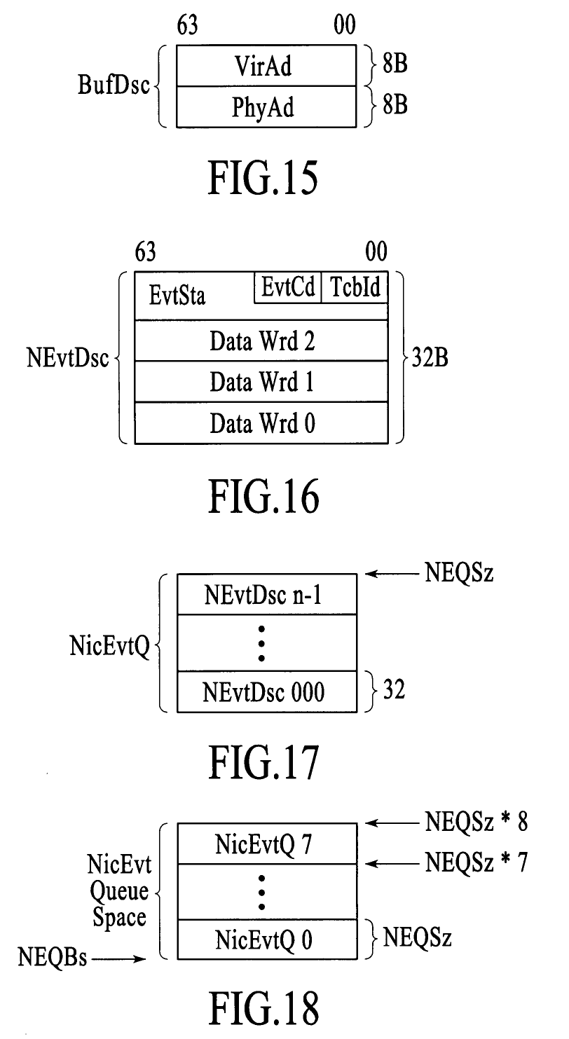

A System Buffer Descriptor is shown in FIG. 15. Raw receive packets and slow path data are copied to system buffers which are taken from a general system receive buffer pool. These buffers are handed off to Sahara by compiling a list of System Buffer Descriptors (SbfDsc, Fig. xx) and then passing a pointer through the receive ring of connection 0. Sahara keeps a Receive Ring Pointer (RRngPtr) and Receive Ring Count (RRngCnt) for the receive rings which allows fetching a buffer descriptor block pointer and subsequently the block of descriptors. The buffer descriptor comprises a Physical Address (PhyAd) and Virtual Address (VirAd) for a 2 KB buffer. The physical address is used to write data to the host memory and the virtual address is passed back to the host to be used to access the data.

Microcode schedules, as needed, a DMA of a SbfDsc list into the SbfDsc list staging area of the GlbRam. Microcode then removes individual descriptors from the list and places them onto context specific buffer descriptor queues until all queues are full. This method of serving descriptors reduces critical receive microcode overhead since the critical path code does not need to lock a global queue and copy a descriptor to a private area.

NIC Event Queues.

Event notification is sent to the host by writing NIC Event Descriptors (NEvtDsc, FIG. 16) to the NIC Event Queues (NicEvtQ, FIG. 17). Eight NicEvtQs (FIG. 18) are implemented to allow distribution of events among multiple host CPUs.

The NEvtDsc is fixed at a size of 32 bytes which includes eight bytes of data, a two byte TCB Identifier (TcbId), a two byte Event Code (EvtCd) and a four byte Event Status (EvtSta). EvtSta is positioned at the end of the structure to be written last because it functions as an event valid indication for the host. The definitions of the various field contents are beyond the scope of this document.

Configuration constants are used to define the queues. These are NIC Event Queue Size (NEQSz) and NIC Event Queue Base Address (NEQBs) which are defined in section Slow Bus Controller. The CPU includes a pair of sequence registers, NIC Event Queue Write Sequence (NEQWrtSq) and NIC Event Queue Release Sequence (NEQRIsSq), for each NicEvtQ. These also function as read and write pointers. Sahara increments NEQWrtSq for each write to the event queue. The host sends a release count of 32 to Sahara each time 32 queue entries have been vacated. Sahara adds this value to NEQRlsSq to keep track of empty queue locations. Additional information can be found in sections CPU Operands and DMA Director.

Global Ram (GlbRam/GRm)

GlbRam, a 128 KB dual port static ram, provides working memory for the CPU. The CPU has exclusive access to a single port, ensuring zero wait access. The second port is used exclusively during DMA operations for the movement of data, commands and status. GlbRam may be written with data units as little as a byte and as large as 8 bytes. All data is protected with byte parity ensuring detection of all single bit errors.

Multiple data structures have been pre-defined, allowing structure specific DMA operations to be implemented. Also, the predefined structures allow the CPU to automatically compile GlbRam addresses using contents of both configuration registers and dynamic registers The resulting effect is reduced CPU overhead. The following list shows the structures and the memory used by them. Any additional structures may reduce the quantity or size of the TCB cache buffers.

| | | | | |
|---|---|---|---|---|
| HdrBufs | 8 | KB = | 128 B/Hbf * 2Bufs/Ctx * 32Ctxs | Header Buffers. |
| DmaDscs | 4 | KB = | 16 B/Dbf * 8Dbfs/Ctx * 32Ctxs | Dma Descriptor Buffers. |
| SbfDscs | 4 | KB = | 16 B/Sbf * 8Dbfs/Ctx * 32Ctxs | Dma Descriptor Buffers. |
| PxyBufs | 2 | KB = | 32 B/Pbf * 64Pbfs | Proxy Buffers. |
| TcbBMap | 512 | B = | 1 b/TCB * 4KTcbs/Map/8 b/B | TCB Bit Map. |
| CchBufs | 109 | KB = | 1 KB/Cbf * 109Cbfs | TCB Cache Buffers. |
| | 128 | KB | | |

Header Buffers

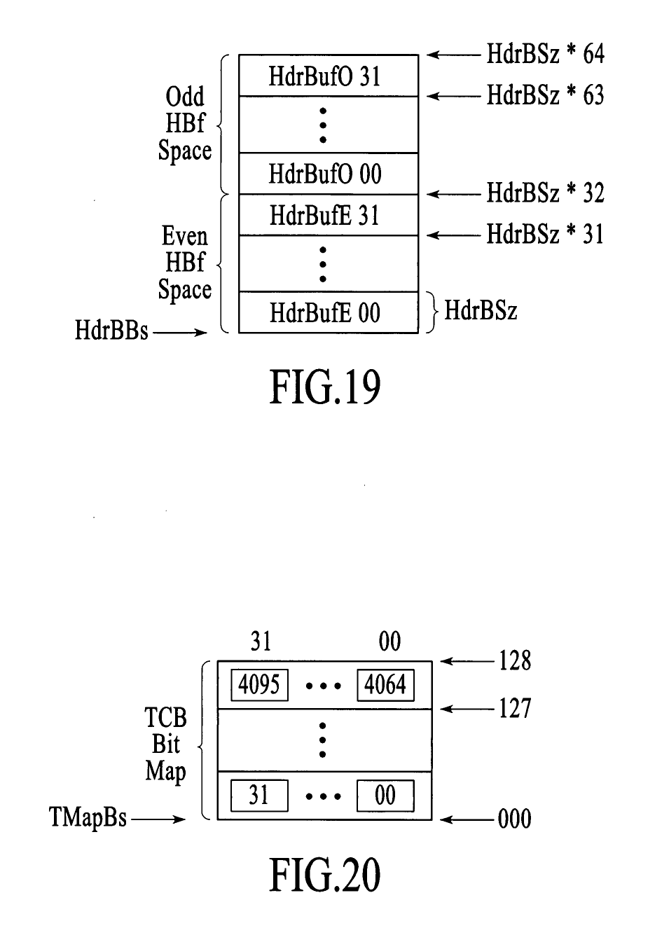

FIG. 19 shows Header Buffer Space. Receive packet processing uses the DMA of headers from the DRAM receive buffers (RcvBuf/Rbf) to GlbRam to which the CPUs have immediate access. An area of GlbRam has been partitioned in to buffers (HdrBu/Hbf, Fig. xx) for the purpose of holding these headers. Each CPU context is assigned two of these buffers and each CPU context has a Header Buffer ID (HbfId) register that indicates which buffer is active. While one header is being processed another header can be pre-fetched thereby reducing latency when processing sequential frames.

Configuration constants define the buffers. They are Header Buffer Base Address (HdrBBs) and Header Buffer Size (HdrBSz). The maximum buffer size allowed is 256 B.

Special CPU operands have been provided which automatically compile addresses for the header buffer area. Refer to section CPU Operand for additional information.

A special DMA is implemented which allows efficient initiation of a copy from DRAM to HdrBuf. Refer to section DMA Director for additional information.

TCB Valid Bit Map

A bit-map (FIG. 20) is implemented in GlbRam wherein each bit indicates that a TCB contains valid data. This area is pre-defined by configuration constant TCB Map Base Address (TMapBs) to allow hardware assistance. CPU operands have been defined which utilize the contents of the TcbId registers to automatically compute a GlbRam address. Refer to CPU Operands and Slow Bus Controller for additional information.

Proxy Buffers

Transmit packet processing uses assembly of transmit descriptors which are deposited into transmit command queues. Up to 32-bytes (8-entries) can be written to the transmit queue while maintaining exclusive access. In order to avoid spin-lock during queue access, a proxy DMA has been provided which copies contents of proxy buffers from GlbRam to the transmit command queues. Sixty four proxy buffers of 32-bytes each are defined by microcode and identified by their starting address. Refer to sections DMA Director and Transmit Operation for additional information.

System Buffer Descriptor Stage

Raw frames and slow path packets are delivered to the system stack via System Buffers (SysBuf/Sbf). These buffers are defined by System Buffer Descriptors (SbfDsc, See prior section System Buffer Descriptor Lists) comprising an 8-byte physical address and an 8-byte virtual address. The system assembles 128 SbfDscs into a 2 KB list then deposits a pointer to this list on to RcvRng 0. The system then notifies microcode by a writing to Sahara's tickle register. Microcode copies the lists as needed into a staging area of GlbRam from which individual descriptors will be distributed to each CPU context's system buffer descriptor queue. This stage is 2 KB to accommodate a single list.

DMA Descriptor Buffers

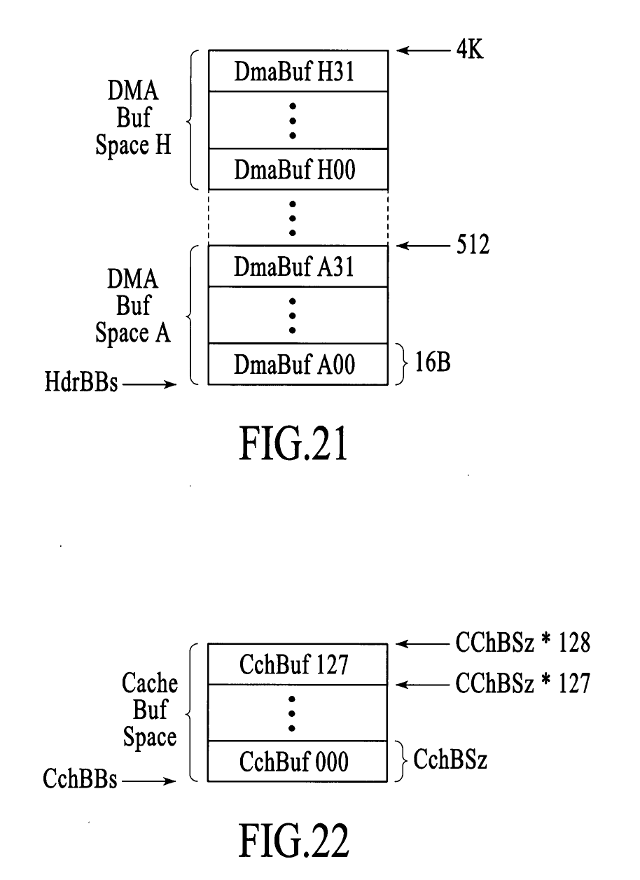

FIG. 21 shows DMA Descriptor Buffer Space. The DMA Director accepts DMA commands which utilize a 16-byte descriptor (DmaDsc) compiled into a buffer (DmaBuf/Dbf) in GlbRam. There are 8 descriptor buffers available to each CPU context for a total of 256 buffers. Each of the 8 buffers corresponds to a DMA context such that a concatenation of CPU Context and DMA Context {DmaCx,CpuCx} selects a unique DmaBuf. CPU operands have been defined which allow indirect addressing of the buffers. See section CPU Operands for more information. Configuration constant—DMA Descriptor Buffer Base Address (DmaBBs) defines the starting address in GlbRam. The DMA Director uses the CpuCx and DmaCx provided via the Channel Command Queues (CCQ) to retrieve a descriptor when required.

Event mode DMAs also access DmaBufs but do so for a different purpose. Event descriptors are written to the host memory resident NIC Event Queues. They are fetched from the DmaBuf by the DMA Director, but are passed on as data instead of being used as extended command descriptors. Event mode utilizes two consecutive DmaBufs since event descriptors are 32-bytes long. It is recommended that DmaCxs 6 and 7 be reserved exclusively for this purpose.

TCB Cache Buffers

A 12-bit identifier (TcbId) allows up to 4095 connections to be actively supported by Sahara. Connection 0 is reserved for raw packet transmit and system buffer passing. These connections are defined by a collection of variables and constants which are arranged in a structure known as a TCP Control Block (TCB). The size of this structure and the number of connections supported preclude immediate access to all of them simultaneously by the CPU due to practical limitations on local memory capacity. A TCB caching scheme provides a solution with reasonable tradeoffs between local memory size and the quantity of connections supported. FIG. 22 shows Cache Buffer Space.

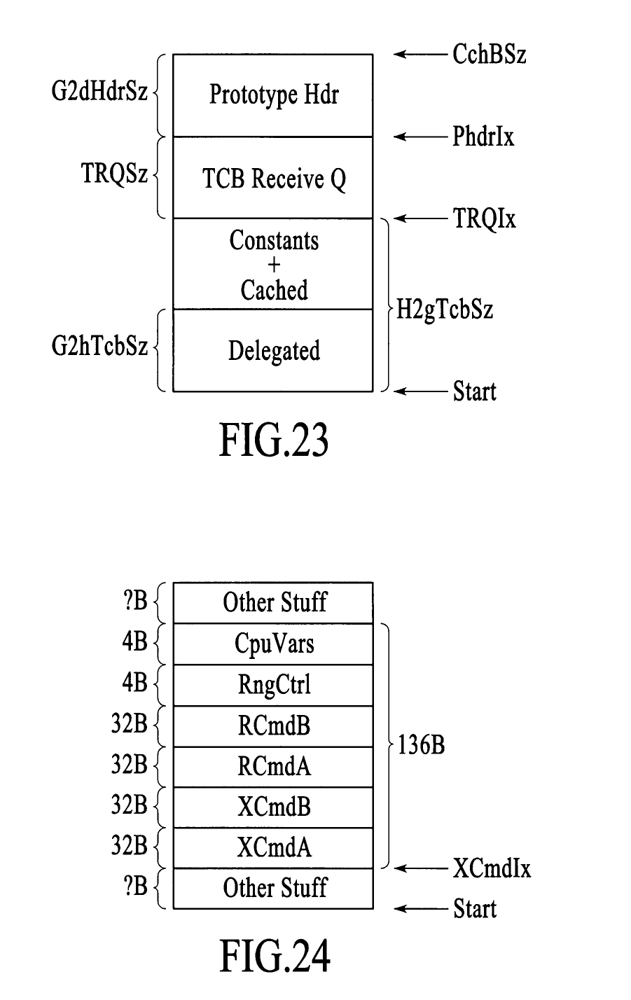

Most of GlbRam is allocated to TCB Cache Buffers (CchBuf/Cbf) leaving primary storage of TCBs in inexpensive host DRAM. In addition to storing the TCB structure, these CchBufs provide storage for the TCB Receive Queue (TRQ) and an optional Prototype Header (Phd). The Phd storage option is intended as a fallback in the event that problems are encountered with the transmit sequencer proxy method of header modification. FIG. 23 shows a Prototype Header Buffer.

CchBufs are represented by cache buffer identifiers (CbfId). Each CpuCtx has a specialized register (CxCbfId) which is dedicated to containing the currently selected CbfId. This value is utilized by the DMA Director, TCB Manager and by the CPU for special memory accesses. CbfId represents a GlbRam resident buffer which has been defined by the configuration constants cache buffer base address (CchBBs) and cache buffer size (CchBSz). The CPU and the DMA Director access structures and variables in the CchBufs using a combination of hard constants, configuration constants and variable register contents. TRQ access by the CPU is facilitated by the contents of the specialized Connection Control register—CxCCtl which holds the read and write sequences for the TRQ. These are combined with TRQ Index (TRQIx), CbfId and CchBSz and CchBBs to arrive at a GlbRam address from which to read or to which to write. The values in CxCCtl are initially loaded from the cached TCB's CPU Variables field (CpuVars) whenever a context first gains ownership of a connection. The value in the CchBuf is updated immediately prior to relinquishing control of the connection. The constant TRQ Size (TRQSz) indicates when the values in CxCCtl should wrap around to zero. FIG. 24 shows a Delegated Variables Space.

Four command sub-structures are implemented in the CchBuf. Two of these provide storage for receive commands—RCmdA and RCmdB and the remaining two provide storage for transmit commands—XCmdA and XCmdB. The commands are used in a ping-pong fashion, allowing the DMA to store the next command or the next SGL entry in one command area while the CPU is actively using the other. Having a fixed size of 32-bytes, the command areas are defined by the configuration constant—Command Index (CmdIx). The DMA Director includes a ring mode which copies command descriptors from the XmtRngs and RcvRngs to the command sub-structures—XCmdA, XCmdB, RCmdA and RCmdB. The commands are retrieved from sequential entries of the host resident rings. A pointer to these entries is stored in the cached TCB in the sub-structure—RngCtrl and is automatically incremented by the DMA Director upon completion of a command fetch. Delivery to the CchBuf resident command sub-structure is ping-ponged, controlled by the CpuVars bits—XCmdOdd and RCmdOdd which are essentially images of XRngPtr[0] and RRngPtr[0] held in CxCCtl. These bits are used to form composite registers for use in DMA Director commands.

CpuVars

| Bits | Name | Description |
|---|---|---|
| 31:28 | Rsvd. | |
| 27:27 | XCOVld | Transmit Command Odd Valid. |
| 26:26 | XCEVld | Transmit Command Even Valid. |
| 25:25 | XCOFlg | Transmit Command Odd Flag. |
| 24:16 | TRQRSq | TCB Receive Queue Read Sequence. |
| 15:12 | Rsvd. | |
| 11:11 | RCOVld | Receive Command Odd Valid. |
| 10:10 | RCEVld | Receive Command Even Valid. |
| 09:09 | RCOFlg | Receive Command Odd Flag. |
| 08:00 | TRQWSq | TCB Receive Queue Write Sequence. |

RngCtrl

| Bits | Name | Description |
|---|---|---|
| 31:24 | XRngCnt | Transmit Ring Command Count. |
| 23:16 | XRngPtr | Transmit Ring Command Pointer. |
| 15:08 | RRngCnt | Receive Ring Command Count. |
| 23:16 | RRngPtr | Receive Ring Command Pointer. |

DRAM Controller (RcvDrm/Drm|XmtDrm/Drm)

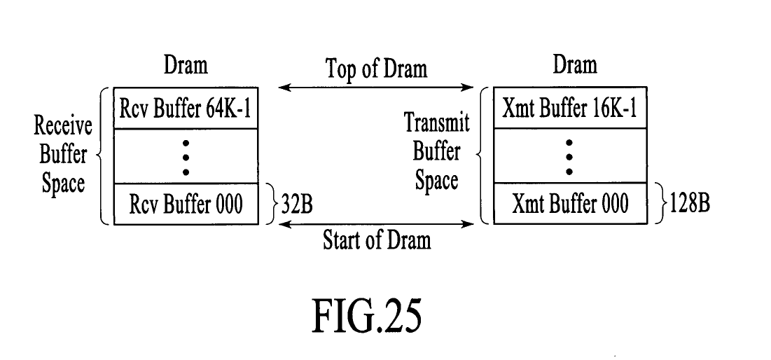

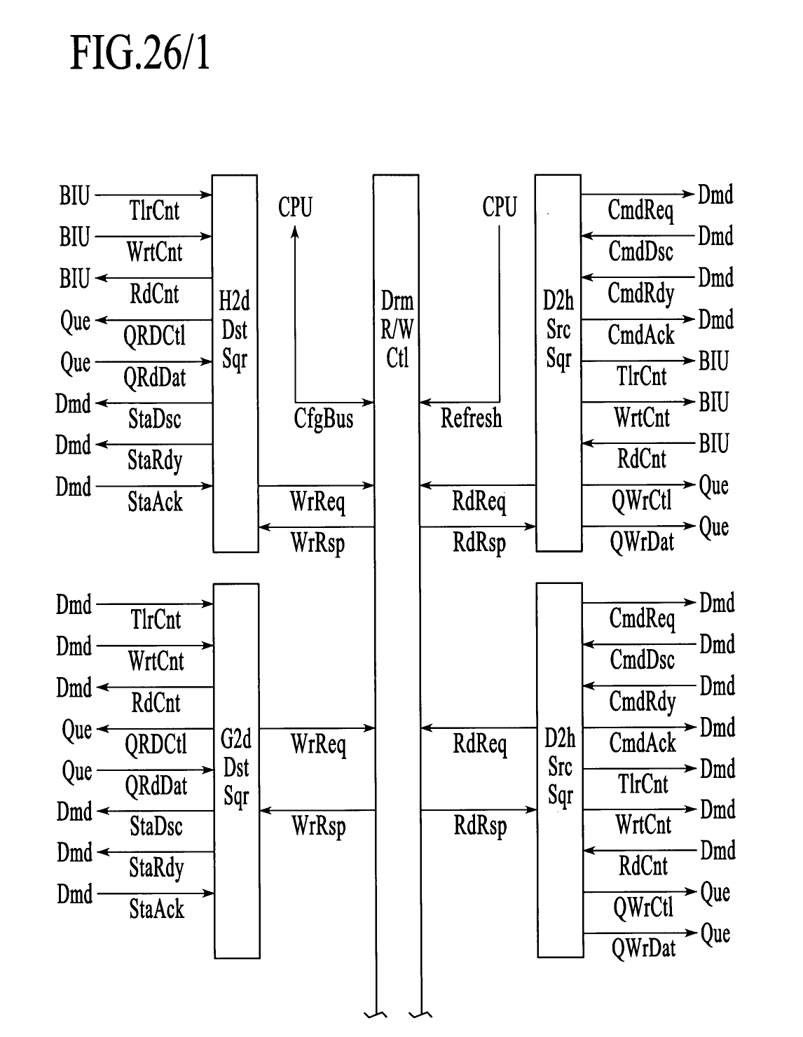

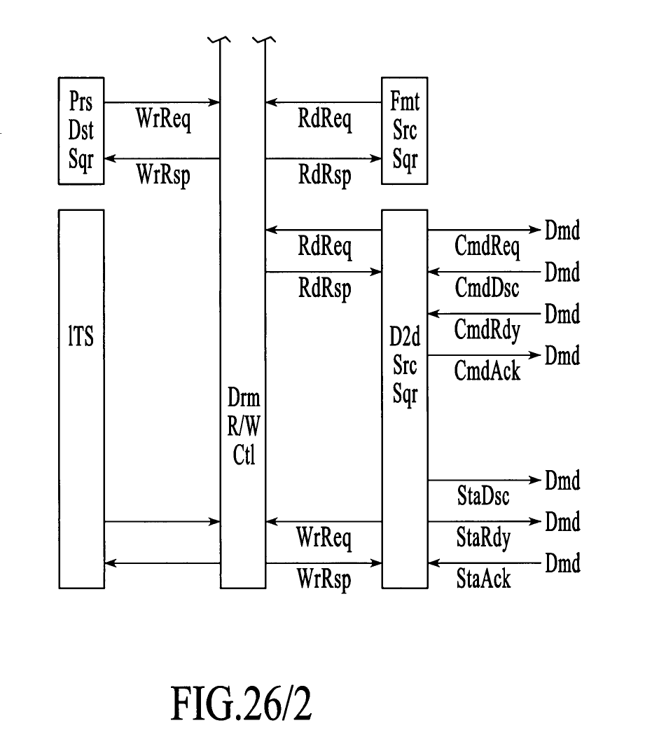

FIG. 26 shows a DRAM Controller. The dram controllers provide access to Dram (RcvDrm/Drm) and Dram (XmtDrm/Drm). RcvDrm primarily serves to buffer incoming packets and TCBs while XmtDrm primarily buffers outgoing data and DrmQ data. FIG. 25 shows the allocation of buffers residing in each of the drams. Both transmit and receive drams are partitioned into data buffers for reception and transmission of packets. At initialization time, select buffer handles are eliminated and the reclaimed memory is instead dedicated to storage of DramQ and TCB data.

XDC supports checksum and crc generation while writing to XmtDrm. XDC also provides a crc appending capability at completion of write data copying. RDC supports checksum and crc generation while reading from RcvDrm and also supports reading additional crc bytes, for testing purposes, which are not copied to the destination. Both controllers provide support for priming checksum and crc functions.

The RDC and XDC modules operate using clocks with frequencies which are independent of the remainder of the system. This allows for optimal speeds based on the characteristics of the chosen dram. Operating at the optimal rate of 500 Mb/sec/pin, the external data bus comprises 64 bits of data and 8 bits of error correcting code. The instantaneous data rate is 4 GB/s for each of the dram subsystems while the average data rate is around 3.5 GB/s due to the overhead associated with each read or write burst. A basic dram block size of 128 bytes is defined which yields a maximum burst size of 16 cycles of 16 B per cycle. Double data rate (DDR) dram is utilized of the type RLDRAM.

The dram controllers implement source and destination sequencers. The source sequencers accept commands to read dram data which is stored into DMA queues preceded by a destination header and followed by a status trailer. The destination sequencers accept address, data and status from DMA queues and save the data to the dram after which a DMA response is assembled and made available to the appropriate module. The dram read/write controller monitors these source and destination sequencers for read and write requests. Arbitration is performed for read requesters during a read service window and for write requesters during a write service window. Each requestor is serviced a single time during the service window excepting PrsDstSqr and XmtSrcSqr requests which are each allowed two DMA requests during the service window. This dual request allowance helps to insure that data late and data early events do not occur. Requests are limited to the maximum burst size of 128 B and must not exceed a size which would cause a burst transfer to span multiple dram blocks. E.g., a starting dram address of 5 would limit XfrCnt to 128-5 or 123.

The Dram Controller includes the following seven functional sub-modules:

PrsDstSqr—Parser to Drm Destination Sequencer monitors the RcvDmaQues and moves data to RcvDrm. No response is assembled.

D2hSrcSqr—Drm to Host Source Sequencer accepts commands from the DmdDspSqr, moves data from RcvDrm to D2hDmaQ preceded by a destination header and followed by a status trailer.

D2gSrcSqr—Drm to GlbRam Source Sequencer accepts commands from the DmdDspSqr, moves data from RcvDrm to D2gDmaQ preceded by a destination header and followed by a status trailer.

H2dDstSqr—Host to Drm Destination Sequencer monitors the H2dDmaQue and moves data to XmtDrm. It then assembles and presents a response to the DmdRspSqr.

G2dDstSqr—G1bRam to Drm Destination Sequencer monitors the G2dDmaQue and moves data to XmtDrm. It then assembles and presents a response to the DmdRspSqr.

D2dCpySqr—Drm to Drm Copy Sequencer accepts commands from the DmdDspSqr, moves data from Drm to Drm then assemble and presents a response to the DmdRspSqr.

XmtSrcSqr—Drm to Formatter Source Sequencer accepts commands from the XmtFmtSqr, moves data from XmtDrm to XmtDmaQ preceded by a destination header and followed by a status trailer.

DMA Director (DmaDir/Dmd)

The DMA Director services DMA request on behalf of the CPU and the Queue Manager. There are eleven distinct DMA channels, which the CPU can utilize and two channels which the Queue Manager can use. The CPU employs a combination of Global Ram resident descriptor blocks and Global Ram resident command queues to initiate DMAs. A command queue entry is always used by the CPU to initiate a DMA operation and, depending on the desired operation, a DMA descriptor block may also used. All DMA channels support the descriptor block mode of operation excepting the Pxy channel. The CPU may initiate TCB, SGL and Hdr DMAs using an abbreviated method which does not utilize descriptor blocks. The abbreviated methods are not available for all channels. Also, for select channels, the CPU may specify the accumulation of checksums and crcs during descriptor block mode DMAs. The following table lists channels and the modes of operation which are supported by each.

| Channel | DscMd | TcbMd | SglMd | HbfMd | PhdMd | CrcAcc | Function |
|---|---|---|---|---|---|---|---|
| Pxh | — | — | — | — | — | — | Global Ram to XmtH Queue |
| Pxl | — | — | — | — | — | — | Global Ram to XmtL Queue |
| D2g | * | — | — | * | — | * | Dram to Global Ram |
| D2h | * | — | — | — | — | * | Dram to Host |
| D2d | * | — | — | — | — | — | Dram to Dram |
| G2d | * | — | — | — | * | * | Global Ram to Dram |
| G2h | * | * | — | — | — | — | Global Ram to Host |
| H2d | * | — | — | — | * | * | Host to Dram |
| H2g | * | * | * | — | — | — | Host to Global Ram |

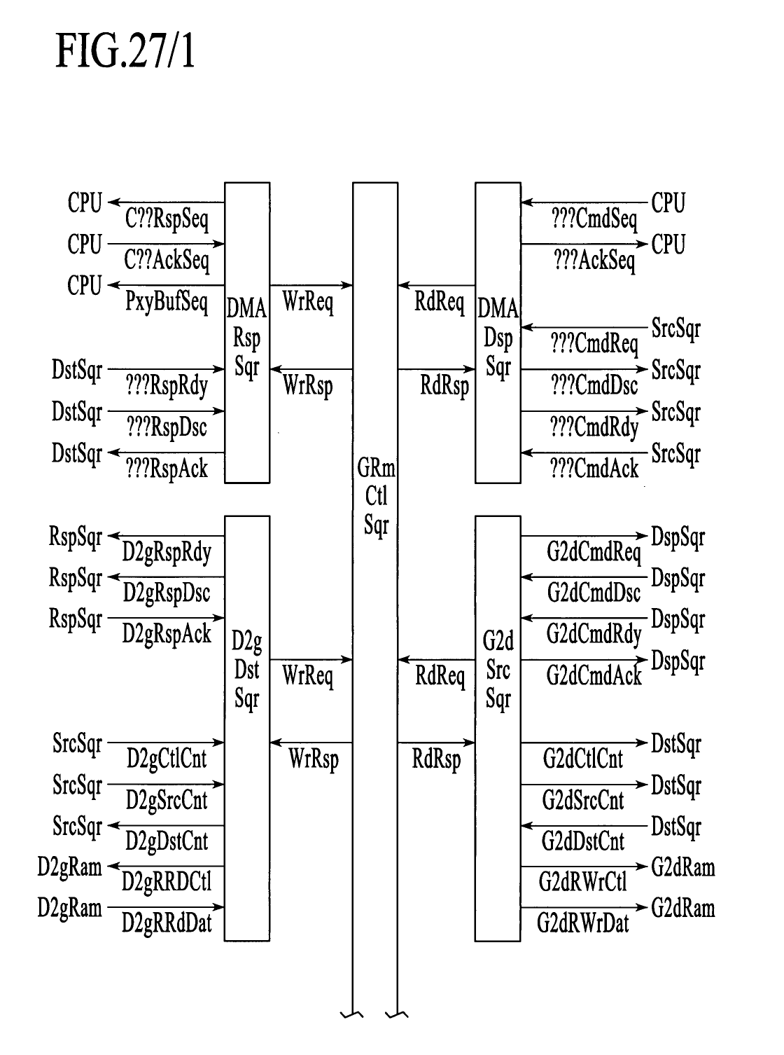

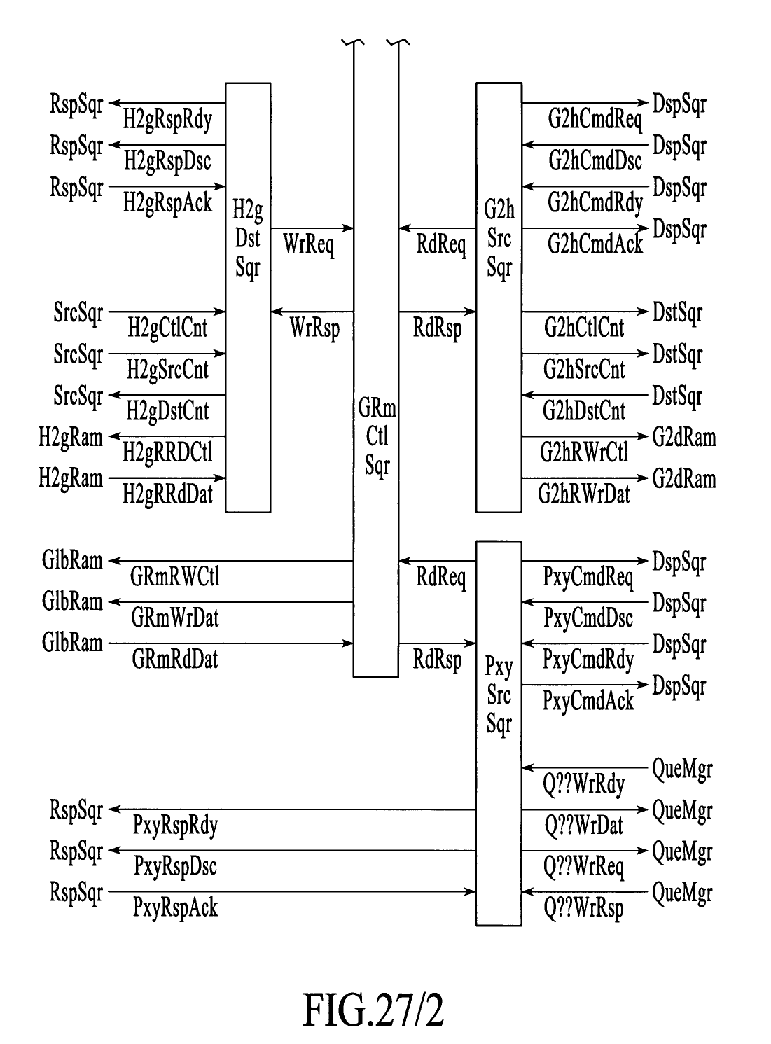

FIG. 27 is a block diagram depicting the functional units of the DMA Director. These units and their functions are:
GRmCtlSqr (Global Ram Control Sequencer).
Performs Global Ram reads and writes as requested.
DmdDspSqr (DMA Director Dispatch Sequencer)
Monitors command queue write sequences and fetches queued entries from Global Ram.
Parses command queue entry.
Fetches DMA descriptors if indicated.
Fetches crc and checksum primers if indicated.
Fetches TCB SGL pointer if indicated.
Presents a compiled command to the DMA source sequencers.
PxySrcSqr (Proxy Source Sequencer)
Monitors the Proxy Queue write sequence and fetches queued command entries from GRm.
Parses proxy commands.
Requests and moves data from GRmCtl to QMgr.
Extracts Proxy Buffer ID and presents to DmdRspSqr.
G2?SrcSqr (G2d/G2h Source Sequencer)
Requests and accepts commands from DmdDspSqr.
Loads destination header into DmaQue.
Requests and moves data from GRmCtl into DmaQue.
Compiles source status trailer and moves into the DmaQue.
?2gDstSqr (D2g/H2g Destination Sequencer)
Unloads and stores destination header from DmaQue.
Unloads data from DmaQue and presents to GRmCtl.
Unloads source status trailer from DmaQue.
Compiles DMA response and presents to DmdRspSqr.
DmdRspSqr (DMA Director Response Sequencer)
Accepts DMA response descriptor from DstSqr.
Updates DmaDsc if indicated.
Saves response to response queue if indicated.

DMA commands utilize configuration information in order to proceed with execution. Global constants such as TCB length, SGL pointer offsets and so on are set up by the CPU at time zero. The configurable constants are:
CmdQBs—Command Queue Base.
EvtQBs—Event Queue Base.
TcbBBs—TCB Buffer Base.
DmaBBs—DMA Descriptor Base.
HdrBBs—Header Buffer Base.
CchBBs—Cache Buffer Base.
HdrBSz—Header Buffer Size.
CchBSz—Cache Buffer Size.
SglPIx—SGL Pointer Index.
MemDscIx—Memory Descriptor Index.
MemDscSz—Memory Descriptor Size.
TRQIx—Receive Queue Index.
PHdrIx—Tcb ProtoHeader Index.
TcbHSz—Tcb ProtoHeader Size.
HDmaSz—Header Dma Sizes A:D.
TRQSz—Receive Queue Size.
TcbBBs—TCB Buffer Base.

Figure X depicts the blocks involved in a DMA. The processing steps of a descriptor, mode DMA are:
CPU obtains use of a CPU Context identifier.
CPU selects a free descriptor buffer available for the current CPU Context identifier.
CPU assembles command variables in the descriptor buffer.
CPU assembles command and deposits it in the DmdCmdQ.
CPU may suspend the current context or continue processing in the current context.
DmdDspSqr detects DmdCmdQ not empty.
DmdDspSqr fetches command queue entry from GRm.
DmdDspSqr uses command queue entry to fetch command descriptor from GRm.
DmdDspSqr presents compiled command to DmaSrcSqr on DmaCmdDsc lines.
DmaSrcSqr accepts DmaCmdDsc.
DmaSrcSqr deposits destination variables (DmaHdr) into DmaQue along with control marker.
DmaSrcSqr presents read request and variables to source read controller.
DrmCtlSqr detects read request and moves data from Drm to DmaSrcSqr along with status.
DmaSrcSqr moves data to DmaDmaQue and increments DmaSrcCnt for each word.
DmaSrcSqr deposits ending status (DmaTlr) in DmaDmaQue along with control marker.
DmaDstSqr fetches DmaHdr and DMA data from DmaQue.
DmaDstSqr request destination write controller to move data to destination.
DmaDstSqr fetches DmaTlr from DmaQue.
DmaDstSqr assembles response descriptor and presents to DmdRspSqr.
DmdRspSqr accepts response descriptor.
DmdRspSqr updates GRm resident DMA descriptor block if indicated.
   Indication is use of descriptor block mode.
DmdRspSqr assembles DMA response event and deposits in C??AtnQ, if indicated.
   Indications are RspEn or occurrence of DMA error.
CPU removes entry from CtxEvtQ and parses it.

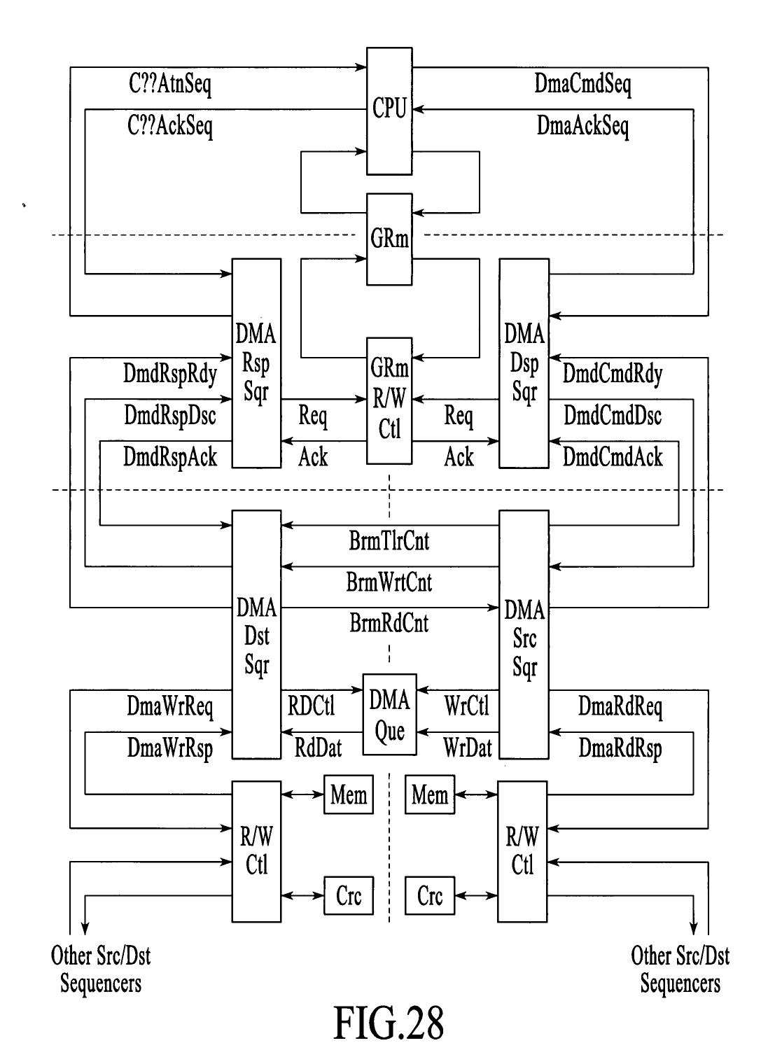

FIG. 28 is a DMA Flow Diagram. The details of each step vary based on the DMA channel and command mode. The following sections outline events which occur for each of the DMA channels.

Proxy Command for Pxh and Pxl

Proxy commands provide firmware an abbreviated method to specify an operation to copy data from GRm resident Proxy Buffers (PxyBufs) on to transmit command queues. DMA variables are retreived and/or calculated using the proxy command fields in conjunction with configuration constants. The command is assembled and deposited into the proxy command queue (PxhCmdQ or PxlCmdQ) by the CPU. Format for the 32-bit, descriptor-mode, command-queue entry is:

| Bits | Name | Queue Word Description |
|---|---|---|
| 31:21 | Rsvd | Zeroes. |
| 20:20 | PxySz | Copy count expressed as units of 16-byte words. |
| | | 0 == 16 words. |
| 19:17 | Rsvd | Zeroes. |
| 16:00 | PxyAd | Address of Proxy Buffer. |

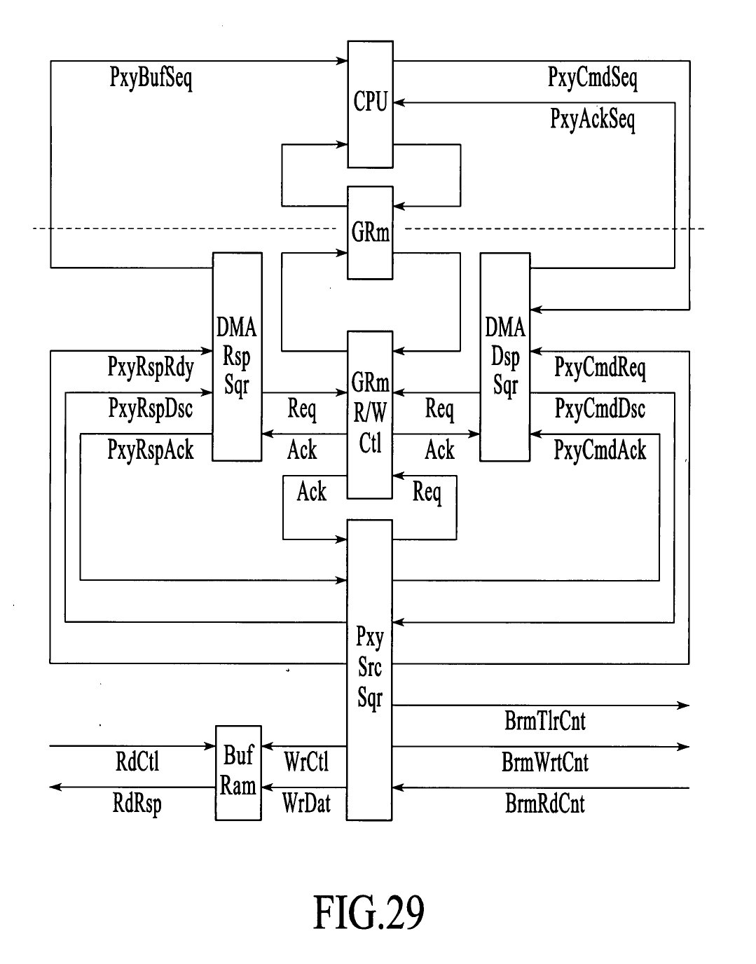

FIG. 29 is a Proxy Flow Diagram. PxyBufs comprise a shared pool of GlbRam. PxyBuf pointers are memory address pointers that point to the start of PxyBufs. Available (free) PxyBufs are each represented by an entry in the Proxy Buffer Queue (PxyBufQ). The pointers are retrieved by the CPU from the PxyBufQ, then inserted into the PxyAd field of a proxy command which is subsequently pushed on to a PxyCmdQ. The PxySrcSqr uses the PxyAd to fetch data from GlbRam then, at command termination, the RspSqr recycles the PxyBuf by pushing the PxyBuf pointer back on to the PxyBufQ.

The format of the 32-bit Proxy Buffer descriptor is:

| Bits | Name | Queue Word Description |
|---|---|---|
| 31:16 | Rsvd | Zeroes. |
| 16:00 | PxyAd | Address of Proxy Buffer. PxyAd[2:0] are zeroes. |

TCB Mode DMA Command for G2h and H2g

TCB Mode (TcbMd) commands provide firmware an abbreviated method to specify an operation to copy TCBs between host based TCB Buffers and GRm resident Cache Buffers (Cbfs). DMA variables are retreived and/or calculated using the DMA command fields in conjunction with configuration constants. The dma size is determined by the configuration constants:
G2hTcbSz
H2gTcbSz

The format of the 32-bit, TCB-mode, command-queue entry is:

| Bits | Name | Description |
|---|---|---|
| 31:31 | RspEn | Response Enable causes an entry to be written to |
| | | one of the 32 response queues (C??EvtQ) following |
| | | termination of a DMA operation. |
| 30:29 | CmdMd | Command Mode must be set to 3. Specifies this entry is |
| | | a TcbMd command. |
| 28:24 | CpuCx | Indicates the context of the CPU |
| | | which originated this command. |
| | | CpuCx also specifies a response queue for |
| | | DMA responses. |
| 23:21 | DmaCx | DMA Context is ignored by hardware. |
| 20:19 | DmaTg | DMA Tag is ignored by hardware. |
| 18:12 | CbfId | Specifies a GRm resident Cache Buffer. |
| 11:00 | TbfId | Specifies host resident TCB Buffer. |

Variable TbfId and configuration constants CchBSz and CchBBs are used to calculate GlbRamras well as HstMem addresses for the copy operation. They are formulated as follows:
GRmAd=CchBBs+(CbfId*CchBSz);
HstAd=TcbBBs+(TbfId*2K);
Command Ring Mode DMA Command for H2g

Command Ring Mode (RngMd) commands provide firmware an abbreviated method to specify an operation to copy transmit and receive command descriptors between host based command rings (XmtRng and RcvRng) and GRm resident Cache Buffers (Cbfs). DMA variables are retreived and/or calculated using the DMA command fields in conjunction with configuration constants. Transmit ring command pointer (XRngPtr) and receive ring command pointer (RRngPtr) are retrieved from the CchBuf incremented and written back. Firmware must decrement transmit ring count (XRngCnt) and receive ring count (RRngCnt). The dma size is fixed at 32. The format of the 32-bit, Ring-mode, command-queue entry is:

| Bits | Name | Description |
|---|---|---|
| 31:31 | RspEn | Response Enable causes an entry to be written to one of the 32 response |
| | | queues (C??EvtQ) following termination of a DMA operation. |
| 30:29 | CmdMd | Command Mode must be set to 2. Specifies this entry is a RngMd command. |
| 28:24 | CpuCx | Indicates the context of the CPU which originated this command. |
| | | CpuCx also specifies a response queue for DMA responses. |
| 23:21 | DmaCx | DMA Context is ignored by hardware. |
| 20:20 | OddSq | Selects the odd or even command buffer of the TCB cache as the destination of |
| | | the command descriptor. This bit can be taken from XRngPtr[0] or RRngPtr [0]. |
| 19:19 | XmtMd | When set, indicates that the transfer is from the host transmit command ring to |
| | | the CchBuf. When reset, indicates that the transfer is from the host receive |
| | | command ring to the CchBuf. |
| 18:12 | CbfId | Specifies a GRm resident Cache Buffer. |
| 11:00 | TbfId | Specifies host resident TCB Buffer. |

Variables TbfId and CbfId and configuration constants XRngBs, RRngBs, XRngSz, RRngSz, XmtCmdIx, CchBSz and CchBBs are used to calculate GlbRam as well as HstMem addresses for the copy operation. They are formulated as follows for transmit command ring transfers:
GRmAd=CchBBs+(CbfId*CchBSz)+XmtCmdIx+32;
HstAd=XRngBs+((TbfId<<XRngSz)+XRngPtr)*32);

They are formulated as follows for receive command ring transfers:
GRmAd=CchBBs+(CbfId*CchBSz)+RcvCmdIx+32;
HstAd=XRngBs+((TbfId<<RRngSz)+RRngPtr)*32);
SGL Mode DMA Command for H2g

SGL Mode (SglMd) commands provide firmware an abbreviated method to specify an operation to copy SGL entries from the host resident SGL to the GRm resident TCB. DMA variables are retreived and/or calculated using the DMA command fields in conjunction with configuration constants and TCB resident variables. Either a transmit or receive SGL may be specified via the CmdMd[0]. This command is assembled and deposited into the H2g Dispatch Queue by the CPU. The format of the 32-bit, descriptor-mode, command-queue entry is:

| Bits | Name | Description |
|---|---|---|
| 31:31 | RspEn | Response Enable causes an entry to be written to one of the 32 response queues |
| | | (C??EvtQ) following termination of a DMA operation. |
| 30:29 | CmdMd | Command Mode==1 specifies that an SGL entry is to be fetched. |
| 28:24 | CpuCx | CPU Context indicates the context of the CPU which originated this command. |
| | | CpuCx specifies a response queue for DMA responses. |
| 23:21 | DmaCx | DMA Context is ignored by hardware. |
| 20:20 | OddSq | Selects the odd or even command buffer of the TCB cache as the source of the SGL |
| | | pointer. Selects the opposite command buffer as the destination of the memory |
| | | descriptor. This bit can be taken from XRngPtr[0] or RRngPtr[0]. |
| 19:19 | XmtMd | When set, indicates that the transfer should use the transmit command buffers of |
| | | the TCB cache buffer as the source of the SGL pointer and the destination of the |
| | | memory descriptor. When reset, indicates that the transfer should use the |
| | | receive command buffers of the TCB cache buffer as the source of the SGL pointer |
| | | and the destination of the memory descriptor. |
| 18:12 | CbfId | Specifies the Cache Buffer to which the SGL entry will be transferred. |
| 11:00 | Rsvd | Ignored. |

CmdMd and CbfId are used along with configuration constants CchBSz, CchBBs, SglPIx and MemDscIx to calculate addresses. The 64-bit SGL pointer, which resides in a Cache Buffer, is fetched using an address formulated as:
GRmAd=CchBBs+(CbfId*CchBSz)+SglPIx+(IxSel*MemDscSz);

The retreived SGL pointer is then used to fetch a 12-byte memory descriptor from host memory which is in turn written to the Cache Buffer at an address formulated as:
GRmAd=CchBBs+(CbfId*CchBSz)+MemDscIx+(IxSel*16);

The SGL pointer is then incremented by the configuration constant SGLIncSz then written back to the CchBuf.

Event Mode DMA Command for G2h

Event Mode (EvtMd) commands provide firmware an abbreviated method to specify an operation to copy an event descriptor between GRm and HstMem. DMA variables are retreived and/or calculated using the DMA command fields in conjunction with configuration constants. The DMA size is fixed at 16 bytes. Data are copied from an event descriptor buffer determined by {DmaCx,CpuCx}.

The format of the 32-bit, Event-mode, command-queue entry is:

| Bits | Name | Description |
|---|---|---|
| 31:31 | RspEn | Response Enable causes an entry to be written to |
| | | one of the 32 response queues (C??EvtQ) following |
| | | termination of a DMA operation. |
| 30:29 | CmdMd | Command Mode must be set to 2. Specifies this entry is |
| | | a EvtMd command. |
| 28:24 | CpuCx | Indicates the context of the CPU which originated this |
| | | command. CpuCx also specifies a response queue |
| | | for DMA responses. |
| 23:21 | DmaCx | DMA Context specifies the DMA descriptor block in |
| | | which the event descriptor (EvtDsc) resides. |
| 20:19 | DmaTg | DMA Tag is ignored by hardware. |
| 17:15 | NEQId | Specifies a host resident NIC event queue. |
| 14:00 | NEQSq | NIC event queue write sequence specifies which entry |
| | | to write. |

Command variables NEQId and NEQSq and configuration constants DmaBBs, NEQSZ and NEQBs are used to calculate the HstMem and GlbRam addresses for the copy operation. They are formulated as follows:
GRmAd=DmaBBs+{CpuCx,DmaCx,5′b00000};
HstAd=NEQBs+{(NEQId*NicQSz)+NEQSq,5′b00000};
Prototype Header Mode DMA Command for H2d Prototype Header Mode (PhdMd) commands provide firmware an abbreviated method to specify an operation to copy prototype headers to DRAM Buffers from host resident TCB Buffers (Tbf). DMA variables are retreived and/or calculated using the DMA command fields in conjunction with configuration constants. This command is assembled and deposited into a dispatch queue by the CPU. CmdMd[0] selects the dma size as follows:
H2dHdrSz [CmdMd[0]]

The format of the 32-bit, protoheader-mode, command-queue entry is:

| Bits | Name | Description |
|---|---|---|
| 31:31 | RspEn | Response Enable causes an entry to be written to one of |
| | | the 32 response queues (C??EvtQ) following termination |
| | | of a DMA operation. |
| 30:29 | CmdMd | Command Mode must be set to 2 or 3. It specifies this |
| | | entry is a HdrMd command. |
| 28:24 | CpuCx | CPU Context indicates the context of the CPU which |
| | | originated this command. CpuCx specifies a response |
| | | queue for DMA responses and is also used to specify a |
| | | GlbRam-resident Header Buffer. |
| 23:12 | XbfId | Specifies a DRAM Transmit Buffer. |
| 11:00 | TbfId | Specifies host resident TCB Buffer. |

Configuration constants PHdrIx and CmpBBs are used to calculate the host address for the copy operation. The addresses are formulated as follows:
HstAd=(TbfId*1K)+CmpBBs;
DrmAd=XbfId*256;

This command does not include a DmaCx or DmaTg field. Any resulting response will have the DmaCx and DmaTg fields set to 5′b11011.

Prototype Header Mode DMA Command for G2d

Prototype. Header Mode (PhdMd) commands provide firmware an abbreviated method to specify an operation to copy prototype headers to DRAM Buffers from GRm resident TCB Buffers (Thf). DMA variables are retreived and/or calculated using the DMA command fields in conjunction with configuration constants. This command is assembled and deposited into a dispatch queue by the CPU. CmdMd[1] selects the dma size as follows:
G2dHdrSz [CmdMd [0]]

The format of the 32-bit, protoheader-mode, command-queue entry is:

| Bits | Name | Description |
|---|---|---|
| 31:31 | RspEn | Response Enable causes an entry to be written to one of |
| | | the 32 response queues (C??EvtQ) following |
| | | termination of a DMA operation. |
| 30:29 | CmdMd | Command Mode must be set to 2 or 3. It specifies this |
| | | entry is a HdrMd command. |
| 28:24 | CpuCx | CPU Context indicates the context of the CPU which |
| | | originated this command. CpuCx specifies a response |
| | | queue for DMA responses and is also used to specify |
| | | a GlbRam-resident Header Buffer. |
| 23:21 | DmaCx | DMA Context is ignored by hardware. |
| 20:19 | DmaTg | DMA Tag is ignored by hardware. |
| 18:12 | CbfId | Specifies a GRm resident Cache Buffer. |
| 11:00 | XbfId | Specifies a DRAM Transmit Buffer. |

Configuration constants CchBSz and CchBBs are used to calculate GlbRam and dram addresses for the copy operation. They are formulated as follows:
GRmAd=(CbfId*CchBSz)+CchBBs+PHdrIx;
Drd=XbfId*256;
Header Buffer Mode DMA Command for D2g

Header Buffer Mode (HbfMd) commands provide firmware an abbreviated method to specify an operation to copy headers from DRAM Buffers to GRm resident Header Buffers (Hbf). DMA variables are retreived and/or calculated using the DMA command fields in conjunction with configuration constants. This command is assembled and deposited into a dispatch queue by the CPU.

The format of the 32-bit, header-mode, command-queue entry is:

| Bits | Name | Description |
|---|---|---|
| 31:31 | RspEn | Response Enable causes an entry to be written to one of |
| | | the 32 response queues (C??EvtQ) following |
| | | termination of a DMA operation. |
| 30:29 | CmdMd | Command Mode must be set to 1. It specifies this |
| | | entry is a HdrMd command. |
| 28:24 | CpuCx | CPU Context indicates the context of the CPU which |
| | | originated this command. CpuCx specifies a response |
| | | queue for DMA responses and is also used to specify |
| | | a GlbRam-resident Header Buffer. |
| 23:21 | DmaCx | DMA Context is ignored by hardware. |
| 20:19 | DmaTg | DMA Tag is ignored by hardware. |
| 18:17 | DmaCd | DmaCd selects the dma size as follows: |
| | | D2gHdrSz[DmaCd] |
| 16:16 | HbfId | Used in conjunction with CpuCx to specify |
| | | a Header Buffer. |
| 15:00 | RbfId | Specifies a DRAM Receive Buffer for the D2g channel. |

Configuration constants HdrBSz and HdrBBs are used to calculate GlbRam and dram addresses for the copy operation. They are formulated as follows:
GRmAd=HdrBBs+({CpuCx,HbfId}*HdrBSz);
DrmAd=RbfId*32;
Descriptor Mode DMA Command for D2h, D2g, D2d, H2d, H2g, G2d an G2h

Descriptor Mode (DscMd) commands allow firmware greater flexibility in defining copy operations through the inclusion of additional variables assembled within a GlbRam-resident DMA Descriptor Block (DmaDsc). This command is assembled and deposited into a DMA dispatch queue by the CPU. The format of the 32-bit, descriptor-mode, command-queue entry is:

| Bits | Name | Description | |
|---|---|---|---|
| 31:31 | RspEn | Response Enable causes an entry to be written to one of the 32 response queues | |
| | | (C??EvtQ) following termination of a DMA operation. | |
| 30:29 | CmdMd | Command Mode must be set to 0. It specifies this entry is a DscMd command. | |
| 28:24 | CpuCx | CPU Context indicates the context of the CPU which originated this command. This | |
| | | field, in conjunction with DmaCx, is used to create a GlbRam address for the | |
| | | retrieval of a DMA descriptor block. CpuCx also specifies a response queue for | |
| | | DMA Responses and specifies a crc/checksum accumulator to be used for the | |
| | | crc/checksum accumulate option. | |
| 23:21 | DmaCx | DMA Context is used along with CpuCx to retreive a DMA descriptor block. | |
| 20:19 | DmaTg | DMA Tag is ignored by hardware. | |
| 18:18 | Rsvd | Ignored by hardware. | |
| 17:17 | AccLd | CrcAcc Load specifies that CrcAcc be initialized with Crc/Checksum values | |
| | | fetched from GlbRam at location ChkAd. This option is valid only when | |
| | | ChkAd != 0. | |
| 16:03 | ChkAd | Check Address specifies GRmAd[16:03] for fetch/store of crc and checksum values. | |
| | | ChkAd == 0 indicates that the accumulate function should start with a checksum | |
| | | value of 0 and that the accumulated checksum value should be stored in the DMA | |
| | | descriptor block only, that crc functions must be disabled and that the CrcAccs | |
| | | must not be altered. If ChkAd == 0 then AccLd and TstSz/AppSz are ignored. | |
| | | The accumulator functions are valid for D2h, D2g, H2d and G2d channels only. | |
| 02:00 | TstSz | This option is valid for D2h and D2g channels only. Causes TstSz bytes of source | |
| | | data to be read and accumulated but not copied to the destination. A maximum | |
| | | value of 7 allows a four byte crc and up to three bytes of padding to be tested. | |
| 02:00 | AppSz | This option is valid for H2d and G2d channels only. Causes AppSz bytes of the | |
| | | CrcAcc and zeroes to be appended to the end of data being copied. This option | |
| | | is valid only when ChkAd != 0. An append size of one to four bytes results in | |
| | | the same number of bytes of crc being sent to the checksum accumulator and | |
| | | written to the destination. An append size greater than four byte results in | |
| | | the appending of the crc plus zeroes. | |
| | | AppSz | Appended |
| | | 0 | {Null} |
| | | 1 | {CrcAcc[31:24]} |
| | | 2 | {CrcAcc[31:16]} |
| | | 3 | {CrcAcc[31:08]} |
| | | 4 | {CrcAcc[31:00]} |
| | | 5 | {08′b0, CrcAcc[31:0]} |
| | | 6 | {16′b0, CrcAcc[31:0]} |
| | | 7 | {24′b0, CrcAcc[31:0]} |

DMA Descriptor

The DMA Descriptor (DmaDsc) is an extension utilized, by DscMd DMA commands, to allow added specification of DMA variables. This method has the benefit of retaining single-word commands for all dispatch queues, thereby retaining the non-locked queue access method. The DmaDsc variables are assembled in, GlbRam resident, DmaDsc Buffers (DmaDsc). Each CpuCx has, preallocated, GlbRam memory which accommodates eight DmaDscs per CpuCx for a total of 256 DmaDscs. The DmaDscs are accessed using a GlbRam starting address formulated as:
GRmAd=DmaBBs+({CpuCx,DmaCx}*16)

DmaDscs are fetched by the DmdDspSqr and used, in conjunction with DmaCmds, to assemble a descriptor for presentation to the various DMA source sequencers. DmaDscs are also updated, upon DMA termination, with ending status comprising variables which reflect the values of address and length counters.

| Word | Bits | Name | Description |
|---|---|---|---|
| 03 | 31:00 | HstAdH | Host Address High provides the address bits [63:32] used by the BIU. This |
| | | | field is updated at transfer termination if either RspEn is set or an error |
| | | | occured. HstAdH is valid for D2h, G2h, H2d and H2g channels only. |
| 02 | 31:00 | HstAdL | Host Address Low provides the address bits [31:00] used by the BIU. This |
| | | | field is updated at transfer termination. HstAdL is valid for D2h, G2h, |
| | | | H2d and H2g channels only. |
| | 27:00 | DrmAdr | Dram Ram Address is used as a source address for D2d. Updated at transfer |
| | | | termination. |
| | 16:00 | GLitAd | Global Ram Address is used as a destination address for D2g and as a source |
| | | | address for G2d DMAs. Updated at transfer termination. |
| 01 | 31:31 | Rsvd | Reserved. |
| | 30:30 | RlxDbl | Relax Disable clears the relaxed-ordering-bit in the host bus attributes. |
| | | | It is valid for D2h, G2h, H2d and H2g channels only. |
| | 29:29 | SnpDbl | Snoop Disable Sets the no-snoop-bit in the host bus attributes. It is |
| | | | valid for D2h, G2h, H2d and H2g channels only. |
| | 28:28 | PadEnb | Pad Enable causes data copies to RcvDrm or XmtDrm, which do not terminate |
| | | | on an eight byte boundary, to be padded with trailing zeroes up to the |
| | | | eight byte boundary. This has the effect of inhibiting read-before-write |
| | | | cycles, thereby improving performance. |
| | 27:00 | DrmAdr | Dram Address provides the dram address for RcvDrm and XmtDrm. This field |
| | | | is updated at transfer termination. DrmAd is valid for D2h, D2g, H2d and |
| | | | G2d channels only. |
| | 16:00 | GLitAd | Global Ram Address is used as a destination address for H2g and as a source |
| | | | address for G2h DMAs. This field is updated at transfer termination. |
| 00 | 31:26 | Rsvd | Reserved. |
| | 25:23 | FuncId | Specifies the PCIe function ID for transfers and interrupts. |
| | 22:22 | IntCyc | Used by the G2h channel to indicate that an interrupt set or clear should |
| | | | be performed upon completion of the transfer operation. |
| | 21:21 | IntClr | 1: Interrupt clear. 0: Interrupt set. For legacy interrupts. |
| | 20:16 | IntVec | Specifies the interrupt vector for message signaled interrupts. |
| | 15:00 | XfrLen | Transfer Length specifies the quantity of data bytes to transfer. A length |
| | | | of zero indicates that no data should be transferred. Functions as storage |
| | | | for the checksum accumulated during an error free transfer and is updated |
| | | | at transfer termination. If a transfer error is detected, this field will |
| | | | instead contain the residual transfer length. |

DMA Event for D2h, D2g, D2d, H2d, H2g, G2d and G2h

DMA Event (DmaEvt) is a 32-bit entry which is deposited into one of the 32 Context Dma Event Queues (C??EvtQ), upon termination of a DMA operation, if RspEn is set or if an error condition was encountered. The event is used to resume processing by a CPU Context and to relay DMA status. The format of the 32-bit event descriptor is as follows:

| Bits | Name | Description |
|---|---|---|
| 31:31 | RspEn | Copied from dispatch queue entry. |
| 30:29 | CmdMd | Copied from dispatch queue entry. |
| 28:24 | CpuCx | Copied from dispatch queue entry. |
| 23:21 | DmaCx | Copied from dispatch queue entry. Forced to 3′b111 for |
| | | H2d PhdMd. |
| 20:19 | DmaTg | Copied from dispatch queue entry. Forced to 2′b11 for |
| | | H2d PhdMd. |
| 18:15 | DmaCh | Indicates the responding DMA channel. |
| 14:05 | Rsvd | Reserved. |
| 04:04 | RdErr | Set for source errors. Cleared for destination errors. |
| 03:00 | ErrCd | Error code. 0 - No error. |

A response is forced regardless of the state of the RspEn bit anytime an error is detected. Next, the DmaErr bit of the xxx register will be set. Dma option is not updated for commands which encounter an error, but the dma descriptor is updated to reflect the residual transfer count at time of error.

Ethernet MAC and PHY

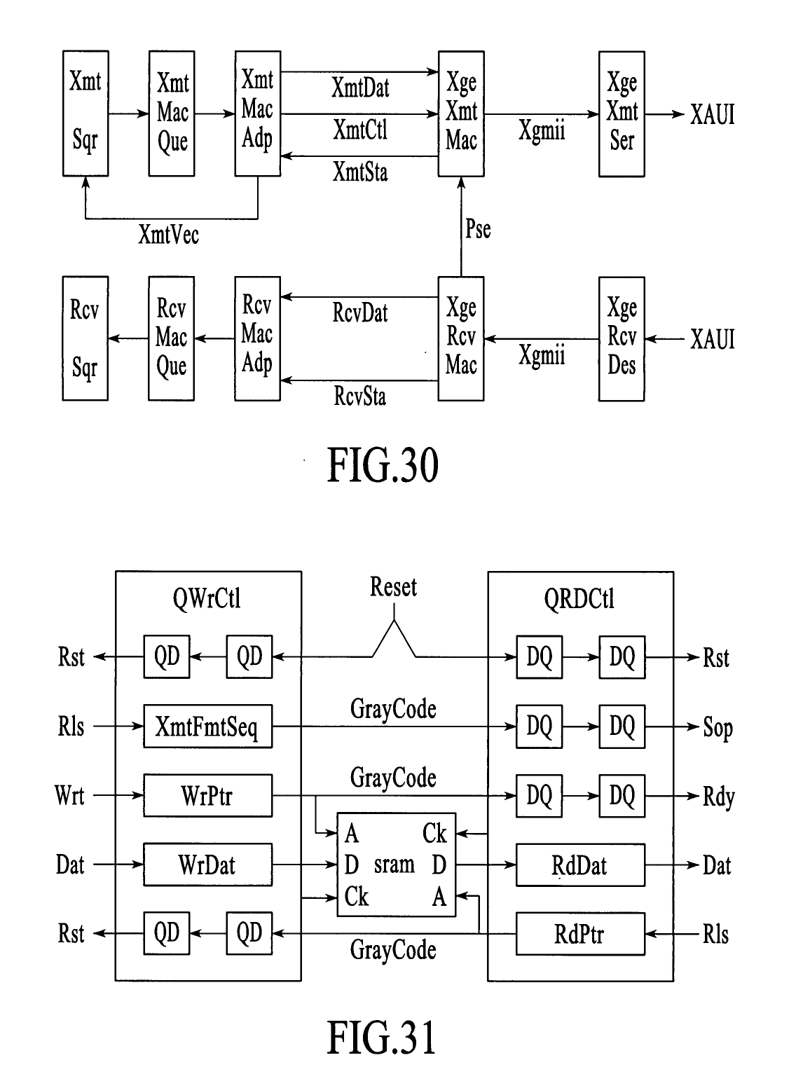

FIG. 30 shows a Ten-Gigabit Receive Mac In Situ.

FIG. 31 shows a Transmit/Receive Mac Queue Implementation.

Receive Sequencer (RcvSqr/RSq)

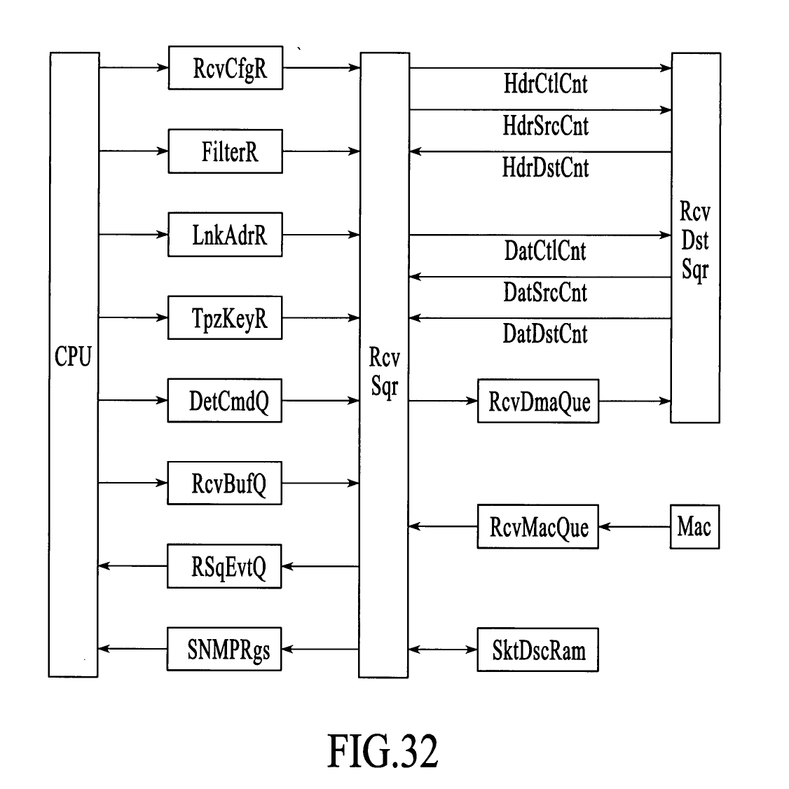

The Receive Sequencer is depicted in FIG. 32 in situ along with connecting modules. RcvSqr functional sub-modules include the Receive Parser (RcvPrsSqr) and the Socket Detector (SktDetSqr). The RcvPrsSqr parses frames, DMAs them to RcvDrm and passes socket information on to the SktDetSqr. The SktDetSqr compares the parse information with socket descriptors from SktDscRam, compiles an event descriptor and pushes it on to the RSqEvtQ. Two modes of operation provide support for either a single ten-gigabit mac or for four one-gigabit macs.

The receive process steps are:
RcvPrsSqr pops a RbfId off of the RcvBufQ.
RcvPrsSqr waits for 1110B of data or PktRdy from RcvMacQ.
RcvPrsSqr pushes RcvDrmAd onto PrsHdrQ.
RcvPrsSqr parses frame headers and moves to RcvDmaQ.
RcvPrsSqr moves residual of 110 B of data from RcvMacQ to PrsHdrQ.
RcvPrsSqr pushes RcvDrmAd+128 onto PrsDatQ.
RcvPrsSqr moves residual frame data from RcvMacQ to PrsDatQ and releases to RcvDstSqr.
RcvDstSqr pops RcvDrmAd+128 off of RcvDatQ then pops data and copies to RcvDrm.
RcvPrsSqr prepends parse header to frame header on PrsHdrQ and releases to RcvDstSqr.
RcvDstSqr pops RcvDrmAd off of RcvDatQ then pops header+data and copies to RcvDrm.
RcvPrsSqr assembles and pushes PrsEvtDsc onto PrsEvtQ.
SktDetSqr pops PrsEvtDsc off of PrsEvtQ.
SktDetSqr uses Toeplitz hash to select SktDscGrp in SktDscRam.
SktDetSqr compares PrsEvtDsc with SktDscGrp entries (SktDscs).
SktDetSqr assembles RSqEvtDsc based on results and pushes onto RSqEvtQ.
CPU pops RSqEvtDsc off of RSqEvtQ.
CPU performs much magic here.

CPU pushes RbfId onto RcvBufQ.

Receive Configuration Register (RcvCfgR)

| Bits | Name | Description |
|---|---|---|
| 031:031 | Reset | Force reset asserted to the receive sequencer. |
| 030:030 | DetEn | Socket detection enable. |
| 029:029 | RcvFsh | Force the receive sequencer to flush prefetched RcvBufs. |
| 028:028 | RcvEnb | Allow parsing of receive packets. |
| 027:027 | RcvAll | Allow forwarding of all packets regardless of destination address. |
| 026:026 | RcvBad | Allow forwarding of packets for which a link error was detected. |
| 025:025 | RcvCtl | Allow forwarding of 802.3X control packets. |
| 024:024 | CmdEnb | Allow execution of 802.3X control packet commands; e.g. pause. |
| 023:023 | AdrEnH | Allow forwarding of packets with the MacAd == RcvAddrH. |
| 022:022 | AdrEnG | Allow forwarding of packets with the MacAd == RcvAddrG. |
| 021:021 | AdrEnF | Allow forwarding of packets with the MacAd == RcvAddrF. |
| 020:020 | AdrEnE | Allow forwarding of packets with the MacAd == RcvAddrE. |
| 019:019 | AdrEnD | Allow forwarding of packets with the MacAd == RcvAddrD. |
| 018:018 | AdrEnC | Allow forwarding of packets with the MacAd == RcvAddrC. |
| 017:017 | AdrEnB | Allow forwarding of packets with the MacAd == RcvAddrB. |
| 016:016 | AdrEnA | Allow forwarding of packets with the MacAd == RcvAddrA. |
| 015:015 | TzIpV6 | Include tcp port during Toeplitz hashing of TcpIpV6 frames. |
| 014:014 | TzIpV4 | Include tcp port during Toeplitz hashing of TcpIpV4 frames. |
| 013:000 | Rsvd | Reserved. |

Multicast-Hash Filter Register (FilterR)

| Bits | Name | Description |
|---|---|---|
| 127:000 | Filter | Hash bucket enable for multicast filtering. |

Link Address Registers H:A (LnkAdrR)

| Bits | Name | Description |
|---|---|---|
| 047:000 | LnkAdr | Link receive address. One register for each of the 8 |
| | | link addresses. |

Toeplitz Key Register (TpzKeyR)

| Bits | Name | Description |
|---|---|---|
| 319:000 | TpzKey | Teoplizt-hash key register. |

Dectect Configuration Register (DetCfgR)

| Bits | Name | Description |
|---|---|---|
| 031:031 | Reset | Force reset asserted to the socket detector. |
| 030:030 | DetEn | |
| 029:000 | Rsvd | Zeroes. |

Receive Buffer Queue (RcvBufQ)

| Bits | Name | Description |
|---|---|---|
| 031:016 | Rsvd | Reserved. |
| 015:000 | RbfId | Drm Buffer id. |

Receive Mac Queue (RcvMacQ)

| if (Type == Data) { | | |
|---|---|---|
| Bits | Name | Description |
| ------- | ------ | ----------- |
| 035:035 | OddPar | Odd parity. |
| 034:034 | WrdTyp | 0-Data. |
| 033:032 | WrdSz | 0-4 bytes. 1-3 bytes. 2-2 bytes. 3-1 bytes. |
| 031:000 | RcvDat | Receive data. |
| } else { | | |
| Bits | Name | Description |
| ------- | ------ | ----------- |
| 035:035 | OddPar | Odd parity. |
| 034:034 | WrdTyp | 1-Status. |
| 033:029 | Rsvd | Zeroes. |
| 028:023 | LnkHsh | Mac Crc hash bits. |
| 022:022 | SvdDet | Previous carrier detected. |
| 021:021 | LngEvt | Long event detected. |
| 020:020 | PEarly | Receive frame missed. |
| 019:019 | DEarly | Receive mac queue overrun. |
| 018:018 | FcsErr | Crc-error detected. |
| 017:017 | SymOdd | Dribble-nibble detected. |
| 016:016 | SymErr | Code-violation detected. |
| 015:000 | RcvLen | Receive frame size (includes crc). |
| } | | |

Parse Event Queue (PrsEvtQ)

| Bits | Name | Description |
|---|---|---|
| 315:188 | SrcAdr | Ip Source Address. IpV4 address is left justified. |
| 187:060 | DstAdr | Ip Destination Address. IpV4 address is left justified. |
| 059:044 | SrcPrt | Tcp Source Port. |
| 043:029 | DstPrt | Tcp Destination Port. |
| 027:020 | SktHsh | Socket Hash. |
| 019:019 | NetVer | 1 = IPV6. 0 = IPV4. |
| 018:018 | RcvAtn | Detect Disable = RcvSta[RcvAtn]. |
| 017:016 | PktPri | Packet priority. |
| 015:000 | RbfId | Receive Packet Id. (Dram packet buffer id.) |

Receive Buffer

| | Name | Description |
|---|---|---|
| Bytes | | |
| ???:018 | RcvDat | Receive frame data begins here. |
| 017:016 | Rsvd | Zeroes. |
| 015:012 | TpzHsh | Toeplitz hash. |
| 011:011 | NetIx | Network header begins at offset NetIx. |
| 010:010 | TptIx | Transport header begins at offset TptIx. |
| 009:009 | SktHsh | Socket hash (Calc TBD). |
| 008:008 | LnkHsh | Link address hash (Crc16[5:0]). |
| 007:006 | TptChk | Transport checksum. |
| 005:004 | RcvLen | Receive frame byte count (Includes crc). |
| 003:000 | RcvSta | Receive parse status. |
| Bits | | |
| 031:031 | RcvAtn | Indicates that any of the following occured: |
| | | A link error was detected. |
| | | An Ip error was detected. |
| | | A tcp or udp error was detected. |
| | | A link address match was not detected. |
| | | Ip version was not 4 and was not 6. |
| | | Ip fragmented and offset not zero. |
| | | An Ip multicast/broadcast address was detected. |
| 030:025 | TptSta | Transport status field. |
| | | 6′b1x_xxxx = Transport error detected. |
| | | 6′b10_0011 = Transport checksum error. |
| | | 6′b10_0010 = Transport underflow error. |
| | | 6′b10_0001 = Reserved. |
| | | 6′b10_0000 = Transport header length error. |
| | | 6′b0x_xxxx = No transport error detected. |
| | | 6′b01_xxxx = Transport flags detected. |
| | | 6′b0x_1xxx = Transport options detected. |
| | | 6′b0x_x111 = Reserved. |
| | | 6′b0x_x110 = DDP. |
| | | 6′b0x_x101 = Session iSCSI. |
| | | 6′b0x_x100 = Session NFS-RPC. |
| | | 6′b0x_x011 = Session FTP. |
| | | 6′b0x_x010 = Session WWW-HTTP. |
| | | 6′b0x_x001 = Session SMB. |
| | | 6′b0x_x000 = Session unknown. |
| 024:016 | NetSta | Network status field. |
| | | 9′b1_xxxx_xxxx = Network error detected. |
| | | 9′b1_0000_0011 = Checksum error. |
| | | 9′b1_0000_0010 = Underflow error. |
| | | 9′b1_0000_0001 = Reserved. |
| | | 9′b1_0000_0000 = Header length error. |
| | | 9′b0_xxxx_xxxx = No network error detected. |
| | | 9′b0_1xxx_xxxx = Network overflow detected |
| | | 9′b0_x1xx_xxxx = Network multicast/broadcast |
| | | detected |
| | | 9′b0_xx1x_xxxx = Network options detected. |
| | | 9′b0_xxx1_xxxx = Network Offset detected. |
| | | 9′b0_xxxx_1xxx = Network fragmentation |
| | | detected. |
| | | 9′b0_xxxx_x1xx = Reserved. |
| | | 9′b0_xxxx_x011 = Reserved. |
| | | 9′b0_xxxx_x010 = Transport UDP. |
| | | 9′b0_xxxx_x001 = Transport Tcp. |
| | | 9′b0_xxxx_x000 = Transport unknown. |
| 015:014 | PktPri | Receive prioirity. |
| 013:012 | Rsvd | Zeroes. |
| 011:008 | LnkCd | Link address detection code. |
| | | 4′b1111 = Link address H. |
| | | 4′b1110 = Link address G. |
| | | 4′b1101 = Link address F. |
| | | 4′b1100 = Link address E. |
| | | 4′b1011 = Link address D. |
| | | 4′b1010 = Link address C. |
| | | 4′b1001 = Link address B. |
| | | 4′b1000 = Link address A. |
| | | 4′b01xx = Reserved. |
| | | 4′b0011 = Link broadcast. |
| | | 4′b0010 = Link multicast. |
| | | 4′b0001 = Link control multicast. |
| | | 4′b0000 = Link address not detected. |
| 007:000 | LnkSta | Link status field. |
| | | 8′b1xxx_xxxx = Link error detected. |
| | | 8′b1000_0111 = RcvMacQ parity error. |
| | | 8′b1000_0110 = Data early. |
| | | 8′b1000_0101 = Buffer overflow - pkt size > buf |
| | | size. |
| | | 8′b1000_0100 = Link code error. |
| | | 8′b1000_0011 = Link dribble nibble. |
| | | 8′b1000_0010 = Link crc error. |
| | | 8′b1000_0001 = Link Overflow - pkt size > Llc |
| | | size. |
| | | 8′b1000_0000 = Link Underflow - pkt size < Llc |
| | | size. |
| | | 8′b01xx_xxxx = Magic packet. |
| | | 8′b0x1x_xxxx = 802.3 packet. |
| | | 8′b0xx1_xxxx = Snap packet. |
| | | 8′b0xxx_1xxx = Vlan packet. |
| | | 8′b0xxx_x011 = Control packet. |
| | | 8′b0xxx_x010 = Network Ipv6. |
| | | 8′b0xxx_x001 = Network Ipv4. |
| | | 8′b0xxx_x000 = Network unknown. |

Receive Statistics Reg (RStatsR)

| Bits | Name | Description |
|---|---|---|
| 31:31 | Type | 0 - Receive vector. |
| 30:27 | Rsvd | Zeroes. |
| 26:26 | 802.3 | Packet format was 802.3 |
| 25:25 | BCast | Broadcast address detected. |
| 24:24 | MCast | Multicast address detected. |
| 23:23 | SvdDet | Previous carrier detected. |
| 22:22 | LngEvt | Long event detected. |
| 21:21 | PEarly | Receive frame missed. |
| 20:20 | DEarly | Receive mac queue overrun. |
| 19:19 | FcsErr | Crc-error detected. |
| 18:18 | SymOdd | Dribble-nibble detected. |
| 17:17 | SymErr | Code-violation detected. |
| 16:16 | RcvAtn | Copy of RcvSta(RcvAtn). |
| 15:00 | RcvLen | Receive frame size (includes crc). |

Socket Descriptor Buffers (SDscBfs) 2K Pairs × 295 b = 75520 B

| | | |
|---|---|---|
| Bits | Name | Description |

Buffer Word Format - IPV6:

| | | |
|---|---|---|
| 294:292 | Rsvd | Must be zero. |
| 291:290 | DmaCd | DMA size indicator. |
| | | 0-16 B, 1-96 B, 2-128 B, 3-192 B. |
| 289:289 | DetEn | 1. |
| 288:288 | IpVer | 1-IpV6. |
| 287:160 | SrcAdr | IpV6 Source Address. |
| 159:032 | DstAdr | IpV6 Destination Address. |
| 031:016 | SrcPrt | Tcp Source Port. |
| 015:000 | DstPrt | Tcp Destination Port. |

Buffer Word Format - IPV4 Pair:

| | | |
|---|---|---|
| 294:293 | DmaCd | Odd dscr DMA size indicator. |
| | | 0-16 B, 1-96 B, 2-128 B, 3-192 B. |
| 292:292 | DetEn | Odd dscr enable. |
| 291:290 | DmaCd | Even DMA size indicator. |
| | | 0-16 B, 1-96 B, 2-128 B, 3-192 B. |
| 289:289 | DetEn | Even dscr enable. |
| 288:288 | IpVer | 0-IpV4. |
| 287:192 | Rsvd | Reserved. |
| 191:160 | SrcAdr | Odd IpV4 Source Address. |
| 159:128 | DstAdr | Odd IpV4 Destination Address. |
| 127:112 | SrcPrt | Odd Tcp Source Port. |
| 111:096 | DstPrt | Odd Tcp Destination Port. |
| 095:064 | SrcAdr | Even IpV4 Source Address. |
| 063:032 | DstAdr | Even IpV4 Destination Address. |
| 031:016 | SrcPrt | Even Tcp Source Port. |
| 015:000 | DstPrt | Even Tcp Destination Port. |

Detect Command (DetCmdQ) ??? Entries × 32 b

| | | |
|---|---|---|
| Bits | Name | Description |

Descriptor Disable Format:

| | | |
|---|---|---|
| 31:30 | CmdCd | 0-DetDbl. |
| 29:12 | Rsvd | Zeroes. |
| 11:00 | TcbId | TCB identifier. |

IPV6 Descriptor Load Format:

| | | |
|---|---|---|
| WORD 0 | | |
| 031:030 | CmdCd | 1-DscLd. |
| 029:029 | DetEn | 1. |
| 028:028 | IpVer | 1-IpV6. |
| 027:014 | Rsvd | Don't Care. |
| 013:012 | DmaCd | DMA size indicator. |
| | | 0-16 B, 1-96 B, 2-128 B, 3-192 B. |
| 011:000 | TcbId | TCB identifier. |
| WORD 1 | | |
| 031:016 | SrcPrt | Tcp Source Port. |
| 015:000 | DstPrt | Tcp Destination Port. |
| WORDS 5:2 | | |
| 127:000 | DstAdr | Ip Destination Address. |
| WORDS 9:6 | | |
| 127:000 | SrcAdr | Ip Source Address. |

IPV4 Descriptor Load Format:

| | | |
|---|---|---|
| WORD 0 | | |
| 031:030 | CmdCd | 1-DscLd. |
| 029:029 | DetEn | 1. |
| 028:028 | IpVer | 0-IpV4. |
| 027:014 | Rsvd | Don't Care. |
| 013:012 | DmaCd | DMA size indicator. |
| | | 0-16 B, 1-96 B, 2-128 B, 3-192 B. |
| 011:000 | TcbId | TCB identifier. |
| WORD 1 | | |
| 031:016 | SrcPrt | Tcp Source Port. |
| 015:000 | DstPrt | Tcp Destination Port. |
| WORD 2 | | |
| 031:000 | DstAdr | Ip Destination Address. |
| WORD 3 | | |
| 031:000 | SrcAdr | Ip Source Address. |

Descriptor Read Format:

| | | |
|---|---|---|
| 31:30 | CmdCd | 2-DscRd. |
| 29:16 | Rsvd | Zeroes. |
| 15:11 | WrdIx | Descriptor word select. |
| 10:00 | WrdAd | TCB identifier. |

Event Push Format:

| | | |
|---|---|---|
| 31:30 | CmdCd | 3-DscRd. |
| 29:00 | Event | Rcv Event Descriptor. |

RcvSqr Event Queue (RSqEvtQ) ??? Entries × 32 b

| | | |
|---|---|---|
| Bits | Name | Description |

Rcv Event Format:

| | | |
|---|---|---|
| 31:31 | EvtCd | 0: RSqEvt |
| 30:29 | DmaCd | If EvtCd == RSqEvt. DMA size indicator. |
| | | 0-16 B, 1-96 B, 2-128 B, 3-192 B. |
| 28:28 | SkRcv | TCB identifier valid. |
| 27:16 | TcbId | TCB identifier. |
| 15:00 | RbfId | Drm Buffer id. |

Cmd Event Format:

| | | |
|---|---|---|
| 31:31 | EvtCd | 1: CmdEvt |
| 30:29 | RspCd | If EvtCd == CmdEvt. Cmd response code. |
| | | 0-Rsvd, 1-DscRd, 2-EnbEvt, 3-blEvt. |
| 28:28 | SkRcv | TCB identifier valid. |
| 27:16 | TcbId | TCB identifier. |
| 15:00 | DscDat | Requested SktDsc data. |

Transmit Sequencer (XmtSqr/XSq)

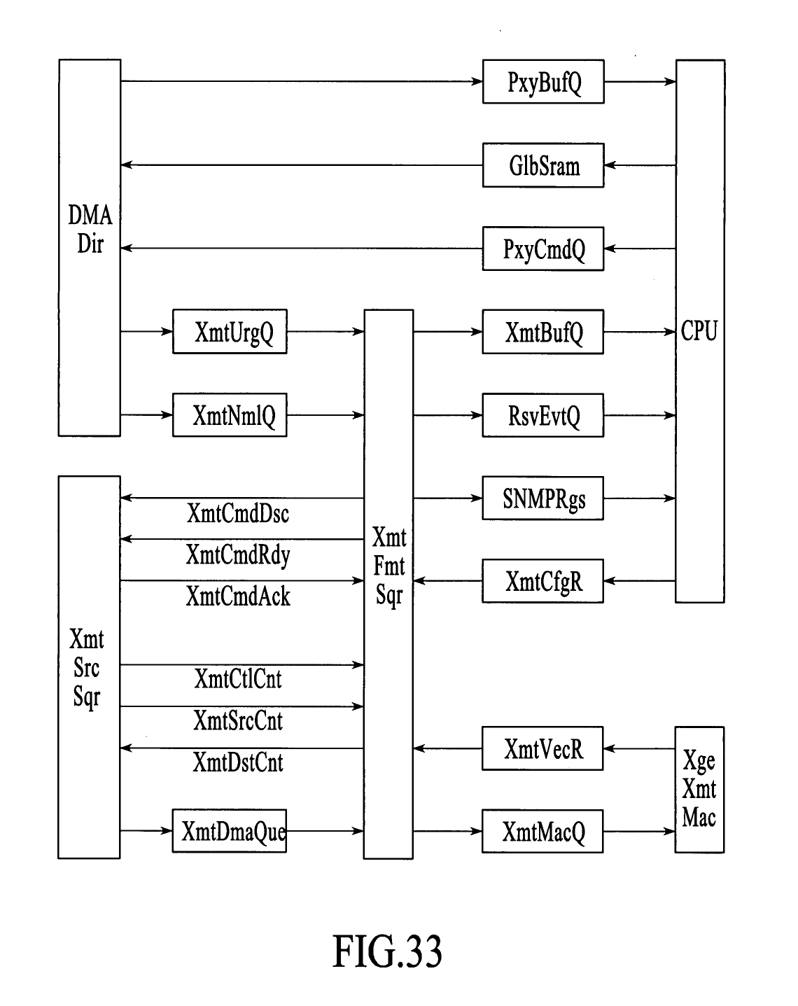

The Transmit Sequencer is depicted in FIG. 33 in situ along with connecting modules. XmtSqr comprises the two functional modules; XmtCmdSqr and XmtFmtSqr. XmtCmdSqr fetches, parses and dispatches commands to the DrmCtl sub-module, XmtSrcSqr. XmtFmtSqr receives commands and data from the XmtDmaQ, parses the command, formats a frame and pushes it on to one of the XmtMacQs. Two modes of operation provide support for either a single ten-gigabit mac or for four one-gigabit macs.

Transmit Packet Buffer (XmtPktBuf) 2 KB, 4 KB, 8 KB or 16 KB

| Bytes | Name | Description |
|---|---|---|
| EOB:000 | XmtPay | Transmit packet payload. |

Transmit Configuration Register (XmtCfgR)

| Bits | Name | Description |
|---|---|---|
| 31:31 | Reset | Force reset asserted to the transmit sequencer. |
| 30:30 | XmtEnb | Allow formatting of transmit packets. |
| 29:29 | PseEnb | Allow generation of 802.3X control packets. |
| 28:16 | PseCnt | Pause value to insert in a control packet. |
| 15:00 | IpId | Ip flow ID initial value. |

Transmit Vector Reg (RStatsR)

| Bits | Name | Description |
|---|---|---|
| 31:28 | Rsvd | A copy of transmit-buffer descriptor-bits 31:28. |
| 27:27 | XmtDn | Transmission of the packet was completed. |
| 26:26 | DAbort | The packet was deferred in excess of 24,287 bit times. |
| 25:25 | Defer | The packet was deferred at least once, and fewer than |
| | | the limit. |
| 24:24 | CAbort | Packet was aborted after CCount exceeded 15. |
| 23:20 | CCount | Number of collisions incurred during transmission |
| | | attempts. |
| 19:19 | CLate | Collision occurred beyond the normal collision window |
| | | (64 B). |
| 18:18 | DLate | XSq failed to provide timely data. |
| 17:17 | CtlPkt | Packet was of the 802.3X control format. LnkTyp == |
| | | 0x8808 |
| 16:16 | BCast | Packet's destination address was broadcast address. |
| 15:15 | MCast | Packet's destination address was multicast address. |
| 14:14 | ECCErr | ECC error detected during dram DMA. |
| 13:00 | XmtLen | Total bytes transmitted on the wire. 0 = 16 KB. |

Transmit Mac Queue (XmtMacQ)

if (Type == Data) {

| Bits | Name | Description |
|---|---|---|
| ----- | ------ | ----------- |
| 35:35 | OddPar | Odd parity. |
| 34:34 | WrdTyp | 0-Data. |
| 33:32 | WrdSz | 0-4 bytes. 1-3 bytes. 2-2 bytes. 3-1 bytes. |
| 31:00 | XmtDat | Data to transmit. |

} else {

| | | |
|---|---|---|
| Bits | Name | Description |
| ----- | ------ | ----------- |
| 35:35 | OddPar | Odd parity. |
| 34:34 | WrdTyp | 1-Status. |
| 33:18 | Rsvd | Zeroes. |
| 17:17 | CtlPkt | Packet was of the 802.3X control format. |
| | | LnkTyp == 0x8808 |
| 16:16 | BCast | Packet's destination address was broadcast address. |
| 15:15 | MCast | Packet's destination address was multicast address. |
| 14:14 | ECCErr | ECC error detected during dram DMA. |
| 13:00 | XmtLen | Total bytes to be transmitted on the wire. 0 = 16 KB. |
| } | | |

Transmit High-Priority/Normal-Priority Queue (XmtUrgQ/XmtNmlQ)

| | | | |
|---|---|---|---|
| Word | Bits | Name | Command Block Description |

Raw Send Descriptor:

| | | | |
|---|---|---|---|
| 00 | 31:30 | CmdCd | 0: RawPkt |
| | 29:16 | XmtLen | Total frame length. 0 == 16 KB. |
| | 15:00 | XmtBuf | Transmit Buffer id. |
| 01 | 31:00 | Rsvd | Don't care. |
| — | — | — | — |
| 03 | 31:00 | Rsvd | Don't care. |

Checksum Insert Descriptor:

| | | | |
|---|---|---|---|
| 00 | 31:30 | CmdCd | 1: ChkIns |
| | 29:16 | XmtLen | Total frame length. 0 == 16 KB. |
| | 15:00 | XmtBuf | Transmit Buffer id. |
| 01 | 31:16 | ChkDat | Checksum insertion data. |
| | 15:08 | Rsvd | Zeroes. |
| | 07:00 | ChkAd | Checksum insertion pointer expressed in 2 B |
| | | | words. |
| 02 | 31:00 | Rsvd | Don't care. |
| — | — | — | — |
| 03 | 31:00 | Rsvd | Don't care. |

Format Descriptor:

| | | | |
|---|---|---|---|
| 00 | 31:30 | CmdCd | 2: Format |
| | 29:16 | XmtLen | Total frame length. 0 == 16 KB. |
| | 15:00 | XmtBuf | Transmit Buffer id. |
| 01 | 31:31 | TimEnb | Tcp timestamp option enable. |
| | 30:30 | TcpPsh | Sets the tcp push flag. |
| | 29:29 | TcpFin | Sets the tcp finish flag. |
| | 28:28 | IpVer | 0: IpV4, 1: IpV6. |
| | 27:27 | LnkVln | Vlan header format. |
| | 26:26 | LnkSnp | 802.3 Snap header format. |
| | 25:25 | PurAck | Pure ack mode. XmtBuf is invalid and should |
| | | | not be recycled. |
| | 24:19 | IHdLen | Ip header length in 4 B dwords. 0 = 256 B. |
| | 18:12 | PHdLen | Protoheader length expressed in 2 B words. |
| | | | 0 = 256 B. |
| | 11:00 | TcbId | Specifies a prototype header. |
| 02 | 31:16 | TcpSum | Tcp-header partial-checksum. |
| | 15:00 | TcpWin | Tcp-header window-size insertion-value. |
| 03 | 31:00 | TcpSeq | Tcp-header sequence insertion-value. |
| 04 | 31:00 | TcpAck | Tcp-header acknowledge insertion-value. |
| 05 | 31:00 | TcpEch | Tcp-header time-echo insertion-value. |
| | | | Optional: included if TimEnb == 1. |
| 06 | 31:00 | TcpTim | Tcp-header time-stamp insertion-value. |
| | | | Optional: included if TimEnb == 1. |
| 07 | 31:00 | Rsvd | Don't care. |

The transmit process steps are:
CPU pops a XmtBuf off of the XmtBufQ.
CPU pops a PxyBuf off of the PxyBufQ.
CPU assembles a transmit descriptor in the PxyBuf.
CPU pushes a proxy command onto the PxyCmdQ.
PxySrcSqr pops the command off of the PxyCmdQ.
PxySrcSqr fetches XmtCmd from PxyBuf.
PxySrcSqr pushes XmtCmd onto the specified XmtCmdQ.
PxySrcSqr pushes PxyBuf onto the PxyBufQ.
XmtCmdSqr pops the XmtCmd off the XmtCmdQ.
XmtCmdSqr passes XmtCmd to the XmtSrcSqr.
XmtSrcSqr pushes XmtCmd onto XmtDmaQ.
XmtSrcSqr, if indicated, fetches prototype header from Drm and pushes onto XmtDmaQ.
XmtSrcSqr, if indicated, fetches transmit data from Drm and pushes onto XmtDmaQ.
XmtSrcSqr pushes ending status onto XmtDmaQ.
XmtFmtSqr pops XmtCmd off the XmtDmaQ and parses.
XmtFmtSqr, if indicated, pops header off XmtDmaQ, formats it then pushes it onto the XmtMacQ.
XmtFmtSqr, if indicated, pops data off XmtDmaQ and pushes onto the XmtMacQ.
XmtFmtSqr pushes ending status onto XmtMacQ.
XmtFmtSqr, if indicated, pushes XmtBuf onto XmtBufQ.
   CPU

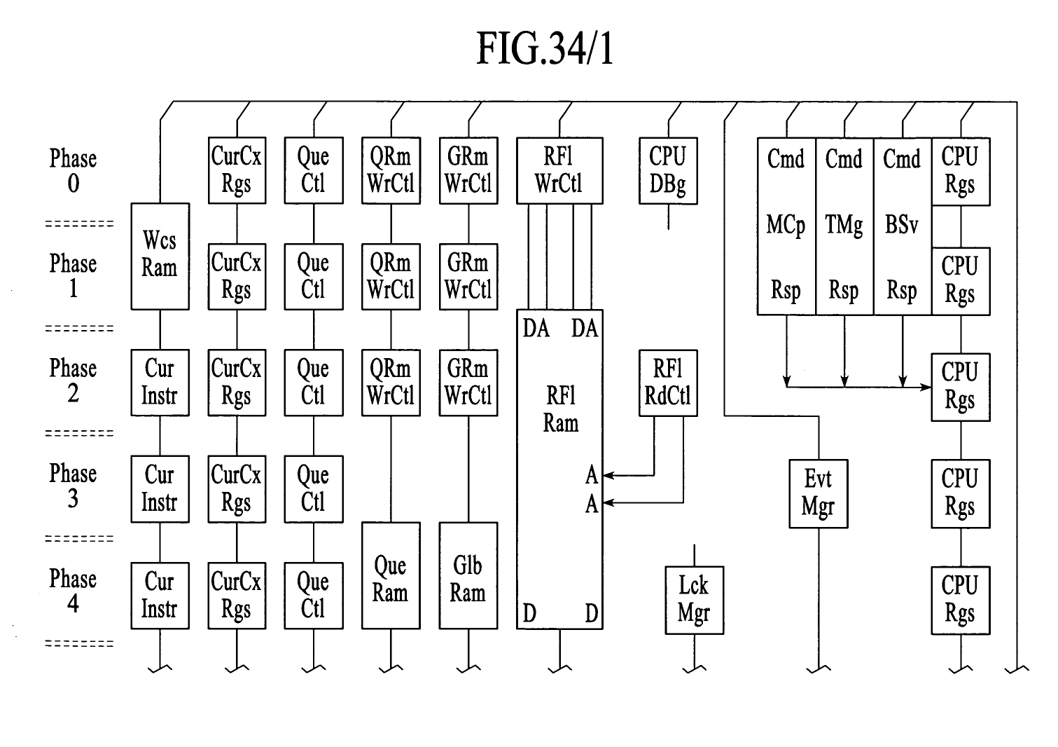

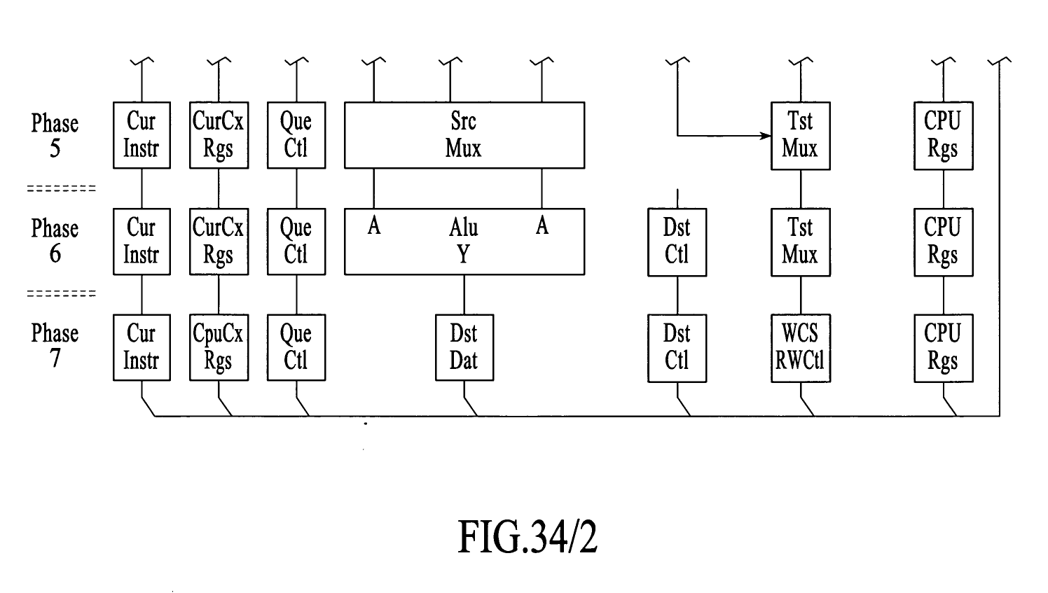

FIG. 34 is a block diagram of a CPU. The CPU utilizes a vertically-encoded, super pipelined, multi-threaded microarchitecture. The pipelines stages are synonymous with execution phases and are assigned IDs Phs0 through Phs7. The threads are called virtual CPUs and are assigned IDs CpuId0 through CpuId7. All CPUs execute simultaneously but each occupies a unique phase during a given clock period. The result is that a virtual CPU (thread) never has multiple instruction completions outstanding. This arrangement allows 100% utilization of the execution phases since it eliminates empty pipeline slots and pipeline flushing.

The CPU includes a Writeable Control Store (WCS) capable of storing up to 8K instructions. The instructions are loaded by the host through a mechanism described in the section Host Cpu Control Port. Every virtural CPU (thread) executes instructions fetched from the WCS. The WCS includes parity protection which will cause the CPU to halt to avoid data corruption.

A CPU Control Port allows the host to control the CPU. The host can halt the CPUs and force execution at location zero. Also, the host can write the WCS, check for parity errors and monitor the global cpu halt bit. A 2048 word Register File provides simultaneous 2-port-read and 1-port-write access. The File is partitioned into 41 areas comprising storage reserved for each of the 32 CPU contexts, each of the 8 CPUs and a global space. The Register File is parity protected and thus requires initialization prior to usage. Reset disables parity detection enabling the CPU to initialize the File before enabling detection. Parity errors cause the CPU to halt. Hardware support for CPU contexts facilitates usage of context specific resources with no microcode overhead. Register File and Global Ram addresses are automatically formed based on the current context. Changing CPU contexts requires no saving nor restoration of registers and pointers. Thirty-two contexts are implemented which allows CPU processing to continue while contexts sleep awaiting DMA completion.

CPU snooping is implemented to aid with microcode debug. CPU PC and data are exported via a multilane serial interface using an XGXS module. Refer to section XXXX and the SACI specification for additional information. See section Snoop Port for additional information.

Local memory called Global Ram (GlbRam or GRm) is provided for immediate access by the CPUs. The memory is dual ported however, one port is inaccessible to the CPU and is reserved for use by the DMA Director (DMD). Global Ram allows each CPU cycle to perform a read or a write but not both. Due to the delayed nature of writes, it is possible to have single instructions which perform both a read and a write, but instructions which attempt to read Global Ram immediately following an instruction which performs a write will result in a CPU trap. This memory is parity protected and requires initialization. Reset disables parity detection. Parity errors cause the CPU to halt.

Queues are integrated into the CPU utilizing a dedicated memory called Queue Ram (QueRAM or QRm). Similar to the Global Ram, the memory is dual-ported but the CPU accesses only a single port. DMD accesses the second port to write ingress and read egress queues containing data, commands and status. Care must be taken not to write any queue during an instruction immediately following an instruction reading any queue or a CPU trap will be performed. This memory is parity protected and must be initialized. See section Queues for additional information.

A Lock Manager provides several locks for which requests are queued and honored in the order in which they were received. Locks can be requested or cleared through the use of flags or test conditions. Some flags are dedicated to locking specific functions. In order to utilize the Math Coprocessor a CPU must be granted a lock. The lock is monitored by the Coprocessor and must be set before commands will be accepted. This allows single instructions to request the lock, write the coprocessor registers and perform a conditional jump. Another lock is dedicated to ownership of the Slow Bus Controller. The remaining locks are available for user definition. See section Lock Manager for additional information.

An Event Manager—has been included which monitors events requiring attention and generates vectors to expedite CPU servicing. The Event Manager is tightly integrated with the CPU and can monitor context state to mask context specific events. See section Event Manager for additional information.

Instruction Format

The CPU is vertically-microcoded. That is to say that the instruction is divided into ten fields with the control fields containing encoded values which select operations to be performed. Instructions are fetched from a writable-control-store and comprise the following fields.

Instruction Fields

| Bits | Name | Description |
|---|---|---|
| 95:93 | SqrCd | Program Sequencer Code. |
| 92:92 | CCEnb | Condition Code Enable. |
| 91:88 | AluOp | ALU Operation Code. |
| 87:78 | SrcA | ALU Source Operand A Select. |
| 77:68 | SrcB | ALU Source Operand B Select. |
| 67:58 | Dst | ALU Destination Operand Select. |
| 57:41 | AdLit | Global RAM Address Literal. |
| 40:32 | TstCd | For Lpt, Rtt, Rtx and Jpt - Program Sequencer Test |
| | | Code. |
| | FlgCd | For Cnt, Jmp, Jsr, and Jsx - Flag Operation Code. |
| 31:16 | LitHi | For Lpt, Cnt, Rtt and Rtx - Literal Bits 31:16. |
| | JmpAd | For Jmp, Jpt, Jsr and Jsx - Program Jump Address. |
| 15:00 | LitLo | Literal Bits 15:00. |

Program Sequence Control (SqrCd).

The SqrCd field in combination with DbgCtl determines the program sequence as defined in the following table.

Sequencer Codes

| Name | SqrCd[2:0] | Description |
|---|---|---|
| Lpt | 0 | Loop if condition is true. The PC is not incremented |
| | | if the condition is true. |
| Cnt | 1 | Continue. The PC is incremented. |
| Rts | 2 | Return subroutine if condition is true. An entry is |
| | | popped off the CPU stack and loaded into the PC. |
| Rtx | 3 | Return context subroutine if condition is true. |
| | | An entry is popped off the context stack and |
| | | loaded into the PC. |
| Jmp | 4 | Jump. LitLo is loaded into the PC. |
| Jpt | 5 | Jump if condition is true. LitLo is loaded into |
| | | the PC. |
| Jsr | 6 | Jump to subroutine. PC is incemented then pushed |
| | | onto the CPU stack then LitLo is loaded |
| | | into the PC. |
| Jsx | 7 | Jump to context subroutine. PC is incemented then |
| | | pushed onto the context stack then LitLo is |
| | | loaded into the PC. |

Condition Code Enable (CCEnb).

The CCEnb field allows the SvdCC register to be updated with the result of an ALU operation.

Condition Code Enable

| Name | CCEnb | Description |
|---|---|---|
| CCUpd | 1′b0 | Condition code update is disabled. |
| CCHld | 1′b1 | Condition code update is enabled. |

Alu Operations (AluOp).

The ALU performs 32-bit operations. All operations utilize two source operands except for the priority encode operation which uses only one and the add carry operation which uses the “C” bit of the SvdCC register.

ALU Op Codes

| Name | AluOp [3:0] | Description | |
|---|---|---|---|
| And | 4′h0 | SrcA & SrcB; | V = 0; |
| Clr | 4′h1 | SrcA &˜SrcB; | V = 0; |
| Or | 4′h2 | SrcA\|SrcB; | V = 0; |
| XOr | 4′h3 | SrcA \hat{ } SrcB; | V = 0; |
| BSet | 4′h4 | SrcA\|(1 << SrcB[4:0]); | V = (SrcB >= 32); |
| BClr | 4′h5 | SrcA &˜(1 << SrcB[4:0]); | V = (SrcB >= 32); |
| ShfR | 4′h6 | SrcA >> SrcB[4:0]; | V = (SrcB >= 32); |
| ShfL | 4′h7 | SrcA << SrcB[4:0]; | V = (SrcB >= 32); |
| ExtR | 4′h8 | SrcB &(SrcA >> Lit); | V = 0; Extract. |
| MrgL | 4′h9 | SrcB\|(SrcA << Lit); | V = 0; Merge. |
| Add | 4′ha | SrcA + SrcB; | V = (SrcA[31]& SrcB[31]&!Y[31])\| |
| | | | (!SrcA[31]&!SrcB[31]& Y[31]); |
| AddC | 4′hb | SrcA + SrcB + C; | V = (SrcA[31]& SrcB[31]&!Y[31])\| |
| | | | (!SrcA[31]&!SrcB[31]& Y[31]); |
| Sub | 4′hc | SrcA − SrcB; | V = (SrcA[31]&!SrcB[31]&!Y[31])\| |
| | | | (!SrcA[31]& SrcB[31]& Y[31]); |
| Enc | 4′hd | SrcA PriEnc; | V = (SrcA == 0); |
| Min | 4′he | SrcA >= SrcB?SrcB:SrcA; | V = 0; |
| Max | 4′hf | SrcA < SrcB?SrcB:SrcA; | V = 0; |

Alu Operands (SrcA, SrcB, Dst).

All ALU operations require operands. Source operand codes provide the ALU with data on which to operate and destination operand codes direct the placement of the ALU product. Operand codes, names and descriptions are listed in the following tables.

10′b000000XXXX (0:15)—CPU Unique Registers.

Each CPU uses its own unique instance of the following registers.

| Name | Opd[9:0] | Description | |
|---|---|---|---|
| SvdAlu | 0 | {SvdAlu[31:0]}, R/W. Previous ALU. | |
| | | ALU results (Y) are saved if the CpExEn bit is set. Use of this code for a source operand selects the | |
| | | results of the previous operation. Use of this code for a destination operand causes a write regardless | |
| | | of the state of CpExEn. | |
| CpAcc | 1 | {CpAcc[31:00]}, R/W. Accumulator. | |
| | | Holds results of operations from multicycle command modules. May also be written using this | |
| | | operand. This register is written upon completion of operations by the Math Coprocessor, Queue | |
| | | Manager and the TCB Manager. | |
| CpPc | 2 | {20′b0, CpPc[12:00]}, R/W. Program Counter (PC). | |
| | | Normally modified by sequencer operations, this register may be modified by selecting this operand | |
| | | code. See the previous section Program Sequencer Control. | |
| CpStk | 3 | {19′b0, CpStk[12:00]}, R/W. Stack. | |
| | | A 4-entry stack implemented as a shift register. Used for storage of data or Program Counter (PC). | |
| | | Normally modified by sequencer operations, this register may be modified by selecting this operand | |
| | | code. See the previous section Program Sequencer Control. | |
| SvdCC | 4 | {28′b0, C, Z, N, V}, R/W. Condition Codes. | |
| | | Stores the following condition code bits resulting from an ALU op: | |
| | | Bit 0 - Carry | (C). |
| | | Bit 1 - Zero | (Z). |
| | | Bit 2 - Negative | (N). |
| | | Bit 3 - Overflow | (V). |

| | | |
|---|---|---|
| | | These bits can be directly written by using SvdCC as a destination operand. |
| CpId | 5 | {29′b0, CpId[02:00]}, RO. CPU ID. A unique ID for each virtual CPU. |
| CpQId | 6 | {25′b0, CpQId[06:00]}, R/W. CPU Queue ID. A unique Queue ID for each virtual CPU. |
| | | This register is used for accessing queues and queue status indirectly. See the sections Global Queue |
| | | Status, GRmQ Operands and Queue Manager. |
| CpCxId | 7 | {27′b0, CpCxId[04:00]}, R/W. Context ID. |
| | | Used for |
| CpFlAd | 8 | {21′b0, CpFlAd[10:00]}, R/W. File Address. |
| | | Used for accessing the register file indirectly. See the section Register File Operands. |
| CpHbIx | 9 | {24′b0, CpHbIx[07:00]}, R/W. Header Buffer Index. |
| | | Used for accessing fields within Header Buffers. Use of operands which utilize CpHbIx can force a |
| | | post-increment of 1, 2, 3 or 4. See the section Global Ram Operands. |
| CpGRAd | 10 | {15′b0, CpGRAd[16:00]}, R/W. Global Ram Address. |
| | | Used for indirectly addressing Global Ram. Use of operands which utilize CpGRAd can force a post- |
| | | increment of 1, 2, 3 or 4. See the section Global Ram Operands. |
| CPuMsk | 11 | {20′b0, EvtBit[11:00]}, R/W. Cpu Event Mask. Used by the Event Manager. |
| Rsvd | 12:15 | Reserved. |

10′b0000010XXX (16:23)—Context Unique Registers.

Each of the thirty two CPU contexts has a unique instance of the following registers. Each CPU has a CpCxId register which selects a set of these registers to be read or modified when using the operand codes defined below. Multiple CPUs may select the same context register set but only a single CPU should modify a register to avoid conflicts.

| Name | Opd[9:0] | Description |
|---|---|---|
| CxStk | 16 | {19′b0, CxStk[12:00]}, R/W. Stack. |
| | | A 4-entry stack implemented as a shift register. Used for storage of data or Program Counter (PC). |
| | | Normally modified by sequencer operations, this register may be modified by selecting this operand |
| | | code. See the previous section Program Sequencer Control. |
| CxFlAd | 17 | {21′b0, CxFlAd[10:00]}, R/W. File Address. |
| | | For indirect addressing of the register file. See the section Register File Operands. |
| CxGRAd | 18 | {15′b0, CxGRAd[16:00]}, R/W. Global Ram Address. |
| | | For indirectly addressing Global Ram. Use of operands which utilize CxGRAd can force a post- |
| | | increment of 1, 2, 3 or 4. See the section Global Ram Operands. |
| CxTcId | 19 | {20′b0, CxTcId[11:00]}, R/W. TCB ID. |
| | | For accessing the TCB Bit Map and in forming composite registers. See the sections Composite |
| | | Registers and Global Ram Operands. |
| CxCBId | 20 | {25′b0, CxCBId[06:00]}, R/W. Cache Buffer ID. |
| | | For addressing a Cache Buffer and for forming composite registers. See the sections Aligned |
| | | Registers. Composite Registers and Global Ram Operands. |
| CxHBId | 21 | {31′b0, CxHBId[00:00]}, R/W. Header Buffer ID. |
| | | For addressing a Header Buffer and for forming composite registers. See the sections Aligned |
| | | Registers. Composite Registers and Global Ram Operands. |
| CxDXId | 22 | {29′b0, CxDXId[02:00]}, R/W. DMA Context ID. |
| | | For addressing a DMA Descriptor and for forming composite registers. See the sections Aligned |
| | | Registers, Composite Registers and Global Ram Operands. |
| CxCCtl | 23 | {Other flags here, TRQRdSq[07:00], TRQWrSq[07:00]}, R/W. Connection |
| | | Control. |
| | | Holds a copy of CpuVars. See section - TCB Cache Buffe). Used to maintain command control flags |
| | | and to access TRQ. See the sections Global Ram Operands and Composite Registers. |

10′b00000110XX (24:28)—Aligned Registers.

These operands provide an alternate method of accessing a subset of those registers that have been defined previously which contain a field less than 32-bits in length. The operands allow reading and writing these previously defined registers using the alignment which they would have during use in composite registers.

| Name | Opd[9:0] | Description |
|---|---|---|
| aCxCbf | 24 | {13′b0, CxCBId[06:00], |
| | | 12′b0}, R/W. Aligned CxCBId. |
| aCxHbf | 25 | {15′b0, CxHBId[00:00], |
| | | 16′b0}, R/W. Aligned CxHBId. |
| aCxDxs | 26 | {8′b0, CxDXId[02:00], |
| | | 21′b0}, R/W. Aligned CxDXId. |
| aCpCtx | 27 | {4′b0, CpCxId[04:00], |
| | | 24′b0}, RO. Aligned CpCxId. |

10′b00000111XX (28:31)—Composite Registers.

These operands provide an alternate method of accessing a subset of those registers that have been defined previously which contain a field less than 32-bits in length. The operands allow reading and writing various composites of these previously defined registers. This has the effect of reading and merging or extracting and writing several registers with a single instruction.

| Name | Opd[9:0] | Description |
|---|---|---|
| CpsRgA | 28 | (aCpCtx\|aCxDxs), RO. |
| CpsRgB | 29 | (aCpCtx\|aCxDxs\|aCxHbf), RO. |
| CpsRgC | 30 | (aCpCtx\|aCxDxs\|aCxCbf\|CxTcId), RO. |
| CpsRgD | 31 | (aCpCtx\|aCxDxs\|NEQPtr), RO. |

10′b00001000XX, 10′b000010010X (32:37)—Instruction Literals.

These source operands facilitate various modes of access of the instruction literal fields.

| Name | Opd[9:0] | Description |
|---|---|---|
| LitSR0 | 32 | {16′h0000, LitLo}, RO. |
| LitSR1 | 33 | {16′hffff, LitLo}, RO. |
| LitSL0 | 34 | {LitLo, 16′h0000}, RO. |
| LitSL1 | 35 | {LitLo, 16′hffff}, RO. |
| LitLrg | 36 | {LitHi, LitLo}, RO. |
| AdrLit | 37 | {15′h0000, AdLit}, RO. |

10′b000010011X (38:39)—Slow Bus Registers.

These operands provide access to the Slow Bus Controller. See Slow Bus Subsystem for a more detailed description.

| | | |
|---|---|---|
| Name | Opd[9:0] | Description |

| | | |
|---|---|---|
| SlwDat | 38 | {SlwDat[31:00]}, WO. Slow Bus Data. |
| SlwAdr | 39 | {SglSel[3:0], RegSel[27:00]}, WO. |
| | | Slow Bus Address. |

10′b0000101XXX (40:47)—Context and Event Control Registers.

These operands facilitate control of CPU events and contexts. See the section Event Manager for a more detailed description.

| Name | Opd[9:0] | Description |
|---|---|---|
| CtxIdl | 40 | {CtxIdl[31:00]}, R/W. Idling Context Flags. |
| CtxSlp | 41 | {CtxSlp[31:00]}, R/W. Sleeping Context Flags. |
| CtxBsy | 42 | {CtxBsy[31:00]}, R/W. Busy Context Flags. |
| CtxSvr | 43 | {27′b0, CtxId[04:00]}, RO. Free Context Server. |
| EvtDbl | 43 | {20′b0, EvtBit[11:00]}, WO. Global Event Disable |
| | | Bits. |
| EvtEnb | 44 | {20′b0, EvtBit[11:00]}, R/W. Global Event Enable |
| | | Bits. |
| EvtVec | 45 | {3′b0, Ctx[4:0], 20′b0, Vec[3:0]}, RO. Event |
| | | Vector. |
| DmdErr | 46 | {DmdErr[31:00]}, R/W. Dmd DMA Context Err |
| | | Flags. |
| Rsvd | 47 | Reserved. |

10′b000011XXXX (48:63)—TCB Manager Registers.

These operands facilitate control of TCB and Cache Buffer state. See the section TCB Manager for a more detailed description.

| Name | Opd[9:0] | Description |
|---|---|---|
| TmgRsp | 48 | RO. TCB Manager Response. |
| TmgReset | 48 | WO. TCB Manager Reset. |
| TmgTcbQry | 49 | WO. Query - TCB. |
| CchBufQry | 50 | WO. Query - Cache Buffer. |
| CchLreQry | 51 | WO. Query - Least Recently Emptied. |
| CchLruQry | 52 | WO. Query - Least Recently Used. |
| CchBufGet | 53 | WO. Buffer Lock Request. |
| CchTcbReg | 54 | WO. TCB Register. |
| CchBufRls | 55 | WO. Buffer Release. |
| CchTcbEvc | 56 | WO. TCB Evict. |
| CchDtyMod | 57 | WO. Buffer Dirty Modify. |
| CchBufEnb | 58 | WO. Buffer Enable. |
| TlkCpxQry | 59 | WO. Query - TCB Lock Registers. |
| TlkRcvPop | 60 | WO. Receive Request Pop. |
| TlkLckRls | 61 | WO. TCB Lock Release. |
| TlkNmlReq | 62 | WO. Normal Lock Request. |
| TlkRcvReq | 63 | WO. Priority Lock Request. |

10′b0001000XXX (64:71) CPU Debug Registers.

These operands facilitate control of CPUs. See the section Debug Control for a more detailed description.

| Name | Opd[9:0] | Description |
|---|---|---|
| CpuHlt | 64 | WO. CPU Halt bits. |
| CpuRun | 65 | WO. CPU Run bits. |
| CpuStp | 66 | WO. CPU Step bits. |
| CpuDbg | 67 | WO. CPU Debug bits. |
| TgrSet | 68 | Trigger Flag set bits. Bit per cpu plus one global. |
| TgrClr | 69 | Trigger Flag clr bits. Bit per cpu plus one global. |
| DbgOpd | 70 | WO. Debug Operands. |
| DbgDat | 71 | R/W. Debug Data. |

10′b00010010XX (72:75)—Math Coprocessor Registers.

These operands facilitate control of the Math Coprocessor. See the section Math Coprocessor for a more detailed description.

| Name | Opd[9:0] | Description |
|---|---|---|
| Dvnd | 72 | Dividend - Writing to this register sets up the |
| | | dividend for a divide operation. Reading from it |
| | | when the divide is complete returns the remainder. |
| | | It is 24 bits wide |
| Mltcnd | 72 | Multiplicand - Writing sets up the 24-bit |
| | | multiplicand for a multiply operation. |
| Dvsr | 73 | Divisor - Writing to this register loads the 24 bit |
| | | divisor and initiates a divide operation. |
| | | Reading from it returns 0. |
| Mltplr | 74 | Multiplier - Writing to this register loads the 24 bit |
| | | multiplier and initiates a multiply operation. |
| | | Reading from it returns 0. |
| Qtnt | 75 | Quotient - This register returns the quotient when |
| | | a divide is complete. |
| Product | 75 | Product - This register returns the product when |
| | | a multiply is complete. |

10′b00010011XX (76:79)—Memory Control Registers.

These operands allow the CPU to control memory parity detection. Each bit of the register represents a memory subsystem as follows: 0-WCS, 1-GlbRam, 2-QueRam, 3-RFile, 4-1TSram.

| Name | Opd[9:0] | Description |
|---|---|---|
| ParEnb | 76 | Parity Enable, WO - Writing ones causes parity |
| | | detection to be disabled. Writing zeros |
| | | causes parity detection to be disabled. |
| ParInv | 77 | Parity Invert, WO - Writing ones causes read parity |
| | | to be inverted from its normal polarity. This is |
| | | useful for forcing errors. |
| ParClr | 78 | Parity Clear, WO - Writing ones causes parity |
| | | errors to be cleared. |
| ParErr | 78 | Parity Error, RO - Each bit set represents a parity |
| | | error. |
| TrpEnb | 79 | Trap Enable, WO - Writing ones enables parity error |
| | | traps. |

10′b000101XXXX (80:95)—Sequence Servers.

There are eight incrementers which will provide a sequence to the CPU when read. They allow multiple CPUs to take sequences without the need for locking, modifying and unlocking. The servers are paired such that one functions as a request sequence and the other functions as a service sequence. Refer to test conditions for more info. Alternatively, the sequence servers can be treated independently. A server can be read at its primary or secondary address. Reading the server with its secondary address causes the server to post increment. Writing a server causes the server to initialize to zero.

| Name | Opd[9:1] | Description |
|---|---|---|
| Seq8 | 10′b0001010XXX | {24′b0, Seq8[07:00]}, R/W, Inc = Opd[0]. |
| Seq16 | 10′b0001011XXX | {16′b0, Seq8[15:00]}, R/W, Inc = Opd[0]. |

10′b00011XXXXX (96:127)—Reserved.
10′b0010XXXXXX, 10′b00110XXXXX (128:223)—Constants.

Constants provide an alternative to using the instruction literal field.

| Name | Opd[9:0] | Description |
|---|---|---|
| Int5 | 10′b00100XXXXX | {27′h0000000, OpdX[4:0]}, RO. Integer. |
| BitX | 10′b00101XXXXX | {32′h00000001 << OpdX[4:0]}, RO. Bit. |
| MskX | 10′b00110XXXXX | {32′hffffffff >> OpdX[4:0]}, RO. Mask. |

10′b001110XXXX, 10′b00111100XX, 10′b001111010X (224:244)—Reserved.
10′b001111011X (245:246)—NIC Event Queue Servers.

Bunch of verbiage here. NEQId=CpQId[2:0].

| Name | Opd[9:0] | Description |
|---|---|---|
| EvtSq | 10′b0011110110 | {RlsSeq[NEQId][15:0], |
| | | WrtSeq[NEQId][15:0]}, R/W. |
| EvtAd | 10′b0011110111 | {NEQId, WrtSeq[NEQId][NEQSz:00]}, |
| | | RO, autoincrements if WrtSeq != RlsSeq; |
| EvtAd | 10′b0011110111 | {RlsSeq[15:00], 16′b0} WO. |

10′b0011111XXX, 10′b010XXXXXXX (248:383)—Queue Registers.

These operands facilitate control of the queues. See the section Queues for a more detailed description

| Name | Opd[9:0] | Description |
|---|---|---|
| Rsvd | 10′b001111100X | Reserved. |
| QSBfS | 10′b0011111010 | R, QId = {2′b0, CpCxId}. SysBufQ status. |
| QSBfD | 10′b0011111011 | RW, QId = {2′b0, CpCxId}. SysBufQ |
| | | data. |
| QRspS | 10′b0011111100 | R, QId = {2′b1, CpCxId}. DmdRspQ |
| | | status. |
| QRspD | 10′b0011111101 | RW, QId = {2′b1, CpCxId}. DmdRspQ |
| | | data. |
| QCpuS | 10′b0011111110 | R, QId = CpQId. Queue status-indirect. |
| QCpuD | 10′b0011111111 | RW, QId = CpQId. Queue data-indirect. |
| QImmS | 10′b01010XXXXX | R, QId = {1′b1, Opd[4:0]} Queue |
| | | status-direct. |
| QImmD | 10′b01011XXXXX | RW, QId = {1′b1, Opd[4:0]} Queue |
| | | data-direct. |

10′b011XXXXXX (384:511)—Global Ram Operands.

These operands provide multiple methods to address Global Ram. The last three operands support automatic post-incrementing. The increment is controlled by the operand select bit Opd[3] and takes place after the address has been compiled. All operands utilize bits [2:0] to control byte swapping and size as shown below.
Opd[2:2] Transpose: 0-NoSwap, 1-Swap
Opd[1:0] DataSize: 0-4B, 1-3B, 2-2B, 3-1B

Hardware detects conditions where reading or writing of data crosses a word boundary and cause the program counter to load with the trap vector. The following shows how address and Opd[2:0] affect the Global Ram data presented to the ALU.

| Transpose | ByteOffset | GRmData | 4 B | 3 B | 2 B | 1 B |
|---|---|---|---|---|---|---|
| 0 | 0 | abcd | abcd | 0bcd | 00cd | 000d |
| 0 | 1 | abcX | trap | 0abc | 00bc | 000c |
| 0 | 2 | abXX | trap | trap | 00ab | 000b |
| 0 | 3 | aXXX | trap | trap | trap | 000a |
| 1 | 0 | abcd | dcba | 0dcb | 00dc | 000d |
| 1 | 1 | abcX | trap | 0cba | 00cb | 000c |
| 1 | 2 | abXX | trap | trap | 00ba | 000b |
| 1 | 3 | aXXX | trap | trap | trap | 000a |

The following shows how address and Opd[2:0] affect the ALU data presented to the Global Ram.

| Transpose | DataSize | AluOut | OF = 0 | 0F = 1 | OF = 2 | OF = 3 |
|---|---|---|---|---|---|---|
| 0 | 4 B | abcd | abcd | trap | trap | trap |
| 0 | 3 B | Xbcd | -bcd | bcd- | trap | trap |
| 0 | 2 B | XXcd | --cd | -cd- | cd-- | trap |
| 0 | 1 B | XXXd | ---d | --d- | -d-- | d--- |
| 1 | 4 B | abcd | dcba | trap | trap | trap |
| 1 | 3 B | Xbcd | -dcb | dcb- | trap | trap |
| 1 | 2 B | XXcd | --dc | -dc- | dc-- | trap |
| 1 | 1 B | XXXd | ---d | --d- | -d-- | d--- |

| Name | Opd[9:0] | Description |
|---|---|---|
| Rsvd | 10′b01100XXXXX | Reserved. |
| GTRQWr | 10′b0110100XXX | GCchBf + CxCCtl[TRQWrSq]; WO, Write to TCB receive queue. |
| GTRQRd | 10′b0110100XXX | GCchBf + CxCCtl[TRQRdSq]; RO, Read from TCB receive queue. |
| GTBMap | 10′b0110101XXX | TCB Bit Map. |
| | | GRm[TMapBs + (CxTcId>>5)]; |
| GLitAd | 10′b0110110XXX | Global Ram. |
| | | GRm[AdLit]; |
| GCchBf | 10′b0110111XXX | Cache Buffer. |
| | | GRm[CchBBs + (CxCBId * CchBSz) + AdLit]; |
| GDmaBf | 10′b0111000XXX | DMA descriptor. |
| | | GRm[DmaBBs + {CpCxId, CxDXId, 4′b0} + AdLit]; |
| GHdrBf | 10′b0111001XXX | Header Buffer. |
| | | GRm[HdrBBs + ({CpCxId, CxHBId} * HdrBSz) + AdLit]; |
| GHdrIx | 10′b011101XXXX | Header Buffer indexed. If Opd[3] CpHbIx ++; |
| | | GRm[GHdrBf + CpHbIx]; |
| GCtxAd | 10′b011110XXXX | Global Ram ctx address. If Opd[3] CxGRAd ++; |
| | | GRm[CxGRAd + AdLit]; |
| GCpuAd | 10′b011111XXXX | Global Ram cpu address. If Opd[3] CpGRAd ++; |
| | | GRm[CpGRAd + AdLit]; |

10′ b1XXXXXXXXXX (512:1023)—Register File Operands.

These operands provide multiple methods to address the Register File. The Register File has three partitions comprising CPU space, Context space and Shared space.

| Name | Opd[9:0] | Description |
|---|---|---|
| FCxWin | 10′b1000XXXXXX | Context File Window. |
| | | RFl[CxFlBs + (CpCxId * CxFlSz) + |
| | | OpdX[5:0]]; |
| FCpWin | 10′b1001XXXXXX | CPU File Window. |
| | | RFl[CpFlBs + (CpId * CpFlSz) + |
| | | OpdX[5:0]]; |
| FCxFAd | 10′b1010XXXXXX | Context File Address. |
| | | RFl[CxFlAd + OpdX[5:0]]; |
| FCpFAd | 10′b1011XXXXXX | CPU File Address. |
| | | RFl[CpFlAd + OpdX[5:0]]; |
| FShWin | 10′b11XXXXXXXX | Shared File Window. |
| | | RFl[ShFlBs + OpdX[5:0]]; |

Global Ram Address Literal (AdLit).

This field supplies a literal which is used in forming an address for accessing Global Ram.

| Name | Description |
|---|---|
| AdLit | AdLit[16:0]; |

Test Operations (TstCd).

Instruction bits [40:32] serve as the FlgCd and TstCd fields. They serve as the TstCd for Lpt, Rtt, Rtx and Jpt instructions. TstCd[8] forces an inversion of the selected test result. Test codes are defined in the following table.

Test Codes

| Name | TstCd[7:0] | Description |
|---|---|---|
| True | 0 | Always true. |
| CurC32 | 1 | Current alu carry. |
| CurV32 | 2 | Current alu overflow. |
| CurN32 | 3 | Current alu negative. |
| CurZ32 | 4 | Current 32 b zero. |
| CurZ64 | 5 | Current 64 b zero. (CurZ32 & SvdZ32); |
| CurULE | 6 | Current unsigned less than or equal. (CurZ32\|˜CurC32); |
| CurSLT | 7 | Current signed less than. (CurN32 \hat{ } CurV32); |
| CurSLE | 8 | Current signed less than or equal. (CurN32 \hat{ } CurV32)\|CurZ32; |
| SvdC32 | 9 | Saved alu carry. |
| SvdV32 | 10 | Saved alu overflow. |
| SvdN32 | 11 | Saved alu negative. |
| SvdZ32 | 12 | Saved 32 b zero. |
| SvdULE | 13 | Saved unsigned less than or equal. (SvdZ32\|˜SvdC32); |
| SvdSLT | 14 | Saved signed less than. (SvdN32 \hat{ } SvdV32); |
| SvdSLE | 15 | Saved signed less than or equal. (SvdN32 \hat{ } SvdV32)\|SvdZ32; |
| SeqTst | 8′b000100XX | Sequence Server test. TstCd[1:0] selects one of 4 pairs. |
| MthErr | 20 | Math Coprocessor error. Divide by 0 or multiply overflow. |
| MthBsy | 21 | Math Coprocessor busy. |
| NEQRdy | 22 | NEQRlsSq[NEQId] != NEQWrtSeq[NEQId]. |
| Rsvd | 22:159 | Reserved. |
| AluBit | 8′b101XXXXX | Test alu data bit. AluDt[TstOp[4:0]]; |
| LkITst | 8′b1100XXXX | Test immediate lock. LockI[TstOp[4:0]]; |
| LkIReq | 8′b1101XXXX | Request and test immediate lock. LockI[TstOp[4:0]]; |
| LkQTst | 8′b1110XXXX | Test queued lock. LockQ[TstOp[4:0]]; |
| LkQReq | 8′b1111XXXX | Request and test queued lock. LockQ[TstOp[4:0]]; |

Flag Operations (FlgCd).

Instruction bits[40:32] serve as the FlgCd and TstCd fields. They serve as the FlgCd for Cnt, Jmp, Jsr and Jsx instructions. Flag codes are defined in the following table.

Flag Codes

| Name | FlgCd[8:0] | Description |
|---|---|---|
| Rsvd | 0:127 | Reserved. |
| LdPc | 128 | Reserved. |
| Rsvd | 129:191 | Reserved. |
| LkIClr | 9′b01100XXXX | Clear immediate lock. See section Lock |
| | | Manager. |
| LkIReq | 9′b01101XXXX | Request immediate lock. See section Lock |
| | | Manager. |
| LkQClr | 9′b01110XXXX | Clear queued lock. See section Lock |
| | | Manager. |
| LkQReq | 9′b01111XXXX | Request queued lock. See section Lock |
| | | Manager. |
| Rsvd | 256:511 | Reserved. |

Jump Address (JmpAd).

Instruction bits [31:16] serve as the JmpAd and LitHi fields. They serve as the JmpAd for Jmp, Jpt, Jsr and Jsx instructions.

| Name | Description |
|---|---|
| JmpAd | JmpAd[15:00]; |

Literal High (LitHi).

Instruction bits [31:16] serve as the JmpAd and LitHi fields. They serve as the LitHi for Lpt, Cnt, Rtt and Rtx instructions. LitHi can be used with LitLo to for a 32-bit literal.

| Name | Description |
|---|---|
| LitHi | LitHi[15:00]; |

Literal Low (LitLo).

Instruction bits [15:00] serve as the LitLo field.

| Name | Description |
|---|---|
| LitLo | LitLo[15:00]; |

CPU Control Port

The host requires a means to halt the CPU, download microcode and force execution at location zero. That means is provided by the CPU Control Port. The port also allows the host to monitor CPU status.

SACI Port.

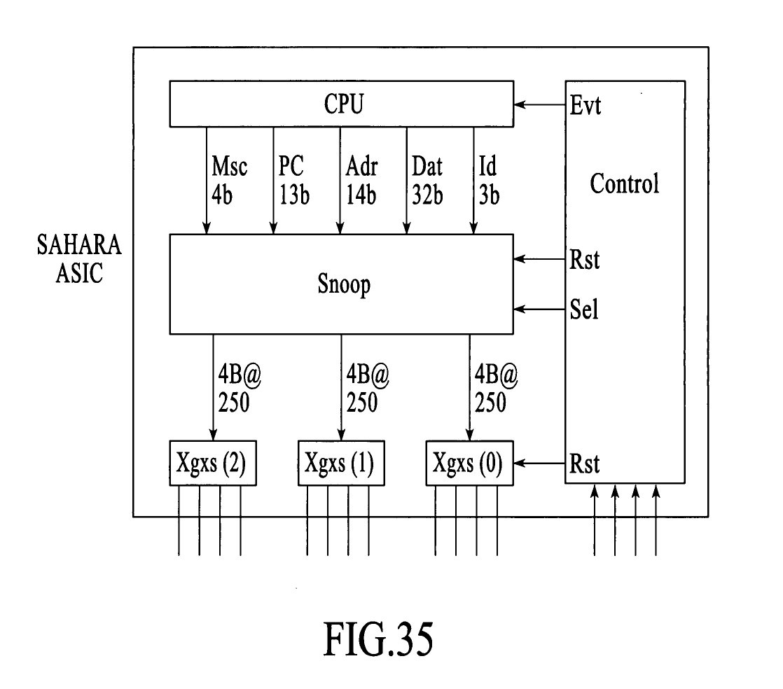

FIG. 35 shows a Snoop Access and Control Interface (SACI) Port that facilitates the exporting of snooped data from the CPU to an external device for storage and analysis. This is intended to function as an aid for the debugging of microcode. A snoop module monitors CPU signals as shown in FIG. 35 then presents the signals to the XGXS module for export to an external adaptor. The “Msc” signal group includes the signals ExeEnb, CpuTgr, GlbTgr and a reserved signal. A table can specify the snoop data and the order in which it is exported for the four possible configurations.

Debug (Dbg)

Describe function of debug registers here.

Halt, run, stop, debug, trigger, debug operand and debug data.

Debug Operand allows the selection of the AluSrcB and AluDst operands for CPU debug cycles.

Debug Source Data is written to by the debug master. Can be specified in AluSrcB field of DbgOpd to force writing of data to destination specified in AluDst. This mechanism can be used to push on to the stack or PC or CPU specific registers which are otherwise not accessible to the debug master.

Debug Destination Data is written to by the debug slave. Is specified in AluDst field of DbgOpd to force saving of data specified in the AluSrcB field. This allows reading from the stack or PC or CPU specific register which are otherwise not accessible to the debug master.

lock manager (LckMgr/LMg)

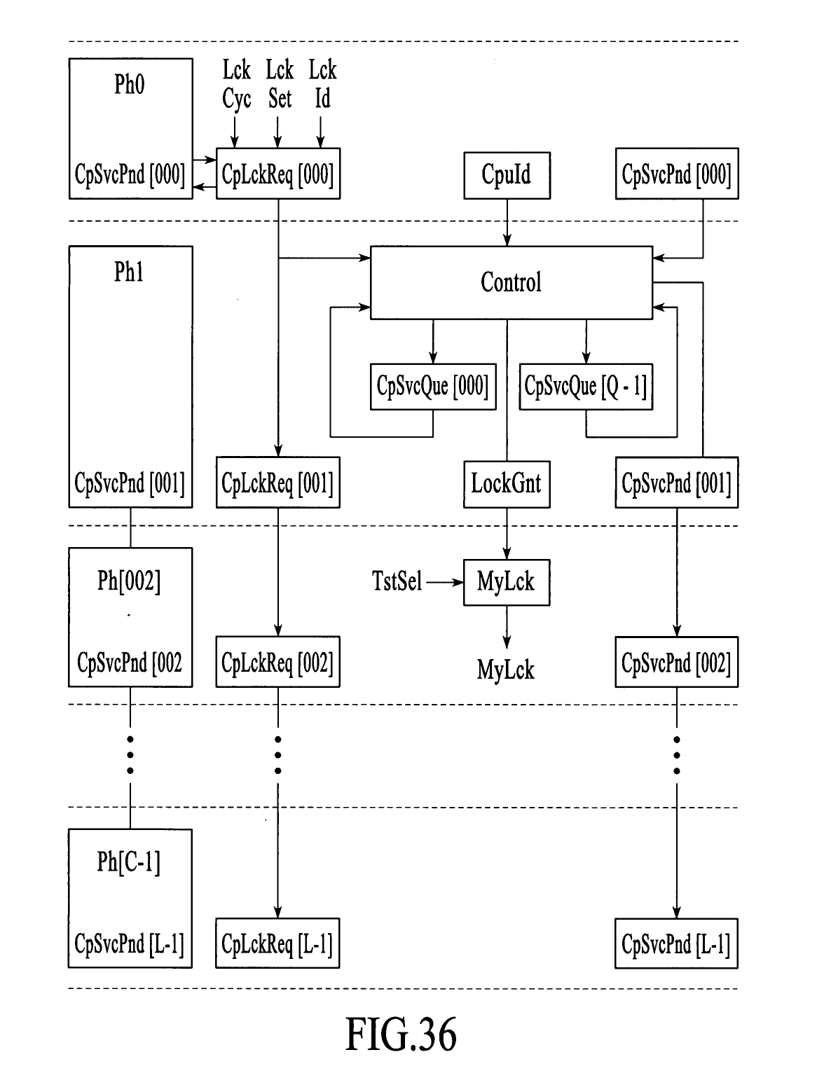

A Register Transfer Language (RTL) description of a lock manager is shown below, and a block diagram of the lock manager is shown in FIG. 36.

/* $Id: locks.sv,v 1.1 2006/04/11 20:42:42 marky Exp $ */
//
=====================================================================================
===========
// Queued Locks
//
=====================================================================================
===========
\grave{ }include “cpu_defs.vh”
\grave{ }include “lock_defs.vh”

| module locks | | (RstL, | |
|---|---|---|---|
| | | Clk, | |
| | | ScanMd, | |
| | | SoftRst, | |
| | | LckCyc, | |
| | | LckSet, | |
| | | LckId, | |
| | | TstSel, | |
| | | MyLck); | |
| input | | RstL; | |
| input | | Clk; | |
| input | | ScanMd; | |
| input | | SoftRst; | |
| input | | LckCyc; | |
| input | | LckSet; | |
| input | [\grave{ }bLockId ] | LckId; | |
| input | [\grave{ }bLockId ] | TstSel; | |
| output | | MyLck; | |
| reg | | MyLck; | //Lock test |
| bit. | | | |
| reg | [\grave{ }bCpuId ] | CpuId; | //Cpu phase |
| counter. | | | |
| reg | [\grave{ }bLockMarks] | LckGnt; | //Lock |
| grants. | | | |
| reg | [\grave{ }bLockMarks] | CpLckReq[\grave{ }bCpuMrks ]; | //Lock |

request bits.

| | | | |
|---|---|---|---|
| reg | [\grave{ }bLockMarks] | CpSvcPnd[\grave{ }bCpuMrks ]; | //Request |

queued bits.

| | | | |
|---|---|---|---|
| reg | [\grave{ }bCpuId ] | CpSvcQue[\grave{ }qLockRqrs−1:0][\grave{ }bLockMarks]; | //Service |
| queues. | | | |

| | | |
|---|---|---|
| reg | CpSvcVld[\grave{ }qLockRqrs−1:0][\grave{ }bLockMarks]; | //Entry valid |
| bits. | | |

| | | |
|---|---|---|
| integer | iPhs ; | //Phase integer. |
| integer | iLck ; | //Lock integer. |
| integer | iEntry; | //Entry integer. |

/************************************************************************************
**************
Reset
*************************************************************************************
************/

| | | |
|---|---|---|
| reg | RstLQ; | |
| wire | LclRstL | = ScanMd ? RstL : RstLQ; |

always @ (posedge Clk or negedge RstL)

| | | |
|---|---|---|
| if(!RstL) | RstLQ | <= 0; |
| else | RstLQ | <= !SoftRst; |

/************************************************************************************
****************/
//Cpu Id.
//CpuId is used to determine which cpu's lock or service requests to service.
/************************************************************************************
****************/
always @ (posedge Clk or negedge LclRstL) begin
if (!LclRstL)

| | |
|---|---|
| CpuId | <= 0; |
| else | |
| CpuId | <= CpuId + 1; |
| end | |

```
/************************************************************************************
****************/
//Cpu Lock Requests
//CpLckReq re-circulates. It is serviced at phase 0 only, where it may be set or
cleared.
/************************************************************************************
****************/
always @ (posedge Clk or negedge LclRstL) begin
    if (!LclRstL)
      for (iPhs=0; iPhs<\grave{ }qCpus ; iPhs=iPhs+1)
```

| | |
|---|---|
| CpLckReq[iPhs] | <= 0; |
| else | |

```
      for (iLck=0; iLck<\grave{ }qLocks; iLck=iLck+1) begin
        if (LckCyc & (LckId==iLck))
```

| | |
|---|---|
| CpLckReq[0] [iLck] | <= LckSet; |
| else | |
| CpLckReq[0] [iLck] | <= CpLckReq[\grave{ }qCpus −1] [iLck]; |

for (iPhs=1; iPhs<\grave{ }qCpus ; iPhs=iPhs+1)

| | |
|---|---|
| CpLckReq[iPhs] [iLck] | <= CpLckReq[iPhs−1] [iLck]; |
| end | |
| end | |

```
/************************************************************************************
****************/
//Cpu Service Pending
//CpSvcPnd is set or cleared in phase 1 only. CpSvcPnd is always forced set if
CpLckReq is set.
//CpSvcPnd remains set until CpLckReq is reset and the output of CpSvcQue indicates
that the current
//cpu is being serviced.
/************************************************************************************
****************/
always @ (posedge Clk or negedge LclRstL) begin
    if (!LclRstL)
      for (iPhs=0; iPhs<\grave{ }qCpus ; iPhs=iPhs+1)
```

| | |
|---|---|
| CpSvcPnd[iPhs] | <= 0; |
| else begin | |
| CpSvcPnd[0] | <= CpSvcPnd[\grave{ }qCpus −1]; |

```
      for (iLck=0; iLck<\grave{ }qLocks; iLck=iLck+1) begin
        if (!CpLckReq[0] [iLck] & CpSvcVld[0] [iLck] & (CpuId==CpSvcQue[0] [iLck]))
```

| | |
|---|---|
| CpSvcPnd[1] [iLck] | <= 1′b0; |
| else | |
| CpSvcPnd[1] [iLck] | <= CpSvcPnd[0] [iLck] \| CpLckReq[0] [iLck]; |

for (iPhs=2; iPhs<\grave{ }qCpus ; iPhs=iPhs+1)

| | |
|---|---|
| CpSvcPnd[iPhs] [iLck] | <= CpSvcPnd[iPhs−1] [iLck]; |
| end | |
| end | |
| end | |

```
*************************************************************************************
****************/
//Service Queues
//CpSvcQue is modified at phase 1 only. There is a CpSvcQue per lock. The output of
CpSvcQue
//indicates which cpu req/rls is to be serviced. When the corresponding cpu is at
phase 1 it's
//CpLckReq is examined and if reset will cause a shift out cycle for the CpSvcQue.
If the current
//cpu is different from the CpSvcQue output and a CpuId has not yet been entered in
to the CpSvcQue
//as indicated by CpSvcPnd, then the current CpuId will be written to the CpSvcQue.
/************************************************************************************
****************/
always @ (posedge Clk or negedge LclRstL)
    if (!LclRstL) for (iLck=0; iLck<\grave{ }qLocks; iLck=iLck+1) begin
      for (iEntry=0; iEntry<\grave{ }qLockRqrs; iEntry=iEntry+1) begin
```

| | |
|---|---|
| CpSvcQue[iEntry] [iLck] | <= 0; |
| CpSvcVld[iEntry] [iLck] | <= 0; |
| end | |
| end | |

```
    else for (iLck=0; iLck<\grave{ }qLocks; iLck=iLck+1) begin
      if (!CpLckReq[0] [iLck]) begin
        if(CpSvcVld[0] [iLck] & (&(CpSvcQue[0] [iLck] ˜\hat{ } CpuId))) begin
            for (iEntry=0; iEntry<(\grave{ }qLockRqrs−1); iEntry=iEntry+1) begin
```

| | |
|---|---|
| CpSvcQue[iEntry] [iLck] | <= CpSvcQue[iEntry+1] [iLck]; |
| CpSvcVld[iEntry] [iLck] | <= CpSvcVld[iEntry+1] [iLck]; |
| end | |

for (iEntry=(\grave{ }qLockRqrs−1); iEntry<\grave{ }qLockRqrs; iEntry=iEntry+1) begin

| | |
|---|---|
| CpSvcQue[iEntry] [iLck] | <= 0; |
| CpSvcVld[iEntry] [iLck] | <= 0; |
| end | |
| end | |
| end | |
| else begin | |

```
        if(!CpSvcPnd[0] [iLck]) begin
            for (iEntry=0; iEntry<1; iEntry=iEntry+1) begin
              if (!CpSvcVld[iEntry] [iLck]) begin
```

| | |
|---|---|
| CpSvcQue[iEntry] [iLck] | <= CpuId; |
| CpSvcVld[iEntry] [iLck] | <= 1′b1; |
| end | |
| end | |

```
            for (iEntry=1; iEntry<\grave{ }qLockRqrs; iEntry=iEntry+1) begin
              if (!CpSvcVld[iEntry] [iLck] & CpSvcVld[iEntry−1] [iLck]) begin
```

| | |
|---|---|
| CpSvcQue[iEntry] [iLck] | <= CpuId; |
| CpSvcVld[iEntry] [iLck] | <= 1′b1; |
| end | |
| end | |
| end | |
| end | |
| end | |

/************************************************************************************
****************/
//Lock Grants
//LckGnt is set or cleared in phase 1 only. LckGnt is set if CpSvcQue indicates that
the current cpu is
// being service and CpLckReq is set.
/************************************************************************************
****************/
always @ (posedge Clk or negedge LclRstL) begin
if (!LclRstL)

| | |
|---|---|
| LckGnt | <= 0; |
| else | |

```
      for (iLck=0; iLck<\grave{ }qLocks; iLck=iLck+1) begin
        if ( CpLckReq[0] [iLck] & CpSvcVld[0] [iLck] & (CpSvcQue[0] [iLck]==CpuId))
```

| | |
|---|---|
| LckGnt[iLck] | <= 1′b1; |

else if ( CpLckReq[0] [iLck] &!CpSvcVld[0] [iLck])

| | |
|---|---|
| LckGnt[iLck] | <= 1′b1; |
| else | |
| LckGnt[iLck] | <= 1′b0; |
| end | |
| end | |

/************************************************************************************
****************/
//My Lock Test
//MyLck is serviced in phase 3 only.
/************************************************************************************
****************/
always @ (posedge Clk or negedge LclRstL) begin
if (!LclRstL)

| | |
|---|---|
| MyLck | <= 0; |
| else | |
| MyLck | <= LckGnt[TstSel]; |
| end | |
| endmodule | |

Slow Bus Controller

The slow bus controller comprises a Slow Data Register (SlwDat), a Slow Address Register (SlwAdr) and a Slow Decode Register (SlwDec). SlwDat sources data for a 32-bit data bus which connects to registers within each of Sahara's functional modules. The SlwDec decodes the SlwAdr[SglSel] bits asserts CfgLd signals which are subsequently synchronized by their target modules then used to enable loading of the target register selected by the SlwDec[RegSel] bits.

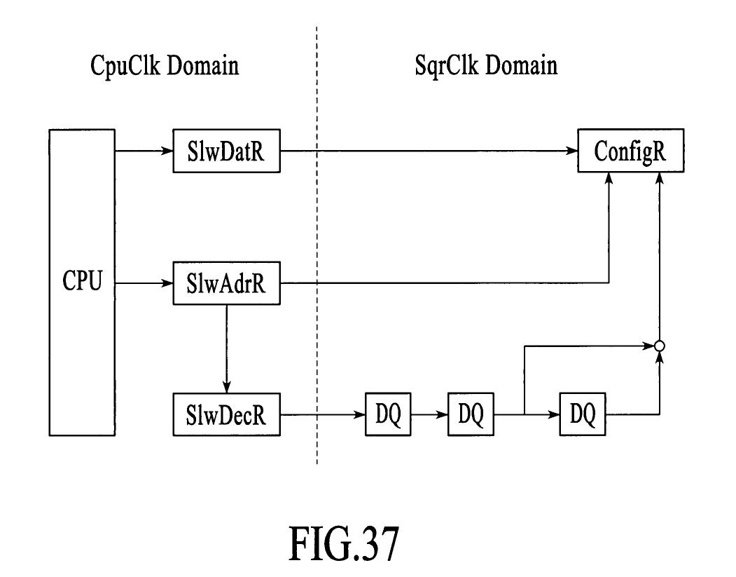

Multiple cycles are required for setup of SlwDat to the destination registers because the SlwDat bus is heavily loaded. Because of this, only a single CPU can access slow registers at a given time. This access is moderated by a queued lock. Queued lock xx must be acquired before a cpu can successfully write to slow registers. Failure to obtain the lock will cause the write to be ignored. The eight level pipeline architecture of the CPU ensures that a single CPU will allow eight clock cycles of setup and hold for slow data. A minimum of three destination clock cycles are needed to ensure that data is captured. This means that if the destination to CPU clock frequency ratio is less than 0.375 (SqrCtkFrq/CpuClkFrq) then a delay must be inserted between steps 2 and 3, and steps 4 and 5. The CPU ucode should perform the steps shown in FIG. 37.

Insert module select and register select and register definition tables here.

Dispatch Queue Base (CmdQBs)

GlbRam address at which the first Dispatch Queue resides. Used by the CPU while writing to a dispatch queue and by DMA Dispatcher while reading for a dispatch queue.

| Bits | Name | Description |
|---|---|---|
| 31:17 | Rsvd | Ignored. |
| 16:00 | CmdQBs | Start of GRm based Dispatch Queues. |
| | | Bits[9:0] are always zeroes. |

Response Queue Base (EvtQBs)

GlbRam address at which the first Response Queue resides. Used by the CPU while reading from a response queue and by DMA Response Sequencer while writing to a response queue.

| Bits | Name | Description |
|---|---|---|
| 31:17 | Rsvd | Ignored. |
| 16:00 | EvtQBs | Start of GRm based Response Queues. |
| | | Bits[9:0] are always zeroes. |

DMA Descriptor Base (DmaBBs)

GlbRam address at which the first DMA Descriptor resides. Used by the CPU, DMA Dispatcher and DMA Response Sequencer.

| Bits | Name | Description |
|---|---|---|
| 31:17 | Rsvd | Ignored. |
| 16:00 | DmaBBs | Start of GRm based DMA Descriptors. |
| | | Bits[9:0] are always zeroes. |

Header Buffer Base (HdrBBs)

GlbRam address at which the first Header Buffer resides. Used by the CPU and DMA Dispatcher.

| Bits | Name | Description |
|---|---|---|
| 31:17 | Rsvd | Ignored. |
| 16:00 | HdrBBs | Start of GRm based Header Buffers. |
| | | Bits[9:0] are always zeroes. |

Header Buffer Size (HdrBSz)

Size of the Header Buffers. Used by the CPU and DMA Dispatcher to determine the GlbRam location of successive Header Buffers. An entry of 0 indicates a size of 256.

| Bits | Name | Description |
|---|---|---|
| 31:08 | Rsvd | Ignored. |
| 07:00 | HdrBSz | Size of GRm based Header Buffers. |
| | | Bits[4:0] are always zeroes. |

TCB Map Base (TMapBs)

GlbRam address at which the TCB Bit Map resides. Used by the CPU.

| Bits | Name | Description |
|---|---|---|
| 31:17 | Rsvd | Ignored. |
| 16:00 | TMapBs | Start of GRm based TCB Bit Map. |
| | | Bits[9:0] are always zeroes. |

Cache Buffer Base (CchBBs)

GlbRam address at which the first Cache Buffer resides. Used by the CPU and DMA Dispatcher.

| Bits | Name | Description |
|---|---|---|
| 31:17 | Rsvd | Ignored. |
| 16:00 | CchBBs | Start of GRm based Cache Buffers. |
| | | Bits[9:0] are always zeroes. |

Cache Buffer Size (CchBSz)

Size of the Cache Buffers. Used by the CPU and DMA Dispatcher to determine the GlbRam location of successive Cache Buffers and by the DMA Dispatcher to determine the amount of data to copy from dram TCB Buffers to Cache Buffers. An entry of 0 indicates a size of 2 KB.

| Bits | Name | Description |
|---|---|---|
| 31:11 | Rsvd | Ignored. |
| 10:00 | CchBSz | Size of GRm based Cache Buffers. |
| | | Bits[6:0] are always zeroes. |

Host Receive SGL Pointer Index (SglPlx)

Location of SGL Pointers relative to the start of a Cache Buffer. Used by the DMA Dispatcher to fetch the RcvSglPtr or XmtSglPtr during SGL mode operation.

| Bits | Name | Description |
|---|---|---|
| 31:09 | Rsvd | Ignored. |
| 08:00 | SglPIx | Offset of RcvSglPtr. |
| | | Bits[3:0] are always zeroes. |

Memory Descriptor Index (MemDscIx)

Location of the Next Receive Memory Descriptor relative to the start of a Cache Buffer. Used by the DMA Dispatcher to specify a data destination address during SGL mode operation.

| Bits | Name | Description |
|---|---|---|
| 31:09 | Rsvd | Ignored. |
| 08:00 | MemDscIx | Offset of RcvMemDsc. |
| | | Bits[3:0] are always zeroes. |

Receive Queue Index (TRQIx)

Start of the Receive Queue relative to the start of a Cache Buffer. Used by the DMA Dispatcher for TCB mode operations to specify the amount of data to be copied. Used by the CPU to formulate Receive Queue read and write addresses.

| Bits | Name | Description |
|---|---|---|
| 31:09 | Rsvd | Ignored. |
| 08:00 | TRQIx | Offset of TcbRcvLis. |
| | | Bits[3:0] are always zeroes. |

Receive Queue Size (TRQSZ)

Size of the Receive Queue. Used by the DMA Dispatcher for TCB mode operations to specify the amount of data to be copied. Used by the CPU to determine roll-over boundaries for Receive Queue Write Sequence and Receive Queue Read Sequence. An entry of 0 indicates a size of 1 KB.

| Bits | Name | Description |
|---|---|---|
| 31:09 | Rsvd | Ignored. |
| 08:00 | TRQSz | Size of TRQ. |
| | | Bits[3:0] are always zeroes. |

TCB Buffer Base (TcbBBs)

Host address at which the first TCB resides. Used by the DMA Dispatcher to formulate host addresses during TCB mode operations.

| Bits | Name | Description |
|---|---|---|
| 63:00 | TcbBBs | Start of Host based TCBs. |
| | | Bits[10:0] are always zeroes. |

Dram Queue Base (DrmQBs)

Dram address at which the first dram queue resides. Used by the Queue Manager to formulate dram addresses during queue body read and write operations.

| Bits | Name | Description |
|---|---|---|
| 31:28 | Rsvd | Ignored. |
| 27:00 | DrmQBs | Start of dram based queues. |
| | | Bits[17:0] are always zeroes. |

Math Coprocessor (MCP)

Sahara contains hardware to execute divide/multiply operations. There is only 1 set of hardware so only one processor may be using it at any one time.

The divider is used by requesting QLck[0] while writing to the dividend register. If the lock is not granted then the write will be inhibited, permitting a single instruction loop until the lock is granted. The operation is then initiated by writing to the divisor register which will cause test condition MthBsy to assert. When complete, MthBsy status will be reset and the result can be read from the quotient and dividend register.

Divide is executed sequentially 2 bits at a time. The number of clocks taken is actually deterministic, assuming the sizes of the operands are known. For divide, the number of cycles taken can be calculated as follows:
MS_Bit_divend=bit position of most significant 1 bit in dividend
MS_Bit_divisor=bit position of most significant 1 bit in divisor
Number of clocks to complete=MS_Bit_divend/2−MS_Bit_divisor/2+2

So if, for instance, we know that the dividend is less than 64K (fits in bits 15-0) and the divisor may be as small as 2 (represented by bit 1), then the maximum number of clocks to complete is 15/2−½+2=7−0+2=9 cycles The multiply is performed by requesting QLck[0] while writing to the multiplicand register. If the lock is not granted then the write will be inhibited, permitting a single instruction loop until the lock is granted. The operation is then initiated by writing to the multiplier register which will cause test condition MthBsy to assert. When complete, MthBsy status will be reset and the result can be read from the product register.

Multiply time is only dependent on the size of the multiplier. The number of cycles taken for multiply may be calculated by
MS_Bit_multiplier=bit position of most significant 1 bit in multiplier
Number of clocks to complete=MS_Bit_multiplier/2+1

So to multiply by a 16 bit number would take (15/2+1) or 8 clocks.

Queues

The Queues are utilized by the CPU for communication with modules or between processes. There is a dedicated Queue Ram which holds the queue data. The queues can be directly accessed by the CPU without need for issuing commands. That is to say that the CPU can read or write a queue with data. The instruction which performs the read or write must perform a test to determine if the read or write was successful.

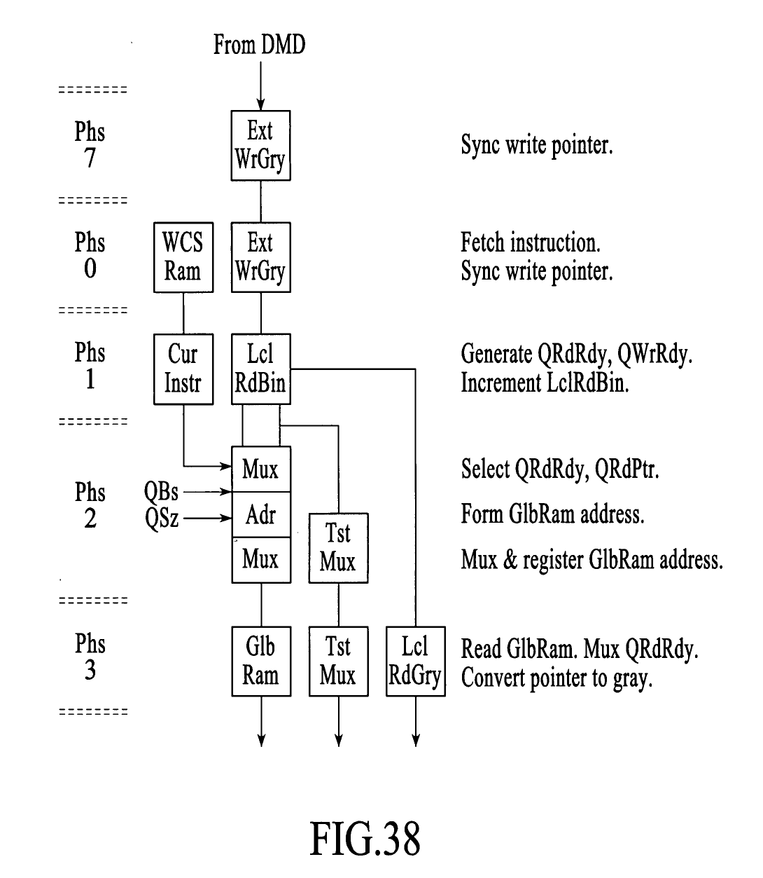

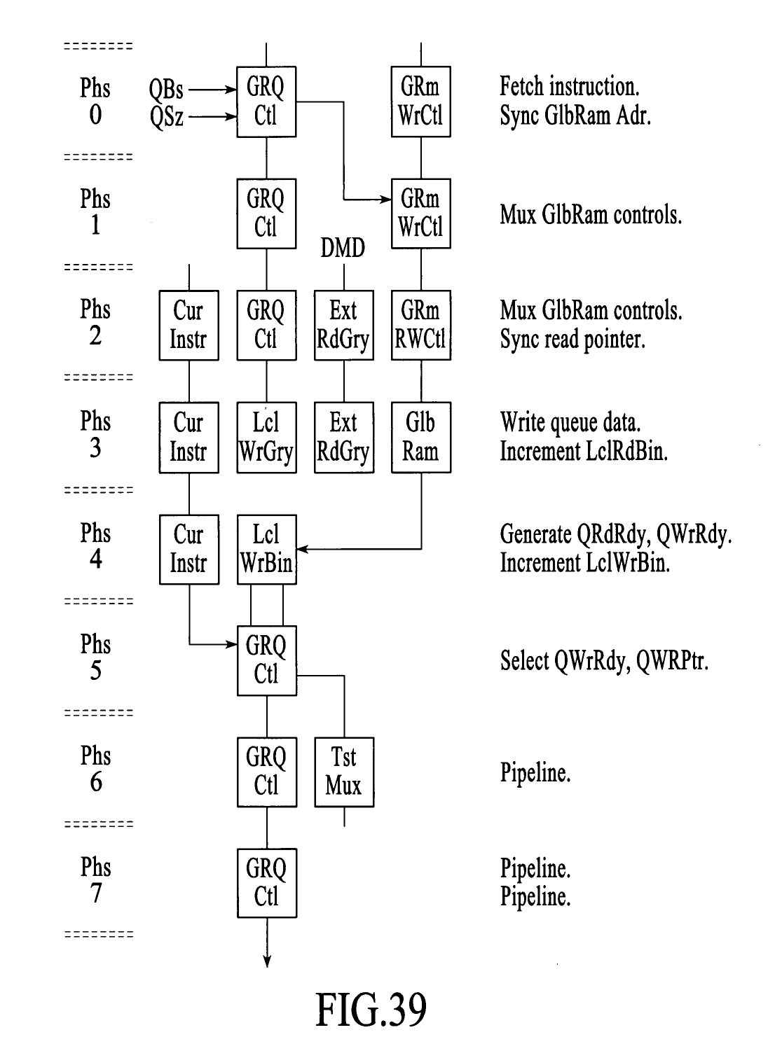

There are three types of queues. Ingress queues hold information which is passing from a functional module to the CPU. FIG. 38 shows an Ingress Queue. Egress queues hold information which is passing from the CPU to a functional module. FIG. 39 shows an Egress Queue. Local queues hold information which is passing between processes that are running on the CPU.

| QId | Name | Type | Bytes | Description |
|---|---|---|---|---|
| 95:64 | SBfDscQ | Local | 8K | 32 System Buffer Descriptor Queues. One per CpuCx. |
| 63 | SpareFQ | Local | 4K | Spare local Queue. |
| 62 | SpareEQ | Local | 2K | Spare local Queue. |
| 61 | SpareDQ | Local | 1K | Spare local Queue. |
| 60 | SpareCQ | Local | 1K | Spare local Queue. |
| 59 | SpareBQ | Local | 512 | Spare local Queue. |
| 58 | SpareAQ | Local | 128 | Spare local Queue. |
| 57 | FSMEvtQ | Local | 16K | Finite-State-Machine Event Queue. |
| 56 | CtxRunQ | Local | 128 | Context Runnable Queue. |
| 47 | RcvBufQ | Egress | 8K | Receive Buffer Queue. |
| 46 | RSqCmdQ | Egress | 2K | Receive Sequencer Command Queue. |
| 45 | PxhCmdQ | Egress | 1K | High Priority Proxy Command Queue. |
| 44 | PxlCmdQ | Egress | 1K | Low Priority Proxy Command Queue. |
| 43 | H2gCmdQ | Egress | 1K | Host to GlbRam DMA Command Queue. |
| 42 | H2dCmdQ | Egress | 1K | Host to DRAM DMA Command Queue. |
| 41 | G2hCmdQ | Egress | 1K | GlbRam to Host DMA Command Queue. |
| 40 | G2dCmdQ | Egress | 1K | GlbRam to DRAM DMA Command Queue. |
| 39 | D2dCmdQ | Egress | 1K | DRAM to DRAM DMA Command Queue. |
| 38 | D2hCmdQ | Egress | 1K | DRAM to Host DMA Command Queue. |
| 37 | D2gCmdQ | Egress | 1K | DRAM to GlbRam DMA Command Queue. |
| 36 | RSqEHiQ | Ingress | 4K | RcvSqr Event High Priority Queue. |
| 35 | RSqELoQ | Ingress | 4K | RcvSqr Event Low Priority Queue. |
| 34 | XmtBufQ | Ingress | 1K | Transmit Buffer Queue. 22K |
| 33 | HstEvtQ | Ingress | 2K | Host Event Staging Queue. |
| 32 | PxyBufQ | Ingress | 256 | Proxy Buffer Queue. |
| 31:00 | DmdRspQ | Ingress | 1K | 32 Dmd Response Queues. One per CPU context. |

Event Manager (EvtMgr/EMg)

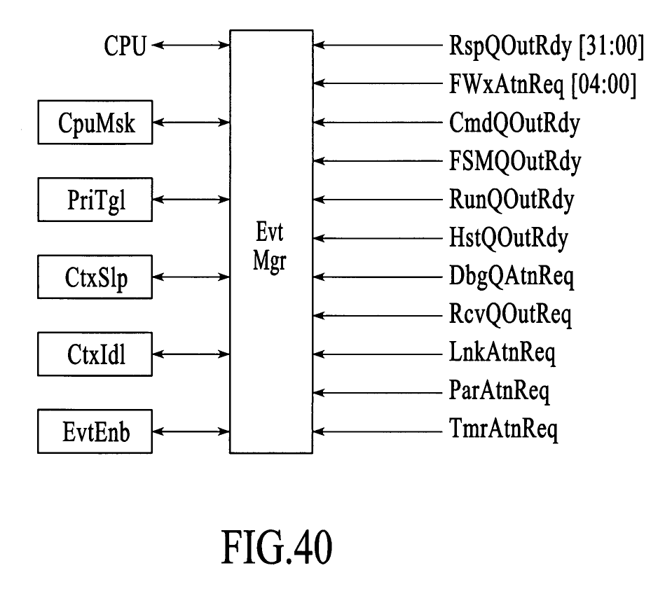

Events and CPU Contexts are inextricably bound. DMA response and run events invoke specific CPU Contexts while all other events demand the allocation of a free CPU Context for servicing to proceed. FIG. 40 shows an Event Manager. The Event Manager combines CPU Context management with event management in order to reduce idle loop processing to a minimum. EvtMgr implements context control registers which allow the CPU to force context state transitions. Current context state can be tested or forced to idle, busy or sleep. Free context allocation is also made possible through the CtxSvr register which provides single cycle servicing of requests without a need for spin-locks.

Event control registers provide the CPU a method to enable or disable events and to service events by providing vector generation with automated context allocation. Events serviced, listed in order of priority, are:
ErrEvt—DMA Error Event.
RspEvt—DMA Completion Event.
BRQEvt—System Buffer Request Event.
RunEvt—Run Request Event.
DbgEvt—Debug Event.
FW3Evt—Firmware Event 3.
HstEvt—Slave Write Event.
TmrEvt—Interval Timer Event.
FW2Evt—Firmware Event 2.
FSMEvt—Finite State Machine Event.
RSqEvt—RcvSqr Event.
FW1Evt—Firmware Event 1.
CmdEvt—Command Ready Event.
LnkEvt—Link Change Event.
FW0Evt—Firmware Event 0.
ParEvt—ECC Error Event.

EvtMgr prioritizes events and presents a context to the CPU along with a vector to be used for code branching. Event vectoring is accomplished when the CPU reads the Event Vector (EvtVec) register which contains an event vector in bits [3:0] and a CPU Context in bits [28:24]. The instruction adds the retrieved vector to a vector-table base-address constant, loading the resulting value into the program counter, thereby accomplishing a branch-relative function. The instruction actually utilizes the CpCxId destination operand along with a flag modifier which specifies the pc as a secondary destination. The actual instruction would appear something like:
Add EvtVec VTblAdr CpCxId, FlgLdPc; //Vector into event table.

EvtVec is an EvtMgr register, VTblAdr is the instruction address where the vector table begins, CpCxId is current CPU's context ID register and FlgLdPc specifies that the alu results also be written to the program counter. The final effect is for the CPU Context to be switched and the event to be decoded within a single cycle. A single exception exists for the RunEvt for which the EvtVec register does not provide the needed context for resumes. Reading the EvtVec register causes the event type associated with the current event vector to be disabled by clearing it's corresponding bit in the Event Enable register (EvtEnb) or in the case of a RspEvt, by setting the context to the busy state. The effect is to inhibit duplicate event service, until explicitly enabled at a later time. The event type may be re-enabled by writing it's bit position in the EvtEnb register or CtxSlp register. The vector table takes the following form.

| Vec | Event | Instruction |
|---|---|---|
| 0 | RspEvt | Mov DmdRspQ CpRgXX, Rtx; //Save DMA response and re-enter. |
| 1 | BRQEvt | , Jmp BRQEvtSvc; // |
| 2 | RunEvt | Mov CtxRunQ CpCxId, Jmp RunEvtSvc; //Save run event descriptor. |
| 3 | DbgEvt | , Jmp DbgEvtSvc; // |
| 4 | FW3Evt | , Jmp FW3EvtSvc; // |
| 5 | HstEvt | Mov HstEvtQ CpRgXX, Jmp HstEvtSvc; //Save lower 32 bits of descriptor. |
| 6 | TmrEvt | , Jmp TmrEvtSvc; // |
| 7 | FW2Evt | , Jmp FW2EvtSvc; // |
| 8 | FSMEvt | Mov FSMEvtQ CpRgXX, Jmp FSMEvtSvc; //Save FSM event descriptor. |
| 9 | RSqEvt | Mov RSqEvtQ CpRgXX, Jmp RspEvtSvc; //Save event descriptor. |
| A | FW1Evt | , Jmp FW1EvtSvc; // |
| B | CmdEvt | Mov HstCmdQ CpRgXX, Jmp CmdRdySvc; //Save command descriptor. |
| C | LnkEvt | , Jmp LnkEvtSvc; // |
| D | FW0Evt | , Jmp FW0EvtSvc; // |
| E | ParEvt | , Jmp ParEvtSvc; // |
| F | NulEvt | , Jmp IdleLoop; //No event detected. |

EvtMgr provides an event mask for each of the CPUs. This allows ucode to configure each CPU with a unique mask for the purpose of distributing the load for servicing events. Also, a single CPU can be defined to service utility functions.

RSqEvt and CmdEvt priorities can be shared. Each time the EvtMgr issues RSqEvt or CmdEvt in response to an EvtVec-read the issued event is assigned the least of the two priorities while the other event is assigned the greater of the two priorites thus ensuring fairness. This is accomplished by setting PriTgl each time RSqEvt is issued.

Idle Contexts Register (CtxIdl)

| Bit | Description |
|---|---|
| 31:00 | R/W - CtxIdl[31:00]. Set by writing “1”. |
| | Cleared by writing CtxBsy or CtxSlp. |

Busy Contexts Register (CtxBsy)

| Bit | Description |
|---|---|
| 31:00 | R/W - CtxBsy[31:00]. Set by writing “1”. |
| | Cleared by writing CtxIdl or CtxSlp. |

Sleep Contexts Register (CtxSlp)

| Bit | Description |
|---|---|
| 31:00 | R/W - CtxSlp[31:00]. Set by writing “1”. |
| | Cleared by writing CtxBsy or CtxIdl. |

CPU Event Mask Register (CpuMsk[CurCpu])

| Bit | Description |
|---|---|
| 31:10 | Reserved. |
| 0E:0E | R/W bit - CpuMsk[11]. Writing a “1” enables ParEvt. Writing a “0” disables ParEvt. |
| 0D:0D | R/W bit - CpuMsk[11]. Writing a “1” enables BRQEvt. Writing a “0” disables BRQEvt. |
| 0C:0C | R/W bit - CpuMsk[10]. Writing a “1” enables LnkEvt. Writing a “0” disables LnkEvt. |
| 0B:0B | R/W bit - CpuMsk[09]. Writing a “1” enables CmdEvt. Writing a “0” disables CmdEvt. |
| 0A:0A | R/W bit - CpuMsk[11]. Writing a “1” enables FW3Evt. Writing a “0” disables FW3Evt. |
| 09:09 | R/W bit - CpuMsk[08]. Writing a “1” enables RSqEvt. Writing a “0” disables RSqEvt. |
| 08:08 | R/W bit - CpuMsk[07]. Writing a “1” enables FSMEvt. Writing a “0” disables FSMEvt. |
| 07:07 | R/W bit - CpuMsk[11]. Writing a “1” enables FW2Evt. Writing a “0” disables FW2Evt. |
| 06:06 | R/W bit - CpuMsk[06]. Writing a “1” enables TmrEvt. Writing a “0” disables TmrEvt. |
| 05:05 | R/W bit - CpuMsk[05]. Writing a “1” enables HstEvt. Writing a “0” disables HstEvt. |
| 04:04 | R/W bit - CpuMsk[11]. Writing a “1” enables FW1Evt. Writing a “0” disables FW1Evt. |
| 03:03 | R/W bit - CpuMsk[02]. Writing a “1” enables DbgEvt. Writing a “0” disables DbgEvt. |
| 02:02 | R/W bit - CpuMsk[01]. Writing a “1” enables RunEvt. Writing a “0” disables RunEvt. |
| 01:01 | R/W bit - CpuMsk[11]. Writing a “1” enables FW0Evt. Writing a “0” disables FW0Evt. |
| 00:00 | R/W bit - CpuMsk[00]. Writing a “1” enables RspEvt. Writing a “0” disables RspEvt. |

Event Enable Register (EvtEnb)

| Bit | Description |
|---|---|
| 31:10 | Reserved. |
| 0E:0E | R/W bit - ParEvtEnb. Writing a “1” enables ParEvt. Writing a “0” has no effect. |
| 0D:0D | R/W bit - BRQEvtEnb. Writing a “1” enables BRQEvt. Writing a “0” has no effect. |
| 0C:0C | R/W bit - LnkEvtEnb. Writing a “1” enables LnkEvt. Writing a “0” has no effect. |
| 0B:0B | R/W bit - CmdEvtEnb. Writing a “1” enables CmdEvt. Writing a “0” has no effect. |
| 0A:0A | R/W bit - FW3EvtEnb. Writing a “1” enables FW3Evt. Writing a “0” has no effect. |
| 09:09 | R/W bit - RSqEvtEnb. Writing a “1” enables RSqEvt. Writing a “0” has no effect. |
| 08:08 | R/W bit - FSMEvtEnb. Writing a “1” enables FSMEvt. Writing a “0” has no effect. |
| 07:07 | R/W bit - FW2EvtEnb. Writing a “1” enables FW2Evt. Writing a “0” has no effect. |
| 06:06 | R/W bit - TmrEvtEnb. Writing a “1” enables TmrEvt. Writing a “0” has no effect. |
| 05:05 | R/W bit - HstEvtEnb. Writing a “1” enables HstEvt. Writing a “0” has no effect. |
| 04:04 | R/W bit - FW1EvtEnb. Writing a “1” enables FW1Evt. Writing a “0” has no effect. |
| 03:03 | R/W bit - DbgEvtEnb. Writing a “1” enables DbgEvt. Writing a “0” has no effect. |
| 02:02 | R/W bit - RunEvtEnb. Writing a “1” enables RunEvt. Writing a “0” has no effect. |
| 01:01 | R/W bit - FW0EvtEnb. Writing a “1” enables FW0Evt. Writing a “0” has no effect. |
| 00:00 | R/W bit - RspEvtEnb. Writing a “1” enables RspEvt. Writing a “0” has no effect. |

Event Disable Register (EvtDbl)

| Bit | Description |
|---|---|
| 31:10 | Reserved. |
| 09:09 | R/W bit - ParEvtDbl. Writing a “1” disables ParEvt. Writing a “0” has no effect. |
| 08:08 | R/W bit - LnkEvtDbl. Writing a “1” disables LnkEvt. Writing a “0” has no effect. |
| 07:07 | R/W bit - CmdEvtDbl. Writing a “1” disables CmdEvt. Writing a “0” has no effect. |
| 06:06 | R/W bit - RSqEvtDbl. Writing a “1” disables RSqEvt. Writing a “0” has no effect. |
| 05:05 | R/W bit - FSMEvtDbl. Writing a “1” disables FSMEvt. Writing a “0” has no effect. |
| 04:04 | R/W bit - TmrEvtDbl. Writing a “1” disables TmrEvt. Writing a “0” has no effect. |
| 03:03 | R/W bit - HstEvtDbl. Writing a “1” disables HstEvt. Writing a “0” has no effect. |
| 02:02 | R/W bit - DbgEvtDbl. Writing a “1” disables DbgEvt. Writing a “0” has no effect. |
| 01:01 | R/W bit - RunEvtDbl. Writing a “1” disables RunEvt. Writing a “0” has no effect. |
| 00:00 | R/W bit - RspEvtDbl. Writing a “1” disables RspEvt. Writing a “0” has no effect. |

Event Vector Register (EvtVec)

| Bit | Description |
|---|---|
| 31:29 | Reserved. |
| 28:24 | CpuCx to be used for servicing the event. Not valid for RunEvt vector. |
| 23:04 | Reserved. |
| 03:00 | Event Vector indicates event to be serviced. |
| | 10: NulEvt, Cause: No detected events. |
| | 09: ParEvt, Cause: CpuMsk[15] & ParEvtEnb & ParAtnReq. |
| | 00: BRQEvt, Cause: CpuMsk[14] & BRQEvtEnb & SysBufReq. |
| | 08: LnkEvt, Cause: CpuMsk[13] & LnkEvtEnb & LnkAtnReq. |
| | 07: CmdEvt, Cause: CpuNsk[12] & CmdEvtEnb & CmdQOutRdy. |
| | 00: FW3Evt, Cause: CpuMsk[11] & FW3EvtEnb & FWxAtnReq[3]. |
| | 06: RSqEvt, Cause: CpuMsk[10] & RSqEvtEnb & RcvQOutRdy. |
| | 05: FSMEvt, Cause: CpuMsk[09] & FSMEvtEnb & FSMQOutRdy. |
| | 00: FW2Evt, Cause: CpuMsk[07] & FW2EvtEnb & FWxAtnReq[2]. |
| | 04: TmrEvt, Cause: CpuMsk[06] & TmrEvtEnb & TmrAtnReq. |
| | 03: HstEvt, Cause: CpuMsk[05] & HstEvtEnb & HstQOutRdy. |
| | 00: FW1Evt, Cause: CpuMsk[04] & FW1EvtEnb & FWxAtnReq[1]. |
| | 02: DbgEvt, Cause: CpuMsk[03] & DbgEvtEnb & DbgAtnReq. |
| | 01: RunEvt, Cause: CpuMsk[02] & RunEvtEnb & RunQOutRdy. |
| | 00: FW0Evt, Cause: CpuMsk[01] & FW0EvtEnb & FWxAtnReq[0]. |
| | 00: RspEvt, Cause: CpuMsk[00] & RspEvtEnb & \|(EvtQOutRdy[31:0] & CtxIdl[31:03]). |

Dmd DMA Error Register (DmdErr)

| Bit | Description |
|---|---|
| 31:00 | R/W - DmdErr[31:00]. “1” indicates error. |
| | Cleared by writing “1”. |

TCB Manager (TcbMgr/TMg)

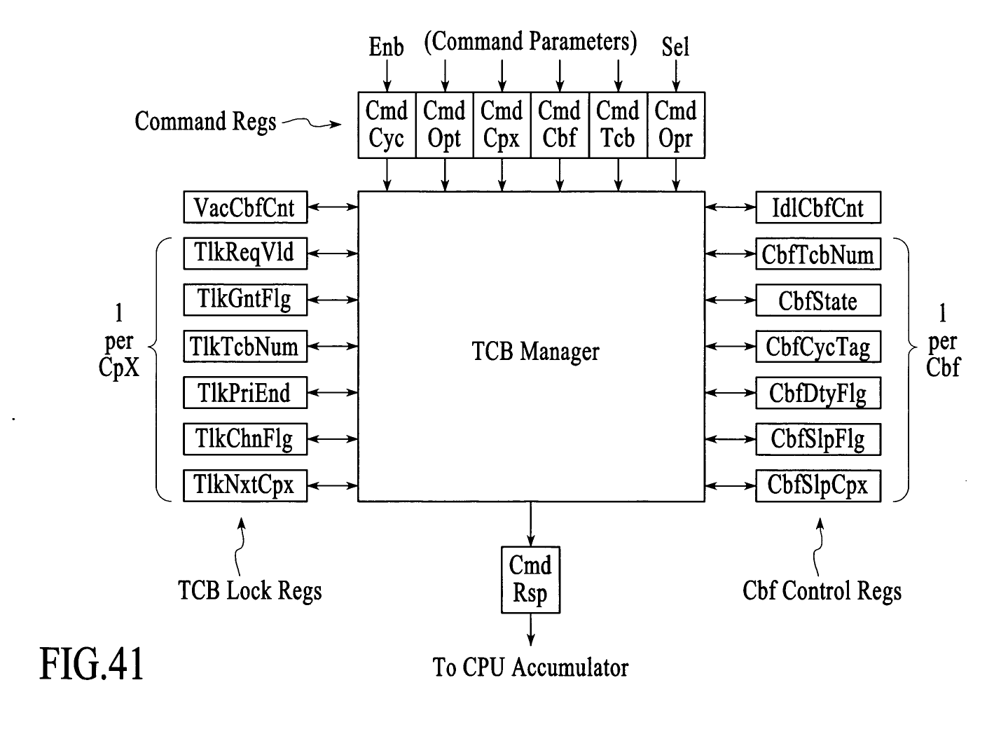

FIG. 41 is a Block Diagram of a TCB Manager. Sahara is capable of offloading up to 4096 TCBs. TCBs, which reside in external memory, are copied into Cache Buffers (Cbfs) for a CPU to access them. Cache Buffers are implemented in contiguous locations of Global Ram to which the CPU has ready access. A maximum of 128 Cache Buffers can be implemented in this embodiment, but Sahara will support fewer Cache Buffers for situations which need to conserve Global Ram.

Due to Sahara's multi-CPU and multi-context architecture, TCB and Cache Buffer access is coordinated through the use of TCB Locks and Cache Buffer Locks. TcbMgr provides the services needed to facilitate these locks. TcbMgr is commanded via a register which has sixteen aliases whereby each alias represents a unique command. Command parameters are provided by the alu output during CPU instructions which specify one of the command aliases as the destination operand. Command responses are immediately saved to the CPU's accumulator. FIG. 41 illustrates the TCB Manager's storage elements. A TCB Lock register is provided for each of the thirty-two CPU Contexts and a Cache Buffer Control register is provided for each of the 128 possible Cache Buffers.

TCB Locks

The objective of TCB locking is to allow logical CPUs, while executing a Context specific thread, to request ownership of a TCB for the purpose of reading the TCB, modifying the TCB or copying the TCB to or from the host. It is also the objective of TCB locking, to enqueue requests such that they are granted in the order received with respect to like priority requests and such that high priority requests are granted prior to normal priority requests.

Up to 4096 TCBs are supported and a maximum of 32 TCBs, one per CPU Context, can be locked at a given time. TCB ownership is granted to a CPU Context and each CPU Context can own no more than a single TCB. TCB ownership is requested when a CPU writes a CpxId and TcbId to the TlkNmlReq or TlkRcvReq operand. Lock ownership will be granted immediately provided it is not already owned by another CPU Context. If the requested TCB Lock is not available and the ChnInh option is not selected then the TCB Lock request will be chained. Chained TCB Lock requests will be granted at future times as TCB Lock release operations pass TCB ownership from CPU Context which initiated the next lock request.

Priority sub-chaining is affected by the TlkRcvReq and TlkRcvPop operands. This facilitates a low latency receive-event copy from the RcvSqr event queue to the TCB receive-list and the ensuing release of the CPU-context for re-use. This feature increases the availability of CPU Contexts for performing work by allowing them to be placed back into the free context pool. The de-queuing of high priority requests from the request chain does not affect the current lock ownership. It allows the current CPU to change to the CPU Context which generated the high priority request, then copy the receive-event descriptor from a context specific register to a CPU specific register, switch back to the previous CPU-context, release the dequeued CPU Context for re-use and finally push the retrieved receive-event descriptor on to the TCB receive-list.

Each CPU Context has a dedicated TCB-Lock register set of which the purpose is to describe a lock request. The TCB Lock register set is defined as follows.

TlkReqVld—Request Valid indicates that an active lock request exists and serves as a valid indication for all other registers. This register is set by the TlkNmlReq and TlkRcvReq commands and it is cleared by the TlIkLckRls and TlkRcvPop commands.

TlkTcbNum—TCB Number specifies one of 4096 TCBs to be locked. This register is modified by only the TlkNmlReq and TlkRcvReq commands. The contents of TlkTcbNum are continuously compared with the command parameter CmdTcb and the resultant status is used to determine if the specified TCB is locked or unlocked.

TlkGntFlg—Grant Flag indicates that the associated CPU Context has been granted Tcb ownership. Set by the commands TlkNmlReq and TlkRcvReq or when the CPU Context has a queued request which is scheduled to be serviced next and a different CPU Context relinquishes ownership. Grant Flag is cleared during the TlkLckFIs command.

TlkChnFlg—Chain Flag indicates that a different CPU Context has requested the same TCB-Lock and that it's request has been scheduled to be serviced next. TlkChnFlg is set during TlkNmIReq and TlkRcvReq commands and is cleared during TlkRcvPop and TlkLckFls commands.

TlkPriEnd—Priority End indicates that the request is the last request in the priority sub-chain. It is set or cleared during TlkRcvPop, TlIkLckRIs, TMgReqNml and TMgReqHgh commands.

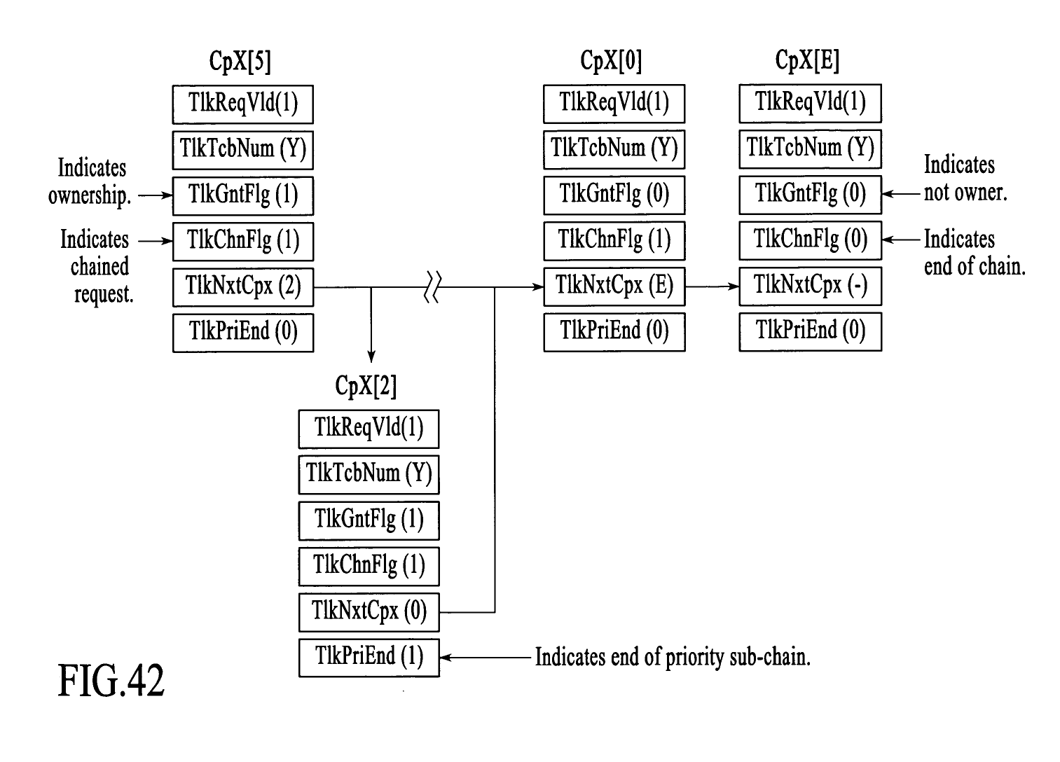

TlkNxtCpx—Next CpX specifies the CPU Context of the next requester and is valid if TlkChnFlg is asserted. FIG. 42 illustrates how TCB Lock registers form a request chain. CpX[5] (CPU Context 5) is the current lock owner, CpX[2] is the next requester followed by CpX[0] and finally CpX[14]. ReqVId==1 to indicate valid request and ownership. ReqVId=0 indicates that the corresponding CPU Context is not requesting a TCB Lock and that all of the other registers are invalid. GntFlg is set to indicate TCB ownership. TcbNum indicates which TCB Lock is requested. ChnFlg indicates that NxtCpx is valid. NxtCpx points to the next requesting CPU Context. PriEnd indicates the end of the high priority request sub-chain.

The following four commands allow the CPU to control TCB Locking.

Request TCB Lock—Normal Priority (TlkNmlReq)

Requests, at a normal priority level, a lock for the specified TCB on behalf of the specified CPU Context. If the context already has a request for a TCB Lock other than the one specified, then TmgErr status is returned because a context may never own more than a single lock. If the context already has a request for the specified TCB Lock but does not yet own the TCB, then TmgErr status is returned because the specified context should be resuming with the lock granted. If the specified context already has ownership of the specified TCB, then TmgDup status is returned indicating successful resumption of a thread. If the specified TCB is owned by another context and ChnInh is reset, then the request will be linked to the end of the request chain and TmgSlp status will be returned indicating that the thread should retire until the lock is granted. If the specified TCB is owned by another context and ChnInh is set, then the request will not be linked and TmgSlp status will be returned. The request chaining inhibit is provided for unanticipated situations.

| CmdRg | Field | Description |
|---|---|---|
| 31:31 | ChnInh | Request chaining inhibit. |
| 30:29 | Rsvd | |
| 28:24 | CpuCx | CPU Context identifier. |
| 23:12 | Rsvd | |
| 11:00 | TcbId | TCB identifier. |

| RspRg | Field | Description |
|---|---|---|
| 31:29 | Status | 7: TmgErr 4: TmgSlp 1: TmgDup 0: TmgGnt |
| 28:00 | Rsvd | Zeroes. |

Release TCB Lock (TIkLckRIs)

Requests that the specified CPU Context relinquish the specified TCB Lock. If the CPU Context does not own the TCB, then TmgErr status is returned. If a chained request is found, it is immediately granted the TCB Lock and the ID of the new owner is returned in the response along with TmgRsm status. The current logical CPU may put the CPU Context ID of the new owner on to a resume list or it may immediately resume execution of the thread by assuming the CPU Context. If no chained request is found, then TmgGnt status is returned.

| CmdRg | Field | Description |
|---|---|---|
| 31:29 | Rsvd | |
| 28:24 | CpuCx | CPU Context identifier. |
| 23:12 | Rsvd | |
| 11:00 | TcbId | TCB identifier. |

| RspRg | Field | Description |
|---|---|---|
| 31:29 | Status | 7: TmgErr 4: TmgRsm 0: TmgGnt |
| 28:05 | Rsvd | Zeroes. |
| 04:00 | NxtCpx | Next requester CPU Context. |

Request TCB Lock—Receive Priority (TlkRcvReq)

Requests, at a high priority level, a lock for the specified TCB on behalf of the specified CPU Context. If the context already has a request for a TCB Lock other than the one specified, then TmgErr status is returned because a context may never own more than a single lock. If the context already has a request for the specified TCB Lock but does not yet own the TCB, then TmgErr status is returned because the specified context should be resuming with the lock granted. If the specified context already has ownership of the specified TCB, then TmgDup status is returned indicating successful resumption of a thread. If the specified TCB is owned by another context and ChnInh is reset, then the request will be linked to the end of the priority request sub-chain and TmgSlp status will be returned. If a priority request sub-chain has not been previously established, then one will be established behind the head of the lock request chain by inserting the high priority request into the request chain between the current owner and the next normal priority requester. The priority sub-chaining affords a means to quickly pass RcvSqr events through to the receive queue residing within a TCB. If the specified TCB is owned by another context and ChnInh is set, then the request will not be linked and TmgSlp status will be returned. The request chaining inhibit is provided for unanticipated situations.

| CmdRg | Field | Description |
|---|---|---|
| 31:31 | ChnInh | Request chainging inhibit. |
| 30:29 | Rsvd | |
| 28:24 | CpuCx | CPU Context identifier. |
| 23:12 | Rsvd | |
| 11:00 | TcbId | TCB identifier. |

| RspRg | Field | Description |
|---|---|---|
| 31:29 | Status | 7: TmgErr 4: TmgSlp 1: TmgDup 0: TmgGnt |
| 28:00 | Rsvd | Zeroes. |

Pop Receive Request (TlkRcvPop)

Causes the removal of the next TCB Lock request in the receive sub-chain of the specified CPU Context. If the CPU Context does not own the specified TCB, then TmgErr status is returned. If there is no chained receive request detected then TmgEnd status is returned.

| CmdRg | Field | Description |
|---|---|---|
| 31:29 | Rsvd | |
| 28:24 | CpuCx | CPU Context identifier. |
| 23:12 | Rsvd | |
| 11:00 | TcbId | TCB identifier. |

| RspRg | Field | Description |
|---|---|---|
| 31:29 | Status | 7: TmgErr 4: TmgEnd 0: TmgGnt |
| 28:00 | Rsvd | Zeroes. |
| 04:00 | NxtCpx | Next requester CPU Context. |

TCB Cache Control

Cache Buffers (Cbfs) are areas within Global Ram which have been reserved for the caching of TCBs. TcbMgr provides control and status registers for 128 Cache Buffers and can be configured to support fewer Cache Buffers. Each of the Cache Buffers has an associated Cache Buffer register set comprising control and status registers which are dedicated to describing the Cache Buffer state and any registered TCB. TcbMgr uses these registers to identify and to lock Cache Buffers for TCB access by the CPU. The Cache Buffer register set is defined as follows.

Cbfstate—Each of the Cache Buffers is assigned one of four states; DISABLED, VACANT, IDLE or BUSY as indicated by the two CbfState flip-flops. The DISABLED state indicates that the Cache Buffer is not available for caching of TCBs. The VACANT state indicates that the Cache Buffer is available for caching of TCBs but that no TCB is currently registered as resident. The IDLE state indicates that a TCB has been registered as resident and that the Cache Buffer is unlocked (not BUSY). The BUSY state indicates that a TCB has been registered as resident and that the Cache Buffer has been locked for exclusive use by a CPU Context.

CbfTcbNum—TCB Number identifies a resident TCB. The identifier is valid for IDLE and BUSY states only. This value is compared against the command parameter CmdTcb and then the result is used to confirm TCB residency for a specified Cache Buffer or to search for a Cache Buffer wherein a desired TCB resides.

CbfDtyFlg—A Dirty Flag is provided for each Cache Buffer to indicate that the resident TCB has been modified and needs to be written back to external memory. This bit is valid during the IDLE and BUSY states only. The Dirty Flag also serves to inhibit invalidation of a modified TCB. Attempts to register a new TCB or invalidate a current registration will be blocked if the Dirty Flag of the specified Cache Buffer is asserted. This protective feature can be circumvented by asserting the Dirty Inhibit (DtyInh) parameter when initiating the command.

CbfSlpFlg—Normally, TCB Locks ensure collision avoidance when requesting a Cache Buffer, but a situation may sometimes occur during which a collision takes place. Sleep Flag indicates that a thread has encountered this situation and has suspended execution while awaiting Cache Buffer collision resolution. The situation occurs whenever a requested TCB is not found to be resident and an IDLE Cache Buffer containing a modified TCB is the only Cache Buffer type available in which to cache the desired TCB. The modified TCB must be written back, to the external TCB Buffer, before the desired TCB can be registered. During this time, if another CPU requests the dirty TCB then CbfSlpFlg will be asserted, the context of the requesting CPU will be saved to CbfSlpCtx and then the thread will be suspended. When the Cache Buffer owner registers the new TCB a response is given which indicates that the suspended thread must be resumed.

CbfSlpCpx—Sleeping CPU Context indicates the thread which was suspended as a result of a Cache Buffer collision.

CbfCycTag—Each Cache Buffer has an associated Cycle Tag register which indicates the order in which it is to be removed from the VACANT Pool or the IDLE Pool for the purpose of caching a currently non-resident TCB. Two counters, VACANT Cache Buffer Count (VacCbfCnt) and IDLE Cache Buffer Count (IdlCbfCnt), indicate the number of Cache Buffers which are in the VACANT or IDLE states. When a Cache Buffer transitions to the VACANT state or to the IDLE state, the value in VacCbfCnt or IdlCbfCnt is copied to the CbfCycTag register and then the counter is incremented to indicate that a Cache Buffer has been added to the pool. When a Cache Buffer is removed from the VACANT Pool or the IDLE Pool, any Cache Buffer in the same pool will have it's CbfCycTag decremented providing that it's CbfCycTag contains a value greater than that of the exiting Cache Buffer. Also, the respective counter value, VacCbfCnt or IdlCbfCnt, is decremented to indicate that one less Cache Buffer is in the pool. CbfCycTag is valid for the VACANT and IDLE states and is not valid for the DISABLED and BUSY states. The CbfCycTag value of each Cache Buffer is continuously tested for a value of zero which indicates that it is the least recently used Cache Buffer in it's pool. In this way, TcbMgr can select a single Cache Buffer from the VACANT Pool or from the IDLE Pool in the event that a targeted TCB is found to be nonresident. The following five commands allow the CPU to initiate Cache Buffer search, lock and registration operations.

Get Cache Buffer. (CchBufGet)

This command requests assignment of a Cache Buffer for the specified TCB. TMg first performs a registry search and if an IDLE Cache Buffer is found wherein the specified TCB resides, then the Cache Buffer is made BUSY. TmgGnt status is returned along with the CbfId.

If a BUSY Cache Buffer is found, wherein the specified TCB resides, and SlpInh is set, then TmgSlp status is returned indicating that the Cache Buffer cannot be reserved for use by the requestor.

If a BUSY Cache Buffer is found, wherein the specified TCB resides, and SlpInh is not set, then the specified CPU Context ID is saved to the CbfSlpCpx and the CbfSlpFlg is set. TmgSlp status is returned indicating that the CPU Context should suspend operation until the Cache Buffer has been released.

If the specified TCB is not found to be residing in any of the Cache Buffers but an LRE Cache Buffer is detected, then the Cache Buffer state will be set to BUSY, the TCB will be registered to the Cache Buffer and TmgFch status plus CbfId will be returned.

If the specified TCB is not found to be residing in any of the Cache Buffers and no LRE Cache Buffer is detected but a LRU Cache Buffer is detected that does not have it's DtyFlg asserted, then the Cache Buffer state will be set to BUSY, the TCB will be registered to the Cache Buffer and TmgFch status will be returned along with the CbfId. The program thread should then schedule a DMA operation to copy the TCB from the external TCB Buffer to the Cache Buffer.

If the specified TCB is not found to be residing in any of the Cache Buffers, no LRE Cache Buffer is detected and a LRU Cache Buffer is detected that has it's DtyFlg asserted, then the Cache Buffer state will be set to BUSY and TmgFsh status will be returned along with the CbfId and it's resident TcbId. The program thread should then schedule a DMA operation to copy the TCB from the internal Cache Buffer to the external TCB Buffer, then upon completion of the DMA, register the desired TCB by issuing a CchTcbReg command, then schedule a DMA to copy the desired TCB for it's external TCB Buffer to the Cache Buffer.

| Conditions | Response_Register |
|---|---|
| TcbDet, CbfBsy, !SlpFlg, SlpInh | {TmgSlp, 10′b0, CbfId, 12′b0} |
| TcbDet, CbfBsy, !SlpFlg, !SlpInh | {TmgSlp, 10′b0, CbfId, 12′b0} |
| TcbDet, !CbfBsy | {TmgGnt, 10′b0, CbfId, 12′b0} |
| !TcbDet, LreDet | {TmgFch, 10′b0, CbfId, 12′b0} |
| !TcbDet, !LreDet, LruDet, !DtyFlg | {TmgFch, 10′b0, CbfId, 12′b0} |
| !TcbDet, !LreDet, LruDet, DtyFlg | {TmgFsh, 10′b0, CbfId, TcbId} |
| Default | {TmgErr, 10′b0, 7′b0, 12′b0} |

| CmdRg | Field | Description |
|---|---|---|
| 31:31 | SlpInh | Inhibits modification of SlpFlg |
| | | and SlpCtx. |
| 30:29 | Rsvd | |
| 28:24 | CpuCx | Current CPU Context. |
| 23:12 | Rsvd | |
| 11:00 | TcbId | Targeted TCB. |

| RspRg | Field | Description |
|---|---|---|
| 31:29 | Status | 7: TmgErr, 6: TmgFsh, 5: TmgFch, |
| | | 4: TmgSlp, 0: TmgGnt |
| 28:19 | Rsvd | Reserved. |
| 18:12 | CbfId | Cache Buffer identifier. |
| 11:00 | TcbId | TCB identifier for Flush indication. |

Modify Dirty. (CchDtyMod)

Selects the specified Cache Buffer. If the state is BUSY and the specified TCB is registered, then the CbfDtyFlg is written with the value in DtyDat and a status of TmgGnt is returned. This command is intended primarily as a means to set the Dirty Flag. Clearing of the Dirty Flag is normally done as a result of invalidating the resident TCB.

| Conditions | Response_Register |
|---|---|
| CbfBsy, TcbDet | {TmgGnt, 29′b0} |
| Default | {TmgErr, 29′b0} |

| CmdRg | Field | Description |
|---|---|---|
| 31:31 | DtyDat | Data to be written to the Dirty Flag. |
| 30:19 | Rsvd | |
| 18:12 | CbfId | Targeted Cbf. |
| 11:00 | TcbId | Expected resident TCB. |

| RspRg | Field | Description |
|---|---|---|
| 31:29 | Status | 7: TmgErr 0: TmgGnt |
| 28:00 | Rsvd | Reserved. |

Evict and Register. (CchTcbReg)

Requests that the TCB which is currently resident in the Cache Buffer be evicted and that the TCB which is locked by the specified CPU Context (TlkTcbNum[CmdCpx]) be registered. The Cache Buffer must be BUSY, CmdTcb must match the current registrant and Dirty must be reset or overridden with DtyInh in order for this command to succeed. SlpFlg without SlpInh causes SlpCpx to be returned along with TmgRsm status otherwise TmgGnt status is returned. This command is intended to register a TCB after completing a flush DMA operation.

| Conditions | Response_Register |
|---|---|
| CbfBsy, TcbDet, DtyFlg, DtyInh, SlpFlg | {TmgRsm, 5′b0, SlpCpx, |
| | 19′b0} |
| CbfBsy, TcbDet, !DtyFlg, SlpFlg | {TmgRsm, 5′b0, SlpCpx, |
| | 19′b0} |
| CbfBsy, TcbDet, DtyFlg, DtyInh, !SlpFlg | {TmgGnt, 29′b0} |
| CbfBsy, TcbDet, !DtyFlg, !SlpFlg | {TmgGnt, 29′b0} |
| Default | {TmgErr, 29′b0} |

| CmdRg | Field | Description |
|---|---|---|
| 31:31 | DtyInh | Inhibits Dirty Flag detection. |
| 30:29 | Rsvd | |
| 28:24 | CpuCx | Current CPU Context. |
| 23:19 | Rsvd | |
| 18:12 | CbfId | Targeted Cbf. |
| 11:00 | TcbId | TCB to evict. |

| RspRg | Field | Description |
|---|---|---|
| 31:29 | Status | 7: TmgErr 4: TmgRsm 0: TmgGnt |
| 28:05 | Rsvd | Reserved. |
| 04:00 | SlpCpx | Cpu Context to resume. |

Evict and Release. (CchTcbEvc)

Requests that the TCB which is currently resident in the Cache Buffer be evicted and that the Cache Buffer then be released to the Vacant Pool. The Cache Buffer must be BUSY, CmdTcb must match the current registrant and Dirty Flag must be reset or overridden with DtyInh in order for this command to succeed. SlpFlg without SlpInh causes SlpCpx to be returned along with TmgRsm status otherwise TmgGnt status is returned.

| Conditions | Response_Register |
|---|---|
| Default | {TmgErr, 29′b0} |
| CbfBsy, TcbDet, DtyFlg, DtyInh, SlpFlg | {TmgRsm, 4′b0, SlpCpx, |
| | 19′b0} |
| CbfBsy, TcbDet, !DtyFlg, SlpFlg | {TmgRsm, 4′b0, SlpCpx, |
| | 19′b0} |
| CbfBsy, TcbDet, DtyFlg, DtyInh, !SlpFlg | {TmgGnt, 29′b0} |
| CbfBsy, TcbDet, !DtyFlg, !SlpFlg | {TmgGnt, 29′b0} |

| CmdRg | Field | Description |
|---|---|---|
| 31:31 | DtyInh | Inhibits Dirty Flag detection. |
| 30:19 | Rsvd | |
| 18:12 | CbfId | Targeted Cbf. |
| 11:00 | TcbId | Expected resident TCB. |

| RspRg | Field | Description |
|---|---|---|
| 31:29 | Status | 7: TmgErr 4: TmgRsm 0: TmgGnt |
| 28:05 | Rsvd | Reserved. |
| 04:00 | SlpCpx | Cpu Context to resume. |

Release. (CchBufRIs)

Selects the specified Cache Buffer then verifies Cache Buffer BUSY and TCB registration before releasing the Cache Buffer. SlpFlg found causes SlpCpx to be returned along with TmgRsm status otherwise a TmgGnt status is returned. DtySet will cause the Dirty Flag to be asserted in the event of a successful Cbf release.

| Conditions | Response_Register |
|---|---|
| Default | {TmgErr, 29′b0} |
| CbfBsy, TcbDet, SlpFlg | {TmgRsm, 4′b0, SlpCpx, 19′b0} |
| CbfBsy, TcbDet, !SlpFlg | {TmgGnt, 29′b0} |

| CmdRg | Field | Description |
|---|---|---|
| 31:31 | DtySet | Causes the dirty flag to be asserted. |
| 30:19 | Rsvd | |
| 18:12 | CbfId | Targeted Cbf. |
| 11:00 | TcbId | Expected resident TCB. |

| RspRg | Field | Description |
|---|---|---|
| 31:29 | Status | 7: TmgErr 4: TmgRsm 0: TmgGnt |
| 28:05 | Rsvd | Reserved. |
| 04:00 | SlpCpx | Cpu Context to resume. |

The following commands are intended for maintenance and debug usage only.

TCB Manager Reset. (TmgReset)

Resets all Cache Buffer registers and all TCB Lock registers.

| | | |
|---|---|---|
| CmdRg | Field | Description |

| | |
|---|---|
| 31:00 | Rsvd |

| RspRg | Field | Description |
|---|---|---|
| 31:00 | Rsvd | Reserved. |

TCB Query. (TmgTcbQry)

Performs registry search for the specified TCB and reports Cache Buffer ID. Also performs TCB Lock search for the specified TCB and reports Cpu Context ID. Additional TCB information can then be obtained by using the returned IDs along with the CchBufQry and TlkCpxQry commands. This command is intended for debug usage.

| CmdRg | Field | Description |
|---|---|---|
| 31:12 | Rsvd | |
| 11:00 | TcbId | Targeted TCB. |

| RspRg | Field | Description |
|---|---|---|
| 31:31 | CbfDet | Indicates the TCB is registered to a Cache Buffer. |
| 30:30 | TlkDet | Indicates the TCB is locked. |
| 29:24 | Rsvd | Reserved. |
| 23:19 | CpxId | ID of Cpu Context that has the TCB lock. |
| 18:12 | CbfId | ID of Cache Buffer where TCB is registered. |
| 11:00 | Rsvd | Reserved. |

Cache Buffer Query. (CchBufQry)

Returns information for the specified Cache Buffer. This command is intended for debug usage.

| | Field | Description |
|---|---|---|
| CmdRg | | |
| 31:19 | Rsvd | |
| 18:12 | CbfId | Targeted Cbf. |
| 11:00 | TcbId | Expected resident TCB. |
| RspRg | | |
| 31:30 | State | 3: BUSY, 2: IDLE, 1: VACANT, 0: DISABLED |
| 29:29 | SlpFlg | Sleep Flag. |
| 28:28 | DtyFlg | Dirty Flag. |
| 27:27 | CTcEql | Command TCB == CbfTcbNum. |
| 26:26 | LreDet | Buffer is least recently emptied. |
| 25:25 | LruDet | Buffer is least recently used. |
| 24:24 | Rsvd | Reserved. |
| 23:19 | SlpCpx | Sleeping CPU Context. |
| 18:12 | CycTag | Cache Buffer Cycle Tag. |
| 11:00 | TcbId | TCB identifier. |

Least Recently Emptied Query. (CchLreQry)

Report on least recently vacated Cache Buffer. Also returns vacant buffer count. Intended for degug usage.

| | | |
|---|---|---|
| CmdRg | Field | Description |

| | |
|---|---|
| 31:00 | Rsvd |

| RspRg | Field | Description |
|---|---|---|
| 31:31 | CbfDet | Vacant Cache Buffer detected. |
| 30:24 | VacCnt | Vacant Cbf count. 0 == 128 if CbfDet. |
| 23:19 | Rsvd | Reserved. |
| 18:12 | CbfId | ID of least recently emptied Cache Buffer. |
| 11:00 | Rsvd | Reserved. |

Least Recently Used Query. (CchLruQry)

Report on least recently used Cache Buffer. Also returns idle buffer count. Intended for degug usage.

| | | |
|---|---|---|
| CmdRg | Field | Description |

| | |
|---|---|
| 31:00 | Rsvd |

| RspRg | Field | Description |
|---|---|---|
| 31:31 | CbfDet | Idle Cache Buffer detected. |
| 30:24 | IdlCnt | Idle Cbf count. 0 == 128 if CbfDet. |
| 23:19 | Rsvd | Reserved. |
| 18:12 | CbfId | ID of least recently used Cache Buffer. |
| 11:00 | TcbId | Resident TCB identifier. |

Cache Buffer Enable. (CchBufEnb)

Enables the specified Cache Buffer. Buffer must be in the DISABLE state for this command to succeed. Any other state will result in a TmgErr status. Intended for initial setup.

| CmdRg | Field | Description |
|---|---|---|
| 31:17 | Rsvd | |
| 18:12 | CbfId | Targeted Cbf. |
| 11:00 | Rsvd | |

| RspRg | Field | Description |
|---|---|---|
| 31:29 | Status | 7: TmgErr 0: TmgGnt |
| 28:00 | Rsvd | Reserved. |

TCB Lock Query—Cpu Context (TlkCpxQry)

Returns the lock registers for the specified CPU Context. TcbDet indicates that CmdTcbId is valid and identical to TlkTcbNum. This command is intended for diagnostic and debug use.

| CmdRg | Field | Description |
|---|---|---|
| 31:29 | Rsvd | |
| 28:24 | CpuCx | CPU Context. |
| 23:12 | Rsvd | |
| 11:00 | TcbId | Expected resident TCB. |

| RspRg | Field | Description |
|---|---|---|
| 31:31 | ReqVld | Lock request is valid. |
| 30:30 | GntFlg | Lock has been granted. |
| 29:29 | ChnFlg | Request is chained. |
| 28:28 | PriEnd | End of priority sub-chain. |
| 27:27 | CTcDet | CmdTcbId == TlkTcbNum. |
| 26:24 | Rsvd | Reserved. |
| 23:19 | NxtCpx | Next requesting CPU Context. |
| 18:12 | Rsvd | |
| 11:00 | TcbId | Identifies the requested TCB. |

Host Bus Interface Adaptor (HstBIA/BIA)
Host Event Queue (HstEvtQ)

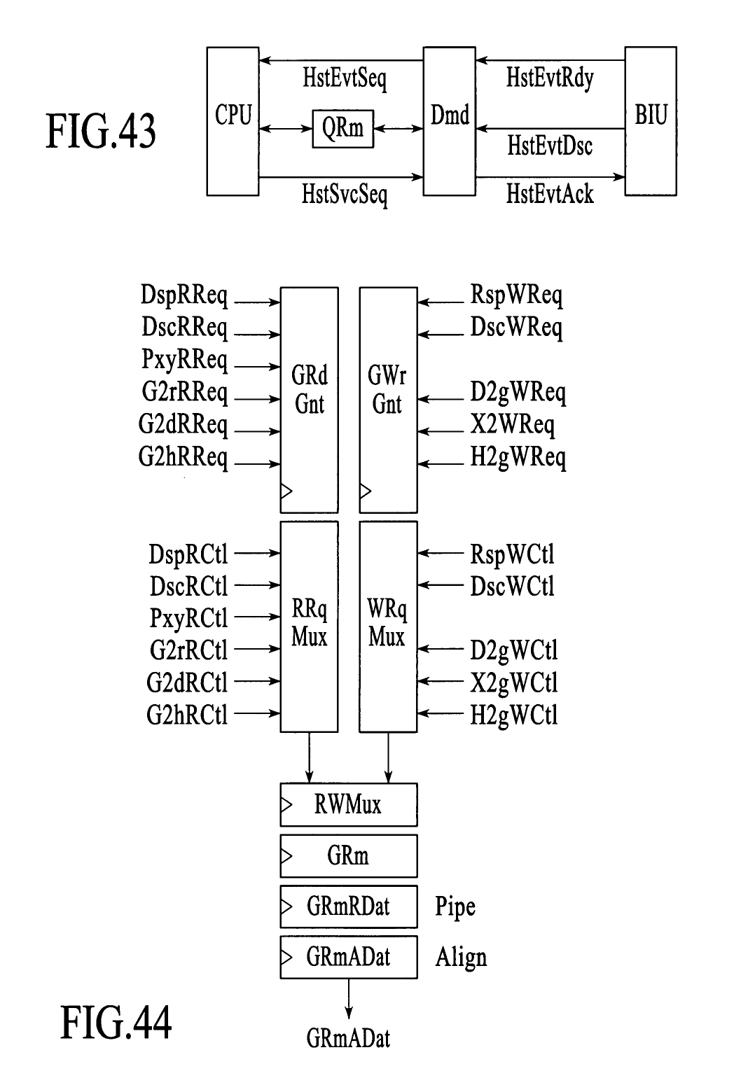

FIG. 43 is a diagram of Host Event Queue Control/Data Paths. The HstEvtQ is a function implemented within the Dmd. It is responsible for delivering slave write descriptors, from the host bus interface to the CPU.

Write Descriptor Entry:

| Bits | Name | Description |
|---|---|---|
| 31:31 | Rsvd | Zero. |
| 30:30 | Func2 | Write to Memory Space of Function 2. |
| 29:29 | Func1 | Write to Memory Space of Function 1. |
| 28:28 | Func0 | Write to Memory Space of Function 0. |
| 27:24 | Marks | Lane markers indicate valid bytes. |
| 23:23 | WrdVld | Marks == 4′b1111. |
| 22:20 | Rsvd | Zeroes. |
| 19:00 | SlvAdr | Slave address bits 19:00. |

Write Data Entry:

| Bits | Name | Description |
|---|---|---|
| ----- | ------ | ----------- |
| 31:00 | SlvDat | Slave data. |
| if (CmdCd==0) { | | |
| 18:12 | CpId | Cpu Id. |
| 11:07 | ExtCd | Specifies 1 of 32 commands. |
| 06:03 | CmdCd | Zero indicates extended (non-TCB) mode. |
| 02:00 | | Always 0 |
| } else { | | |
| 18:07 | TcbId | Specifies 1 of 4096 TCBs. |
| 06:03 | CmdCd | 1 of 15 TCB commands. |
| 02:00 | | Always 0 |
| } | | |

CONVENTIONAL PARTS

PCI EXPRESS, EIGHT LANE
LVDS I/O Cells
Pll
Phy
Mac
Link Controller
Transaction Controller

RLDRAM, 76 BIT, 500 Mb/S/Pin
LVDS, HSTL I/O Cells
Pll
Dll

XGXS/XAUI
CML I/O Cells
Pll
Controller

SERDES
LVDS
SERDES Controller

RGMII
HSTL I/O Cells

MAC
10/100/1000 Mac
10 Gbe Mac

SRAM
Custom Single Port Sram
Custom Dual Port Srams, 2-RW Ports
Custom Dual Port Srams, 1-R 1-W Port

PLLs

FIG. 44 is a diagram of Global RAM Control.

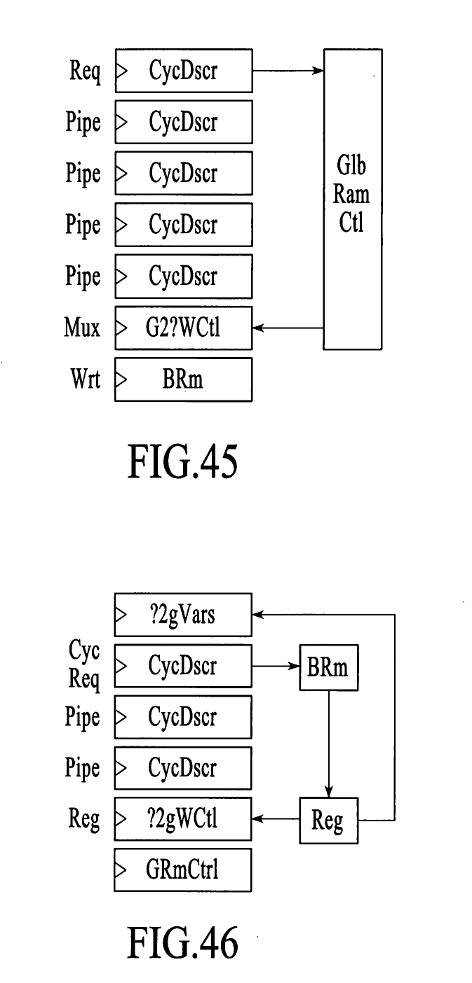

FIG. 45 is a diagram of Global RAM to Buffer RAM.

FIG. 46 is a diagram of Buffer RAM to Global RAM.

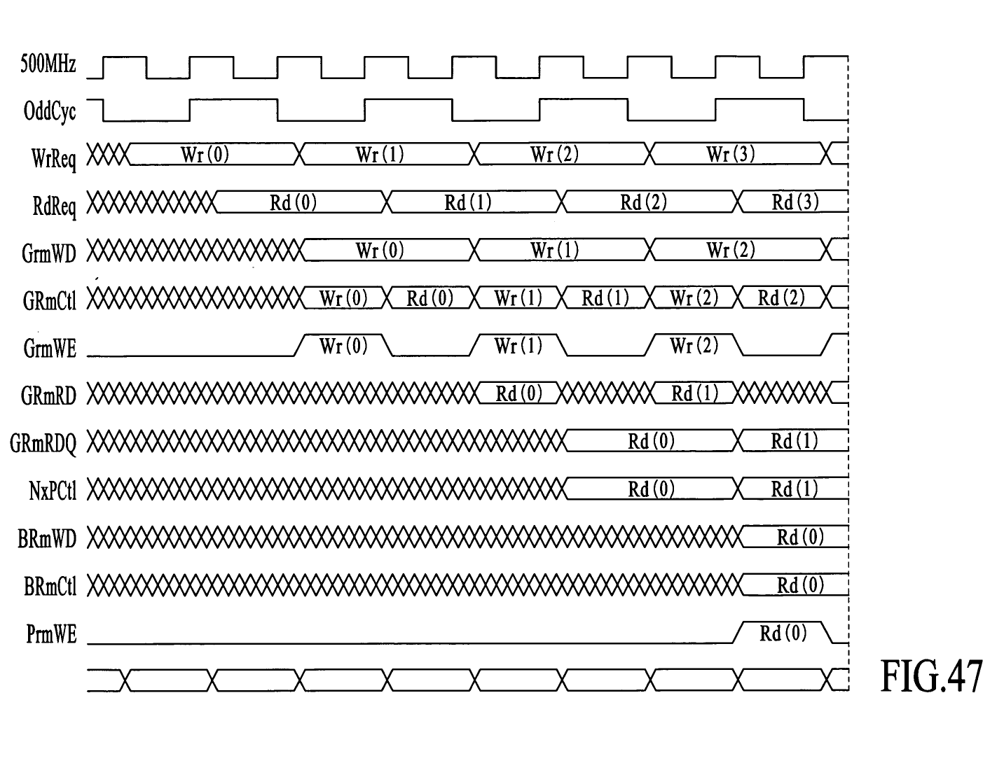

FIG. 47 is a Global RAM Controller timing diagram. In this diagram, odd clock cycles are reserved for read operations, and even cycles are reserved for write operations. As shown in the figure:

1) Write request is presented to controller.

2) Read request is presented to controller.

3) Write 0 data, write 0 address and write enable are presented to RAM while OddCyc is false.

4) Read 0 address is presented to RAM while OddCyc is true.

5) Write 1 data, write 1 address and write enable are presented to RAM and read 0 data is available at RAM outputs.

6) Read 1 address is presented to RAM while read 0 data is available at read registers.

7) Write 2 data, write 2 address and write enable are presented to RAM, read 1 data is available at RAM outputs and read 0 data is available at Brm write data registers from where it will be written to Brm.

1. A device comprising:
a plurality of control blocks, each of the control blocks containing a combination of information representing the state of a process;
a processor that accesses the control blocks to read and update the information; and
a control block manager that allocates the accessing of the control blocks by the processor.

2. The device of claim 1, wherein the processor has a plurality of contexts, with each context representing a group of resources available to the processor when operating within the context, and the control block manager allows, for each of the control blocks, only one of the contexts to access that control block at one time.

3. The device of claim 1, wherein the process includes communication according to the Transmission Control Protocol (TCP).

4. The device of claim 1, wherein each control block contains information corresponding to TCP.

5. The device of claim 1, wherein each control block contains information corresponding to a different TCP connection.

6. The device of claim 1, wherein each control block contains information corresponding to a different TCP Control Block (TCB).

7. The device of claim 1, wherein each control block contains information corresponding to a transport layer of a communication protocol.

8. The device of claim 1, wherein each control block contains information corresponding to a network layer of a communication protocol.

9. The device of claim 1, wherein each control block contains information corresponding to a Media Access Control (MAC) layer of a communication protocol.

10. The device of claim 1, wherein each control block contains information corresponding to an upper layer of a communication protocol, the upper layer being higher than a transport layer.

11. The device of claim 1, wherein each control block contains information corresponding to at least three layers of a communication protocol.

12. The device of claim 1, wherein the device provides a communication interface for a host.

13. The device of claim 1, wherein at least one of the control blocks has been transferred to the device from a host.

14. The device of claim 1, wherein at least one of the control blocks is not established by the device.

15. The device of claim 1, wherein the control block manager manages storage of the control blocks in a memory.

16. A device comprising:
a control block containing a combination of information representing the state of a process;
a plurality of processors that access the control block to read and update the information; and
a control block manager that allocates the accessing of the control block by the processors.

17. The device of claim 16, wherein the process includes communication according to the Transmission Control Protocol (TCP).

18. The device of claim 16, wherein the control block contains information corresponding to TCP.

19. The device of claim 16, wherein the control block contains information corresponding to a TCP connection.

20. The device of claim 16, wherein the control block contains information corresponding to a TCP Control Block (TCB).

21. The device of claim 16, wherein the device provides a communication interface for a host.

22. The device of claim 16, wherein the control block contains information corresponding to a transport layer of a communication protocol.

23. The device of claim 16, wherein the control block contains information corresponding to a network layer of a communication protocol.

24. The device of claim 16, wherein the control block contains information corresponding to a Media Access Control (MAC) layer of a communication protocol.

25. The device of claim 16, wherein the control block contains information corresponding to an upper layer of a communication protocol, the upper layer being higher than a transport layer.

26. The device of claim 16, wherein the control block contains information corresponding to at least three layers of a communication protocol.

27. The device of claim 16, wherein the processors are pipelined.

28. The device of claim 16, wherein the processors share hardware, with each of the processors occupying a different phase at a single time.

29. The device of claim 16, wherein the control block has been transferred to the device from a host.

30. The device of claim 16, wherein the control block manager manages storage of the control block in a memory.

31. The device of claim 16, wherein each of the processors has a plurality of contexts, with each context representing a group of resources available to the processor when operating within the context, and the control block manager allows only one of the contexts to access the control block at one time.

32. A device comprising:
a plurality of control blocks, each of the control blocks containing a combination of information representing the state of a process;
a plurality of processors that access the control blocks to read and update the information; and
a control block manager that allocates the accessing of the control blocks by the processors.

33. The device of claim 32, wherein each of the processors has a plurality of contexts, with each context representing a group of resources available to the processor when operating within the context, and the control block manager allows only one of the contexts to access any one of the control blocks at one time.

34. The device of claim 32, wherein the control block manager manages storage of the control blocks in a memory.

35. The device of claim 32, wherein the process includes communication according to the Transmission Control Protocol (TCP).

36. The device of claim 32, wherein each control block contains information corresponding to TCP.

37. The device of claim 32, wherein each control block contains information corresponding to a different TCP connection.

38. The device of claim 32, wherein each control block contains information corresponding to a different TCP Control Block (TCB).

39. The device of claim 32, wherein the device provides a communication interface for a host.

40. The device of claim 32, wherein each control block contains information corresponding to a transport layer of a communication protocol.

41. The device of claim 32, wherein each control block contains information corresponding to a network layer of a communication protocol.

42. The device of claim 32, wherein each control block contains information corresponding to a Media Access Control (MAC) layer of a communication protocol.

43. The device of claim 32, wherein each control block contains information corresponding to an upper layer of a communication protocol, the upper layer being higher than a transport layer.

44. The device of claim 32, wherein each control block contains information corresponding to at least three layers of a communication protocol.

45. The device of claim 32, wherein each control block is only accessed by one processor at a time.

46. The device of claim 32, wherein each control block contains information corresponding to a different TCP connection, and each control block is only accessed by one processor at a time.

47. The device of claim 32, wherein the processors are pipelined.

48. The device of claim 32, wherein the processors share hardware, with each of the processors occupying a different phase at a time.

49. The device of claim 32, wherein the device provides a communication interface for a host.

50. The device of claim 32, wherein at least one of the control blocks has been transferred to the device from a host.

51. The device of claim 32, wherein the control block manager grants locks to the plurality of processors, each of the locks being defined to allow access to a specific one of the control blocks by only one of the processors at a time, the control block manager maintaining a queue of lock requests that have been made by all of the processors for each lock.

52. The device of claim 32, wherein the plurality of processors each has a plurality of contexts, with each context representing a group of resources available to the processor when operating within the context, and the control block manager grants locks to the plurality of processors, each of the locks being defined to allow access to a specific one of the control blocks by only one of the contexts at a time.

53. The device of claim 52, wherein the control block manager maintains a queue of requests to access each control block that have been made by all of the contexts for each lock.

54. The device of claim 52, wherein the control block manager maintains a queue of lock requests that have been made by all of the contexts for each lock.

55. The device of claim 32, wherein the plurality of processors each has a plurality of contexts, with each context representing a group of resources available to the processor when operating within the context, and the control block manager allows, for each of the control blocks, only one of the contexts to access that control block at one time.

56. The device of claim 55, wherein the control block manager maintains a queue of requests to access each control block that have been made by all of the contexts for each lock.

57. A device comprising:
a plurality of control blocks stored in a memory, each of the control blocks containing a combination of information representing the state of a process;
a plurality of processors that access the control blocks to read and update the information; and
a control block manager that manages storage of the control blocks in the memory and allocates the accessing of the control blocks by the processors.

58. The device of claim 57, wherein the plurality of processors each has a plurality of contexts, with each context representing a group of resources available to the processor when operating within the context, and the control block manager allows, for each of the control blocks, only one of the contexts to access that control block at one time.

59. The device of claim 57, wherein the control block manager allocates the accessing of the control blocks by the processors based at least in part upon the order in which the processors requested to access each of the control blocks.

60. The device of claim 57, wherein the control block manager allocates the accessing of the control blocks by the processors based at least in part upon a predetermined priority of functions provided by the processors.

61. The device of claim 57, wherein the control block manager allocates the accessing of the control blocks by the processors based at least in part upon a predetermined priority of contexts, wherein each context represents a group of resources available to the processors when operating within the context.
